(19) United States
(12) Patent Application Publication
(10) Pub. No.: US 2025/0370526 A1
(43) Pub. Date: Dec. 4, 2025

(54) MULTI-COMPONENT SYSTEM WITH POWER-UP SURGE MITIGATION

(71) Applicant: NVIDIA Corporation, Santa Clara, CA (US)

(72) Inventor: Ran Yehiel Attias, Kfar-Sava (IL)

(21) Appl. No.: 18/676,389

(22) Filed: May 28, 2024

(51) Int. Cl. G06F 1/3206; G06F 1/3293; G06F 1/3296

(52) U.S. Cl. CPC G06F 1/3206; G06F 1/3293; G06F 1/3296

(57) ABSTRACT

An electronic component that modulates when one or more associated processors power on for power surge mitigation. The electronic component may include one or more processors and power-on control circuitry to modulate a time when at least a portion of the electronic component including the one or more processors powers on responsive to an input indicating the electronic component to power-up.

### FIELD

This disclosure relates generally to a system including one or more processors in a datacenter, and particularly to modulating a start-up of individual processors of the one or more processors for surge mitigation.

### BACKGROUND

Datacenter systems may power processors using one or more same power sources and/or have a maximum amount of power that one or more power sources are capable of providing and/or are permitted to provide to the datacenter system to manage power-load and costs. When the processors are initiated for power-up, individual processors may draw an additional amount of power for power-up before reducing their power consumption after power-up for specified operation(s). Because, often, the processors power-up at the same time, the cumulative power load drawn by the processors may exceed the capacity of the power source(s) and/or exceed the maximum amount of power that the datacenter system is capable of or permitted to receive from the power source(s).

### BRIEF DESCRIPTION OF THE DRAWINGS

FIG. 1 illustrates a datacenter system, in accordance with at least one embodiment;

FIG. 2 illustrates a server, in accordance with at least one embodiment;

FIG. 3 illustrates another server, in accordance with at least one embodiment;

FIG. 4 illustrates yet another server, in accordance with at least one embodiment;

FIG. 5 illustrates yet another server, in accordance with at least one embodiment;

FIG. 6 illustrates an example method of power-surge mitigation, in accordance with at least one embodiment.

FIG. 7 illustrates an example method of power-surge mitigation, in accordance with at least one embodiment;

FIG. 8 illustrates an example method of power-surge mitigation, in accordance with at least one embodiment.

FIG. 9 illustrates an example method of power-surge mitigation, in accordance with at least one embodiment.

FIG. 10 illustrates a distributed system, in accordance with at least one embodiment;

FIG. 11 illustrates an exemplary data center, in accordance with at least one embodiment;

FIG. 12 illustrates a client-server network, in accordance with at least one embodiment;

FIG. 13 illustrates a computer network, in accordance with at least one embodiment;

FIG. 14A illustrates a networked computer system, in accordance with at least one embodiment;

FIG. 14B illustrates a networked computer system, in accordance with at least one embodiment;

FIG. 14C illustrates a networked computer system, in accordance with at least one embodiment;

FIG. 15 illustrates one or more components of a system environment in which services may be offered as nth party network services, in accordance with at least one embodiment;

FIG. 16 illustrates a cloud computing environment, in accordance with at least one embodiment;

FIG. 17 illustrates a set of functional abstraction layers provided by a cloud computing environment, in accordance with at least one embodiment;

FIG. 18 illustrates a supercomputer at a chip level, in accordance with at least one embodiment;

FIG. 19 illustrates a supercomputer at a rack module level, in accordance with at least one embodiment;

FIG. 20 illustrates a supercomputer at a rack level, in accordance with at least one embodiment;

FIG. 21 illustrates a supercomputer at a whole system level, in accordance with at least one embodiment;

FIG. 22A illustrates inference and/or training logic, in accordance with at least one embodiment;

FIG. 22B illustrates inference and/or training logic, in accordance with at least one embodiment;

FIG. 23 illustrates training and deployment of a neural network, in accordance with at least one embodiment;

FIG. 24 illustrates an architecture of a system of a network, in accordance with at least one embodiment;

FIG. 25 illustrates an architecture of a system of a network, in accordance with at least one embodiment;

FIG. 26 illustrates a control plane protocol stack, in accordance with at least one embodiment;

FIG. 27 illustrates a user plane protocol stack, in accordance with at least one embodiment;

FIG. 28 illustrates components of a core network, in accordance with at least one embodiment; and

FIG. 29 illustrates components of a system to support network function virtualization (NFV), in accordance with at least one embodiment;

FIG. 30 illustrates a processing system, in accordance with at least one embodiment;

FIG. 31 illustrates a computer system, in accordance with at least one embodiment;

FIG. 32 illustrates a system, in accordance with at least one embodiment;

FIG. 33 illustrates an exemplary integrated circuit, in accordance with at least one embodiment;

FIG. 34 illustrates a computing system, according to at least one embodiment;

FIG. 35 illustrates an APU, in accordance with at least one embodiment;

FIG. 36 illustrates a CPU, in accordance with at least one embodiment;

FIG. 37 illustrates an exemplary accelerator integration slice, in accordance with at least one embodiment;

FIGS. 38A-38B illustrate exemplary graphics processors, in accordance with at least one embodiment;

FIG. 39A illustrates a graphics core, in accordance with at least one embodiment;

FIG. 39B illustrates a GPGPU, in accordance with at least one embodiment;

FIG. 40A illustrates a parallel processor, in accordance with at least one embodiment;

FIG. 40B illustrates a processing cluster, in accordance with at least one embodiment;

FIG. 40C illustrates a graphics multiprocessor, in accordance with at least one embodiment;

FIG. 41 illustrates a software stack of a programming platform, in accordance with at least one embodiment;

FIG. 42 illustrates a CUDA implementation of a software stack of FIG. 41, in accordance with at least one embodiment;

FIG. 43 illustrates a ROCm implementation of a software stack of FIG. 41, in accordance with at least one embodiment;

FIG. 44 illustrates an OpenCL implementation of a software stack of FIG. 41, in accordance with at least one embodiment;

FIG. 45 illustrates software that is supported by a programming platform, in accordance with at least one embodiment; and

FIG. 46 illustrates compiling code to execute on programming platforms of FIGS. 41-45, in accordance with at least one embodiment.

### DETAILED DESCRIPTION

In the following description, numerous specific details are set forth to provide a more thorough understanding of at least one embodiment. However, it will be apparent to one skilled in the art that the concepts may be practiced without one or more of these specific details.

Various embodiments described herein relate to a datacenter system including a plurality of servers. Each of the plurality of servers includes one or more electronic components. Each of the electronic components includes power-on control circuitry to modulate a time when the electronic component (for example, including one or more processors) fully powers-up. In at least one embodiment, a server of datacenter may include a plurality electronic components. For example, the server may power all of the plurality of electronic components using a single power source (for example, a single same power source) and/or have a maximum amount of power that one or more power sources (for example, one or more shared power sources) is capable of providing (for example, supplying) to the servers of the datacenter system and/or is permitted to provide to the server of the datacenter system. When the plurality of electronic components is initiated for power-up, individual electronic components may draw an additional amount of power for power-up before reducing their power consumption after power-up for operation(s). If the plurality of electronic components power-up at the same time, the cumulative power load drawn by the plurality of electronic components may exceed the capacity of the power source(s) and/or exceed the maximum amount of power that the server of the datacenter system is capable of receiving and/or is permitted to receive from the power source(s). Accordingly, one or more electronic components of the plurality of electronic components may not power-up correctly or sufficiently (or at all) and/or one or more electronic components of the plurality of electronic components may exceed the maximum amount of power draw that the one or more power sources are capable of providing to the server of the datacenter system and/or are permitted to provide to the servers of the datacenter system causing power-source damage to the one or more power sources, accelerated degradation to the one or more power sources, or failure to the one or more power sources and/or sever/datacenter system damage, accelerated degradation of the server/datacenter system, and/or failure of the server/datacenter system. Alternatively, in addition to the one or more power sources being sized to provide enough power to the plurality of electronic components during operation (for example, after power-up, in the “on,” “powered.” or “powered-on” state), the one or more power sources may also be sized to provide enough power to the plurality of electronic components so that the plurality of electronic components may power-up at the same time. However, sizing the one or more power sources to accommodate the power-up of the plurality of electronic components at the same time may be an inefficient use of space within the server and/or the datacenter, an inefficient use of power source(s), and/or an inefficient use of financial resources especially when powering-up individual electronic components and/or the plurality of electronic components occupies less time (for example, substantially less time) than the amount of time that the one or more electronic components may be in operation.

In at least one embodiment, the datacenter system may include a main power-on control circuitry (for example, a central controller) that (for example, among other things) manages a time when respective electronic components of the plurality of electronic components power-up. For example, a main power-on control circuitry programmed or configured (in some cases, may determine) managing power-up a plurality of electronic components (for example, processors of the electronic components). Subsequently, one or more signals may be transmitted (for example, from a higher level main power-on control circuitry, from a user terminal, or the like) for respective electronic components of the plurality of electronic components requesting/commanding/instructing that those respective electronic components be powered-up for use. The main power-on control circuitry may intercept the one or more signals to manage a timing when respective electronic components of the plurality of electronic components draw power from the one or more power sources for power-up. For example, upon receiving the one or more signals to initiate power-up for the plurality of electronic components, the main power-on control circuitry may modulate (for example, stagger) individual electronic components of the plurality of electronic components to manage a timing when respective electronic components of the plurality of electronic components draw power from the one or more electronic components for power-up. Accordingly, based on the coordination implemented solely by the main power-on control circuitry, individual electronic components may be powered-up at different times to manage the amount of power that the plurality of electronic components draw from the one or more power sources. However, relying solely on a main power-on control circuitry to manage power-up of a plurality of electronic components may have some draw-backs. For instance, additional configuration steps may be needed when installing the main power-on control circuitry and/or individual electronic components of the plurality of electronic components so that the main power-on control circuitry knows which electronic components the main power-on control circuitry is to manage and knows which power-up signal(s) to intercept. As another example, additional configuration steps may be needed when installing the main power-on control circuitry and/or individual electronic components of the plurality of electronic components so that the main power-on control circuitry knows how much power each individual electronic component draws for power-up and how much time each electronic components draws power for power-up as well as how much power each individual electronic components draws after power-up during operation and thus knows which power-up signal to intercept. As yet another example, additional configuration steps may be needed when installing the main power-on control circuitry and/or individual electronic components of the plurality of electronic components so that the main power-on control circuitry knows which power sources the plurality of electronic components may be used for power-up (for example, as well as after power-up during operational use) and how much power is available and/or permitted to be drawn for the plurality of electronic components.

As described herein, a datacenter system may include electronic components each including one or more processors (for example, one or more sets of processor(s)) and power-on control circuitry so that individual electronic components may modulate a time when at least a portion of the electronic component (for example, when the one or more processors) powers-up. For example, one or more signals may be transmitted (for example, from a higher level main power-on control circuitry, from a user terminal, or the like) for respective electronic components of a plurality of electronic components requesting/commanding/instructing that those respective electronic components (for example, the one or more processors) be powered-up for use. Power-on control circuitry located on (or packaged with) each of the electronic components (for example, sets of processors) may receive a signal of the one or more signals to initiate power-up for that particular electronic component (for example, set of processors). For example, an electronic component (for example, the power-on control circuitry) may receive an input such as an indication that power is received and modulate when a portion of the electronic component (for example, the one or more processors) powers up. In other words, each power-on control circuitry for each individual electronic component (include a set of processors) may individually receive a signal to power-up (for example, a power-up signal) so the sets of processor(s)) each receive a signal to power-up (for example, at the same time or at contemporaneous times). In response to receiving the signal for the individual electronic components to power-up, the power-on control circuitry may modulate a time when the set of processors powers up. As such, the plurality of electronic components may receive a signal to power-up, via the power-on control circuitry, so that each individual power-on control circuitry may modulate a time when that individual processor powers-up so that the individual power-on control circuitries for respective processors may vary when power is drawn by the plurality of processors and from the one or more power sources. This creates a high likelihood that power drawn from the one or more power sources does not occur at the same time. Preventing power from being drawn by the plurality of electronic components (for example, including the set of processors) from the one or more power sources at the same time may reduce the total amount of power drawn by the plurality of electronic components for power-up to an amount that is below a maximum amount of power that one or more power sources is capable of providing (for example, supplying) to the datacenter system and/or is permitted to provide to the datacenter system.

Using power-on control circuitry to manage power-up of individual electronic components of a plurality of electronic components may have some advantages. For instance, additional datacenter system configuration steps for coordinating and/or managing sequencies to determine when individual processors are powered-on may be reduced or eliminated. For example, individual electronic components having power-on control circuitry may be installed into a datacenter system server without programming the power-on control circuitry to specifically coordinate with any other electronic components. In some cases, a main power-on control circuitry may not be needed so that additional datacenter system configuration steps implemented for the main power-on control circuitry may not be needed during installation of the individual electronic components. For instance, no programming of a main power-on control circuitry may be needed so that the main power-on control circuitry knows how much power each individual electronic component draws for power-up and how much time each electronic component draws power for power-up as well as how much power each individual electronic component draws after power-up during operation and thus knows which power-up signal to intercept. In some cases, a main power-on control circuitry may not be needed so that additional datacenter system configuration steps implemented for the main power-on control circuitry may not be needed during installation of the individual electronic components of the plurality of electronic components. For instance no programming of a main power-on control circuitries may be needed so that the main power-on control circuitry knows which power sources the plurality of electronic components may be used for power-up (for example, as well as after power-up during operational use) and how much power is available and/or permitted to be drawn for the plurality of electronic components.

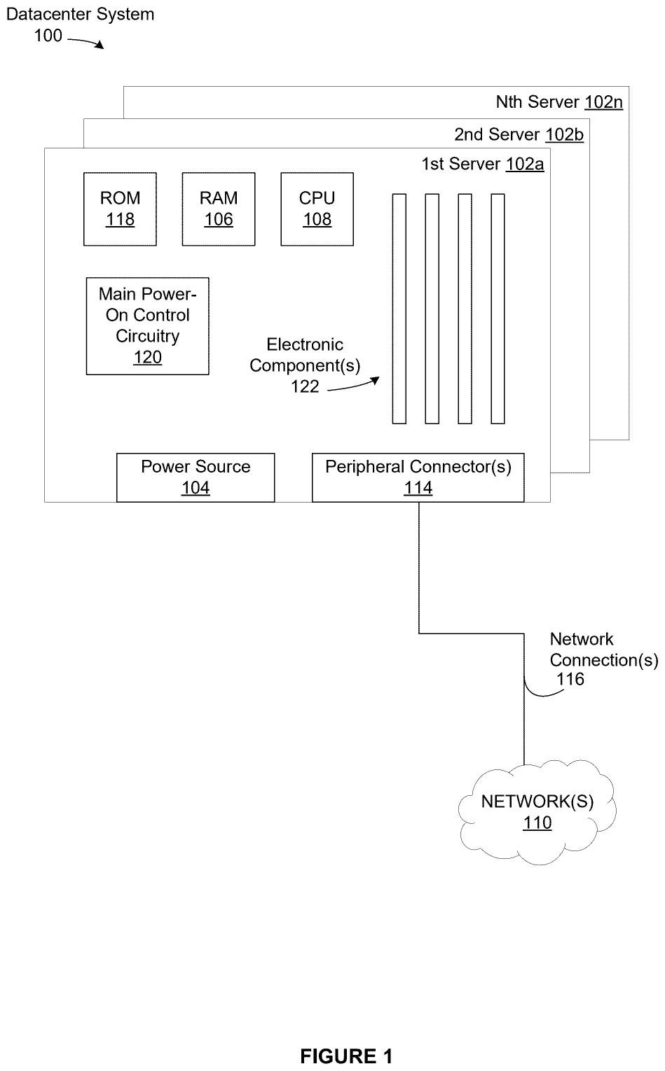

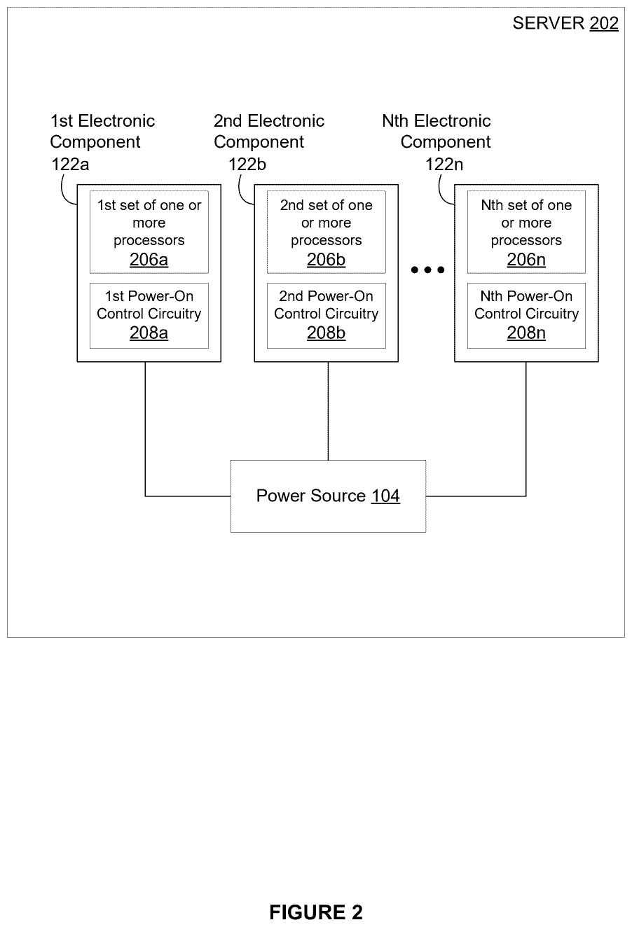

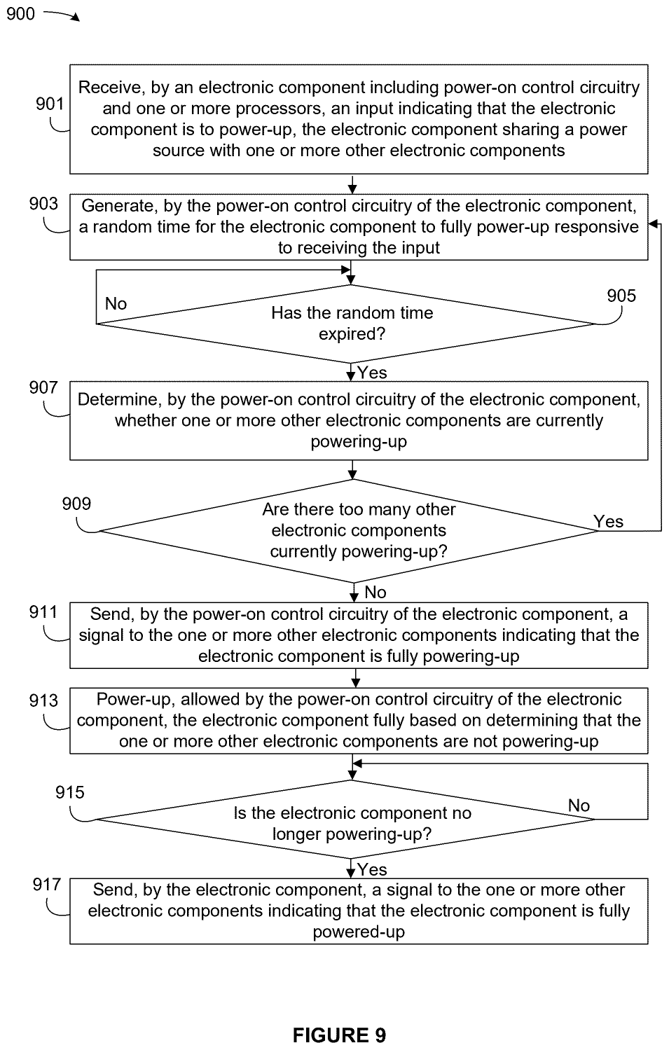

FIG. 1 illustrates a datacenter system 100, in accordance with at least one embodiment. The datacenter system 100 illustrated in FIG. 1 may implement and/or include any of the components, systems, or operations described in any one or more figures of the figures provided herein including those from FIGS. 2 through 46. For instance, the datacenter system 100 may implement and/or include the databases 914 and 916 illustrated in FIG. 9. Additionally, any one or more of the components, system, or operations described in any one or more figures of the figures provided herein including those from FIGS. 2 through 46 may be implemented into and/or included with the datacenter system 100, its respective components, and any associated operations described therewith.

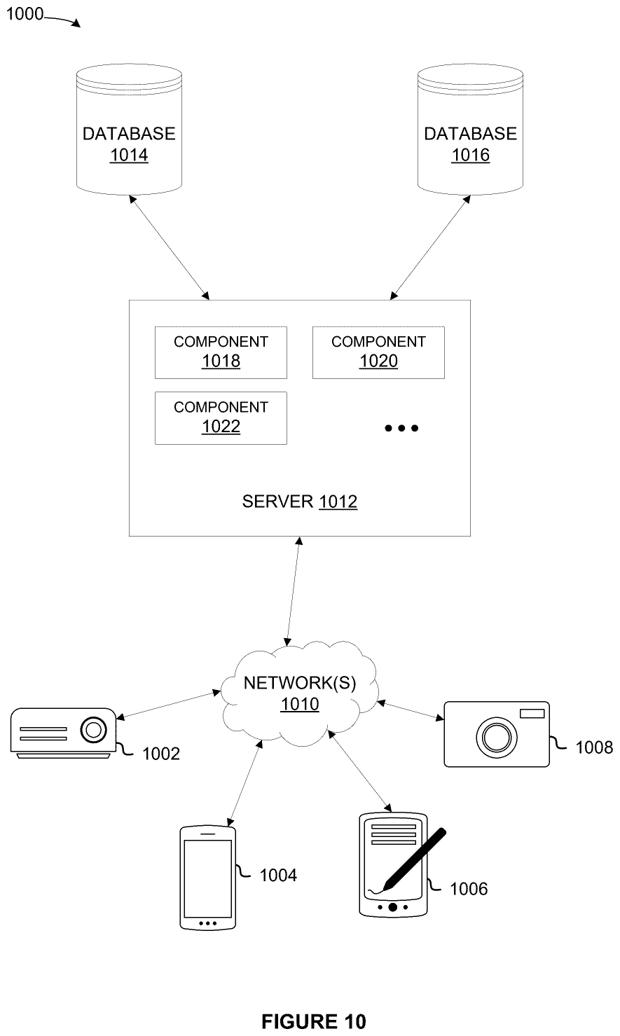

In at least one embodiment, the datacenter system 100 includes a plurality of servers including a first server 102a. a second server 102b, and an Nth server 102b. Each of the plurality of servers 102 may include one or more memory units including read only memory (ROM) 116 and random access memory (RAM) 208n. Each the plurality of servers 102 may also include a power source 104, a central processing unit (CPU) 208n, a main power-on control circuitry 120, peripheral connector(s) 114, and one or more electronic components 122. The peripheral connection(s) 114 may connect the respective servers 102 to one or more networks 110 via network connections 116. The one or more networks 110 may be the same or at least similar to the networks 910 of FIG. 10 having one or more client computing devices (for example, client computing device 1002, 1004, 1006, and 1008 as illustrated in FIG. 10), which are configured to execute and operate a client application such as a web browser, proprietary client, and/or variations thereof over one or more network(s) 110. The power source 104 may be configured to provide electrical power to all of the components of the respective servers 102 including the ROM 118, the RAM 206, the CPU 208n, the main power-on control circuitry 120, the peripheral connection(s) 114, and the one or more electronic components 122. The power source 104 may be sized and/or have a power supply capacity to sufficiently provide enough power to the respective servers of the plurality of servers for operations. In at least one embodiment, power source 104 may additionally be sized and/or have a power supply capacity to sufficiently provide enough power to the respective servers 102 of the plurality of servers while the respective servers 102 are in a power-up state. In at least one embodiment, the plurality of servers 102 of the datacenter system 100 including may be communicatively coupled with remote client computing devices via the one or more networks 110.

Each of the plurality of servers 102 may include a main power-on control circuitry 120. The main power-on control circuitry 120 may be configured to coordinate and/or control when at least some components on the server 102 may be powered on. For example, the main power-on control circuitry 120 may coordinate when the ROM 118, the RAM 206, the CPU 208n, and/or the peripheral connections 114 power on in response to receiving an input (for example, receiving power via the power source 104). In some aspects, as described further herein, the main power-on control circuitry 102 may assist the electronic components 122 with the respective electronic components' individual self-power-on operations.

In at least one embodiment, the plurality of servers 102 of the datacenter system 100 may be adapted to run one or more services or software applications such as services and applications that may manage session activity of single sign-on (SSO) access across multiple data centers. In at least one embodiment, the respective servers 102 may also provide other services or software applications that can include non-virtual and virtual environments. In at least one embodiment, these services may be offered as web-based or cloud services or under a Software as a Service (SaaS) model to users of client computing devices via the one or more networks 110. In at least one embodiment, users operating client computing devices via the one or more networks 110 may in turn utilize one or more client applications to interact with the plurality of servers of the datacenter system 100 including the respective servers 102 of the plurality of servers 102 to utilize services provided by these components.

A plurality of electronic components may be implemented on each of the plurality of servers of the datacenter system 100. As described herein, the plurality of electronic components may each include a set of one or more processors and power-on control circuitry. Users operating client computing devices may then utilize one or more client applications to use services provided by these sets of one or more processors. The respective processors of each of the sets of one or more processors may implement firmware and/or software to provide the services. It should be appreciated that various different system configurations are possible, which may be different from datacenter system 100. The embodiment shown in FIG. 1 is thus one example of a distributed system for implementing an embodiment system and is not intended to be limiting.

In at least one embodiment, client computing devices may include various types of computing systems. In at least one embodiment, a client computing device may include portable handheld devices (for example, an iPhone®, cellular telephone, an iPad®, computing tablet, a personal digital assistant (PDA)) or wearable devices (for example, a Google Glass® head mounted display), running software such as Microsoft Windows Mobile®, and/or a variety of mobile operating systems such as iOS, Windows Phone, Android, BlackBerry 10, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (for example, a Microsoft Xbox gaming console with or without a Kinect® gesture input device), and/or a personal messaging device, capable of communicating over the one or more network(s) 110.

In at least one embodiment, network(s) 110 in datacenter system 100 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 110 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (for example, a network operating under any of the Institute of Electrical and Electronics (IEEE) 802.11 suite of protocols, Bluetooth®, and/or any other wireless protocol), and/or any combination of these and/or other networks.

In at least one embodiment, the respective servers 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, the respective servers 102 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by the respective servers 102 using software defined networking. In at least one embodiment, the respective servers 102 may be adapted to run one or more services or software applications.

In at least one embodiment, the respective server 102 may run any operating system, as well as any commercially available server operating system. In at least one embodiment, the respective servers 102 may also run any of a variety of additional server applications and/or mid-tier applications, including HTTP (hypertext transport protocol) servers, FTP (file transfer protocol) servers, CGI (for example, a gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, the respective servers 102 may include one or more applications (for example, executed by one or more sets of one or more processors 206a. 206b. 206n) to analyze and consolidate data feeds and/or event updates received from users of client computing devices via the one or more network(s) 110. In at least one embodiment, data feeds and/or event updates may include, but are not limited to, Twitter® feeds, Facebook® updates or real-time updates received from one or more nth party information sources and continuous data streams, which may include real-time events related to sensor data applications, financial tickers, network performance measuring tools (for example, network monitoring and traffic management applications), clickstream analysis tools, automobile traffic monitoring, and/or variations thereof. In at least one embodiment, the respective servers 102 may also include one or more applications to display data feeds and/or real-time events via one or more display devices of client computing devices.

In at least one embodiment, datacenter system 100 may also include one or more databases (for example, the databases 914 and 916 illustrated in FIG. 9). In at least one embodiment, the databases may provide a mechanism for storing information such as user interactions information, usage patterns information, adaptation rules information, and other information. In at least one embodiment, databases may reside in a variety of locations. In at least one embodiment, one or more of databases may reside on a non-transitory storage medium local to (and/or resident in) the respective servers 102. In at least one embodiment, the databases may be remote from the respective servers 102 and in communication with the respective servers 102 via a network-based or dedicated connection. In at least one embodiment, the databases may reside in a storage-area network (SAN). In at least one embodiment, any necessary files for performing functions attributed to the respective servers 102 may be stored locally on the respective servers 102 and/or remotely, as appropriate. In at least one embodiment, the databases may include relational databases, such as databases that are adapted to store, update, and retrieve data in response to SQL-formatted commands.

FIGS. 2, 3, 4, and 5 illustrate example servers 202, 302, 402, and 502, respectively, in accordance with at least one embodiment. The servers 202, 302, 402, and 502, respectively may be the same as or similar to any of the servers 102a through 102n of the datacenter system 100 illustrated in FIG. 1 and may implement and/or include any of the components, systems, or operations described in any one or more figures of the figures provided herein including those from FIGS. 1 and 3 through 46. For instance, the datacenter system 100 may implement and/or include the databases 1014 and 1016 illustrated in FIG. 10. Additionally, any one or more of the components, system, or operations described in any one or more figures of the figures provided herein including those from FIGS. 1 and 3 through 46 may be implemented into and/or included with the datacenter system 100, its respective components, and any associated operations described therewith.

As shown in FIG. 2, the servers 202 may include electronic components 122 each having one or more sets of one or more processors and power-on control circuitry so that individual electronic components may modulate a time when the individual processor(s) themselves power(s)-up. For example, the first electronic component 122a may include the first set of one or more processors 206a and a first power on control circuitry 208a, the second electronic component 122b may include the second set of one or more processors 206b and a second power on control circuitry 208b, and the nth electronic component 122n may include the nth set of one or more processors 206n and an nth power on control circuitry 208n. The first power-on control circuitry 208a of the first electronic component 122a may modulate a time when a portion of the first electronic device 122a (for example, the first set of one or more processors 206a) powers-up, the second power on control circuitry 208b of the second electronic component 122b may modulate a time when a portion of the second electronic device 122b (for example, the second set of one or more processors 206b) powers-up, and the nth power on control circuitry 208n of the nth electronic component 122n may modulate a time when a portion of the nth electronic device 122n (for example, the nth set of one or more processors 206n) powers-up. It should be understood that the power-on control circuitry 208 may power-up when an input (for example, power) is received by the electronic component. The power-on control circuitry 208 may then modulate when a portion of the electronic component that did not power-up when the power-on control circuitry 208 powered-up powers-up.

For instance, one or more signals may be transmitted (for example, from a higher level main power-on control circuitry, from a user terminal, or the like) via the one or more networks 110 for respective electronic components 122 of a plurality of electronic components 122 requesting/commanding/instructing that those respective electronic components 122 be powered-up for use. Power-on control circuitry 208 of an electronic component 122 may receive a signal to initiate power-up for that particular electronic component to power-up (for example, set of processors). In other words, each power-on control circuitry 208 for each individual electronic component 122 may individually receive a signal to power-up (for example, a power-up signal) so the plurality of electronic components each receive a signal to power-up (for example, at the same time or at contemporaneous times). In response to receiving the signal for the individual electronic components to power-up, the power-on control circuitry 208 may modulate a time when that individual electronic components 122 powers-up. As such, the plurality of electronic components 122 may receive a signal to power-up so that each individual power-on control circuitry may modulate a time when that individual electronic components 122 powers-up so that the individual power-on control circuitries 208n for respective processors 206 may vary when power is drawn by the plurality of electronic components 122 and from the one or more power sources 104. This creates a high likelihood that power drawn from the one or more power sources 104 does not occur at the same time. Preventing power from being drawn by the individual electronic components 122 from the one or more power sources 104 at the same time may reduce the total amount of power drawn by the plurality of electronic components 122 for power-up to an amount that is below a maximum amount of power that one or more power sources 104 is capable of providing (for example, supplying) to the server 202 and/or is permitted to provide to the server 202.

Using power-on control circuitry 208n to manage power-up of individual electronic components 122 of a plurality of electronic components 122 may have some advantages. For instance, additional datacenter system configuration steps for coordinating and/or managing sequencies to determine when individual electronic components 122 are powered-on may be reduced or eliminated. For example, individual electronic components 122 having power-on control circuitry 208 may be installed into a server 202 without programming the power-on control circuitry 208 to specifically coordinate with any other particular electronic components 122 and/or any other power-on control circuitries 208n. In some cases, a main power-on control circuitry (for example, main power-on control circuitry 112) may not be needed so that additional datacenter system configuration steps implemented for the main power-on control circuitry may not be needed during installation of the individual electronic components 122. For instance, no programming of a main power-on control circuitry may be needed so that the main power-on control circuitry knows how much power each individual electronic components 122 draws for power-up and how much time each electronic components 122 draws power for power-up as well as how much power each individual electronic components 122 draws after power-up during operation and thus knows which power-up signal to intercept. In some cases, a main power-on control circuitry may not be needed so that additional datacenter system configuration steps implemented for the main power-on control circuitry may not be needed during installation of the individual electronic components 122 of the plurality of electronic components 122. For instance no programming of a main power-on control circuitry may be needed so that the main power-on control circuitry knows which power sources the plurality of electronic components 122 may be used for power-up (for example, as well as after power-up during operational use) and how much power is available and/or permitted to be drawn for the plurality of electronic components 122.

The power-on control circuitry 208 of the electronic component 122 may modulate the time when the electronic components 122 is to power-up based on a random time generated by the power-on control circuitry 208 for the respective electronic components 122 to power-up. For example, the server 202 may include a first electronic components 122a, a second electronic components 122b, and a nth electronic components 122n all installed in server 202 to receive power from a same or shared one or more power sources 104. The first electronic component 122a may include a set of one or more processors 206a and first power-on control circuitry 208a, the second electronic component 122b may a second set of one or more processors 206b and second power-on control circuitry 208b, and the nth set of one or more processors 206n may include an nth set of one or more processors 206n and nth power-on control circuitry 208n.

Each of the power-on control circuitries 208 may individually and autonomously generate a random time to initiate power-up for their respective electronic components. For instance, the first power-on control circuitry 208a of the first electronic component 122a, the second power-on control circuitry 208b of the second electronic component 122b, and the nth power-on control circuitry 208n of the nth electronic component 122n may all receive (for example, at a same time, at contemporaneous times) a signal to power-up (for example, from a higher level main power-on control circuitry, from a user terminal, or the like) via the one or more networks 110 for their respective sets of one or more processors 206a, 206b, and 206n. In response to receiving the signal(s), the first power-on control circuitry 208a of the first electronic component 122a may autonomously generate a random first time for the first set of one or more processors 206a to power-up, the second power-on control circuitry 208b of the second electronic component 122b may autonomously generate a random second time for the second set of one or more processors 206b to power-up, and the nth power-on control circuitry 208n of the nth electronic component 122n may autonomously generate a random nth time for the nth set of one or more processors 206n to power-up. With the individual power-on control circuitries 208 autonomously generating random times for the respective sets of processor(s) 206 to power-up, a high probability is created that all of the respective sets of processor(s) 206 will not power-up at a same time and/or that all of the respective sets of processor(s) 206 will not have overlapping (or will have limited or short overlapping) power-up durations thereby limiting the amount of power that the one or more power sources 104 (for example, one or more shared power sources) provides to be below a maximum amount of power that the one or more power sources 104 is capable of providing (for example, supplying) to the plurality of electronic components 122 and/or is permitted to provide to the plurality of electronic component 122.

The random time generated by the respective power-on control circuitries 208n to power-up the respective electronic components 122 may be a random time within a limited time window. In at least one embodiment, the limited time windows may be varying or different limited time windows. For example, the first power-on control circuitry 208a may generate a random time within a first time window (for example, a random time within one (1) minute of receiving a signal to power-up the first set of processor(s)). The second power-on control circuitry 208b may generate a random time within a second time window (for example, a random time within three (3) minutes of receiving a signal to power-up the second set of processor(s)). The nth power-on control circuitry 208n may generate a random time within a nth time window (for example, a random time within six (6) minutes of receiving a signal to power-up the nth set of processor(s)). Thus, upon each of the first power-on control circuitry 208a, the second power-on control circuitry 208b, and the nth power-on control circuitry 208n receiving a signal to power-up their respective electronic components (for example, sets of processor(s) 206a, 206b, and 206n (for example, at the same time or at contemporaneous times)), the different time windows for generating the respective random times for powering-up the respective electronic components 122 may create a high likelihood that the respective electronic components will not fully power-up at the same time and/or will have minimal overlapping full power-up durations.

The limited random time may be a same limited random time window. For example, the first power-on control circuitry 208a may generate a random time within a limited time window that is shared by the second power-on control circuitry 208b and the nth power-on control circuitry 208n. Thus, upon each of the first power-on control circuitry 208a, the second power-on control circuitry 208b, and the nth power-on control circuitry 208n receiving (for example, at the same time, at contemporaneous times) a signal to power-up their respective electronic components 122a, 122b, 122n (for example, respective sets of processors 206a. 206b, and 206n), the same limited time window for generating the respective random times for powering-up the respective electronic component 122 may create a high likelihood that the respective electronic component 122 will not fully power-up at the same time and/or will have minimal overlapping full power-up durations.

The limited time window may be a predetermined limited time window. For example, the first power-on control circuitry 208a may generate a random time within a first limited time window, the second power-on control circuitry 208b may generate a random time within a second limited time window, and the nth power-on control circuitry 208n may generate a random time within a nth limited time window. The first, second, and nth limited time windows may be a same predetermined limited time window (for example, a five (5) minute predetermined time window) (for example, programmed into the respective power-on control circuitries before installation) to create a high likelihood that the respective sets of processor(s) will not power-up at the same time and/or will have minimal overlapping power-up durations. The predetermined limited time window for the respective electronic component 122 may be predetermined based on how much time is needed for the power-up procedures for each of the respective electronic component to completely power-up, how much time is needed for the power-up procedures for the combined electronic components to completely power-up, how much power is needed to power-up each of the respective electronic components relative to the maximum amount of power that the one or more power sources is capable of providing (for example, supplying) to the plurality of electronic components and/or is permitted to provide to the plurality of electronic components, the quantity of electronic components using the same one or more power sources and receiving a signal to power-up, and/or the like. Thus, upon each of the first power-on control circuitry 208a, the second power-on control circuitry 208b, and the nth power-on control circuitry 208n receiving (for example, at a same time, at contemporaneous times) a signal to power-up their respective electronic components, the predetermined limited time window for generating the respective random times for powering-up the electronic components may create a high likelihood that the respective electronic components will not fully power-up at the same time and/or have overlapping full power-up durations. It should be understood that the predetermined limited time window may be a same predetermined limited time window for the plurality of power-on control circuitries and their respective sets of processor(s) (for example, sharing a same one or more power sources) or that the predetermined limited time window may be different predetermined limited time windows such that at least two power-on control circuitries and their respective sets of processor(s) have predetermined limited time windows that are different from each other.

The limited time window may be a variable or a configurable limited time window. For example, the first power-on control circuitry 208a may generate a random time within a first limited time window, the second power-on control circuitry 208b may generate a random time within a second limited time window, and the nth power-on control circuitry 208n may generate a random time within a nth limited time window. The first, second, and nth limited time windows may be individually variable or configurable (for example, configured by the respective power-on control circuitries, configured by a main power-on control circuitry) to create a high likelihood that the respective electronic components will not fully power-up at the same time and/or will have minimal overlapping full power-up durations. The variable or configurable limited time windows for the respective electronic components may be determined (for example, by the respective power-on control circuitries, by a main power-on control circuitry) based on how much time is needed for the power-up procedures for each of the respective electronic components to completely power-up, how much time is needed for the power-up procedures for the combined electronic components to completely power-up, how many electronic components of the plurality of electronic components have previously powered-up and are currently drawing power from the one or more power sources for operation(s), how many electronic components of the plurality of electronic components are currently powering-up and are currently drawing power from the one or more power sources for powering-up, how many electronic components of the plurality of electronic components are going to power-up but have not yet done so, how much power is needed to power-up each of the respective electronic components relative to the maximum amount of power that the one or more power sources are capable of providing (for example, supplying) to the plurality of electronic components and/or are permitted to provide to the plurality of electronic components, the quantity of electronic components using the same one or more power sources and receiving a signal to power-up, how much power is needed to maintain power for each of the respective electronic components after power-up and during operation relative to the maximum amount of power that the one or more power sources are capable of providing (for example, supplying) to the plurality of electronic components and/or are permitted to provide to the plurality of electronic components, the quantity of electronic components using the same one or more power sources and receiving a signal to power-up, and/or the like. It should be understood that the variable or configured limited time window may be a same variable or configured limited time window for the plurality of power-on control circuitries 208n and their respective electronic components (for example, sharing a same one or more power sources) (for example, when the plurality of power-on control circuitries and their respective processors are communicating with a main power-on control circuitry and/or each other) or that the variable or configurable limited time window may be different limited time windows such that at least two power-on control circuitries 208n and their respective electronic components (for example, sharing a same one or more power sources) have variable or configured limited time windows configured independently of each other (for example, by the respective power-on control circuitries, by a main power-on control circuitry) (for example, when the plurality of power-on control circuitries 208n and their respective electronic components 206 are communicating with a main power-on control circuitry and/or each other).

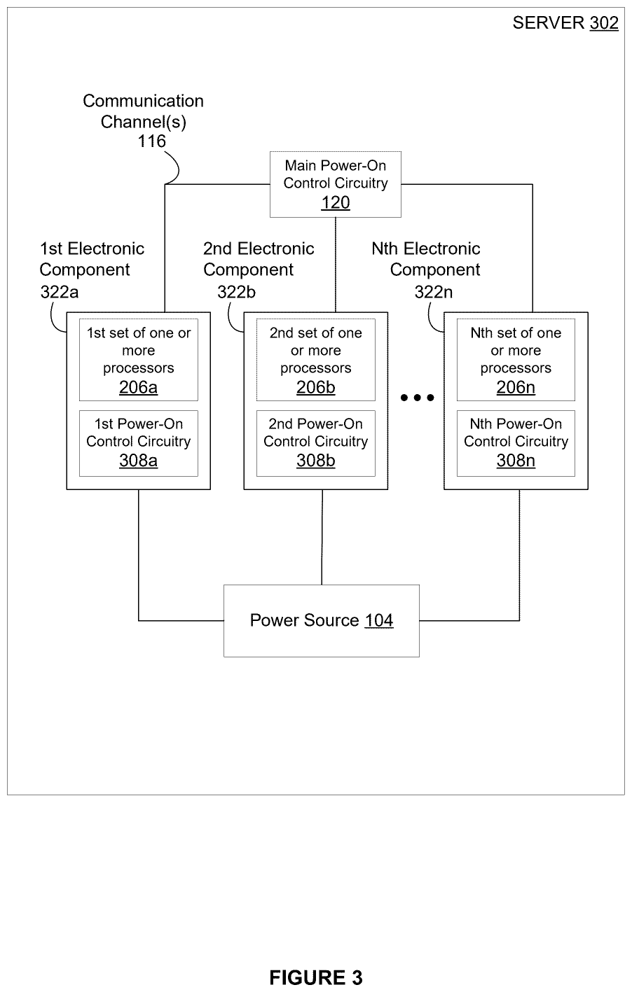

As shown in FIG. 3, in at least one embodiment, the server 302 may include a main power-on control circuitry 120. In at least one embodiment, respective power-on control circuitries 308 (for example, a first power-on control circuitry 308a for the first electronic component 322a, a second power-on control circuitry 308b for the second electronic component 322, an nth power-on control circuitry 308n for the nth electronic component 322n) may modulate the time when the respective electronic components 322 power-up based on a received control signal from the main power-on control circuitry 120 that is received in response to a request sent by the power-on control circuitry 308 to the main power-on control circuitry 120 requesting that the respective electronic components 322 power-up. For example, a plurality of power-on control circuitries 308 and the respective electronic components 322 may be in electronic communication with a main power-on control circuitry 120 and electrically connected to one or more power sources 104 for receiving electrical power. The plurality of power-on control circuitries 308 and the respective electronic components 322 may also be in electronic communication with communication channels so that the plurality of power-on control circuitries 308 are able to receive and send electronic communications with a higher level main power-on control circuitry, a user terminal, or the like via the one or more networks 110. In at least one embodiment, the plurality of power-on control circuitries 308 of the respective electronic components 322 may be in electronic communication with, via the communication channels 116, the main power-on control circuitry 120. In at least one embodiment, the plurality of power-on control circuitries 308 of the respective electronic components 322 may be electrically connected to one or more power sources for receiving electrical power. In at least one embodiment, the plurality of power-on control circuitries 308 of the respective electronic components 322 may be in electronic communication with one or more networks 110 via one or more communication channels that are separate from and/or different than the communication channels with the main power-on control circuitry 112. In at least one embodiment, the plurality of power-on control circuitries 308 of the respective electronic components 322 may be electrically connected to one or more power sources 104 for receiving electrical power via one or more electrical power connections that are separate from and/or different than the electrical connections with the main power-on control circuitry 120.

One or more signals may be transmitted (for example, from a higher level main power-on control circuitry, from a user terminal, or the like via the one or more networks 110) for respective electronic components 322 requesting/commanding/instructing that those respective electronic components 322 be powered-up for use. The power-on control circuitries 308 of the respective electronic components 322 may receive the one or more signals and may individually and autonomously modulate a time when the respective electronic components 322 fully power on. For example, the power-on control circuitries 308 of the respective electronic components 322 may individually and autonomously generate a random time for their respective sets of processor(s) 206a, 206b, and 206n (and/or other components of the electronic component 322) to power-up in response to receiving the one or more signals. The random time generated by the power-on control circuitries 308 for the respective electronic components 322 (for example, sets of processor(s) 206a, 206b, and 206n) to power-up may include a random time within a limited time window. As described herein, the limited time window may be a predetermined limited time window or a variable or configurable limited time window. In at least one embodiment, the power-on control circuitries 308 for the respective electronic components 322 may subsequently power-up their respective sets of processor(s) 206a. 206b, and 206n in accordance with their individually generated random power-up times. The power-on control circuitries 308 may then transmit a signal to the main power-on control circuitry 120 informing the main power-on control circuitry 120 that the respective electronic components 322 have been fully powered-up and/or have completed power-up and are currently operating.

For instance, a server 302 may include a plurality of electronic components 322. Respective electronic components 322 may include a power-on control circuitry 208n and a set of one or more processors 206. The electronic components 322 may also be in electronic communication with a main power-on control circuitry 120 and a network 110 (for example, for communicating with a higher level main power-on control circuitry, a user terminal, or the like). The plurality of electronic components 322 may also be in electrical communication with one or more power source(s) 104 for powering-up the plurality of electronic components 322 and for providing power for the plurality of electronic components 322 during operation(s). A power-on control circuitry 308 of an electronic component 322 may receive an input (for example, a signal or power) indicating that the electronic component 322 is to power-up. Responsive to receiving the one or more signals, the power-on control circuitry 308 may generate a random time for the electronic component 322 to fully power-up. The random time generated by the power-on control circuitry 308 to power-up the electronic component 322 may include a random time within a limited time window. As described herein, the limited time window may be a predetermined limited time window or a variable or configurable limited time window.

When the random generated time expires, the power-on control circuitry 308 may send a signal to the main power-on control circuitry 120 requesting that the electronic component 322 fully power-up. The main power-on control circuitry 120 in communication with the power-on control circuitry 308 of the electronic component 322 may determine a power-up status of each of the respective electronic components 322 and/or the maximum amount of power that the one or more power sources 104 are capable of providing (for example, supplying) to the electronic components 322 and/or are permitted to provide to the electronic components 322. In at least one embodiment, the main power-on control circuitry 120 may determine how much time is needed for the power-up procedures for each of the respective electronic components 322 to completely power-up, how much time is needed for the power-up procedures for the combined electronic components 322 to completely power-up, how many electronic components 322 of the plurality of electronic components 322 have previously powered-up and are currently drawing power from the one or more power sources for operation(s), how many electronic components 322 of the plurality of electronic components 322 are currently powering-up and are currently drawing power from the one or more power sources for powering-up, how many electronic components 322 of the plurality of electronic components 322 are going to power-up but have not yet done so, how much power is needed to power-up each of the respective electronic components 322 relative to the maximum amount of power that the one or more power sources are capable of providing (for example, supplying) to the plurality of electronic components 322 and/or are permitted to provide to the plurality of electronic components 322, the quantity of electronic components 322 using the same one or more power sources and receiving a signal to power-up, how much power is needed to maintain power for each of the respective sets of electronic components 322 after power-up and during operation relative to the maximum amount of power that the one or more power sources are capable of providing (for example, supplying) to the plurality of electronic components 322 and/or are permitted to provide to the plurality of electronic components 322, the quantity of electronic components 322 using the same one or more power sources and receiving a signal to power-up, and/or the like.

Based on a power-up status of each of the electronic components 322, and/or the maximum amount of power that the one or more power sources 104 are capable of providing (for example, supplying) to the plurality of electronic components 322 and/or are permitted to provide to the plurality of electronic components 322, for example, the main power-on control circuitry 120 may determine whether one electronic components 322 can or should power-up. For instance, the main power-on control circuitry 120 may send a signal to the first electronic component 322a indicating whether or not the first electronic component 322 is to fully power-up. If the first power-on control circuitry 308a determines based on the signal from the main power-on control circuitry 120 that, for example, the first set of one or more processors 206a is not to power-up, then the first power-on control circuitry 308a generates another random time for the first electronic component 322a to subsequently power-up repeating the aforementioned processes. If the first power-on control circuitry 308a determines based on the signal from the main power-on control circuitry 120 that the first set of one or more processors 206a is to power-up causing the first electronic component 322a to fully power-up, then the first power-on control circuitry 308a initiates power-up of the first set of one or more processors 206a of the first electronic component 322a.

Upon the first power-on control circuitry 308a initiating power-up of the first set of one or more processors 206a, the first power-on control circuitry 308a may send a signal to the main power-on control circuitry 120 informing the main power-on control circuitry 120 that the first electronic component 322 is fully powering-up. This may inform the main power-on control circuitry 120 of the powering-up status of the first electronic component 322a so that if the second power-on control circuitry 208b or the nth power-on control circuitry 208n requests power-up of the second electronic component 322b or the nth electronic components 322n, respectively, the main power-on control circuitry 120 may know the status of the first electronic component 322a and provide a signal to the second electronic component 322b or the nth electronic component 322n, respectively indicating whether the second electronic component 322b or the nth electronic component 322n, respectively, have permission to fully power-up. Doing so may allow the main power-on control circuitry 120 to ensure that the amount of power from the one or more power sources 104 stays below the maximum amount of power that the one or more power sources 104 are capable of providing (for example, supplying) to the plurality of electronic components 322 and/or are permitted to provide to the plurality of electronic components 322.

Subsequently, the first power-on control circuitry 208a may continue to monitor the first electronic component 322a to determine when the first electronic component 322 (for example, the first set of one or more processors 206a) are no longer powering-up (for example, are finished powering-up) and are now in an operational state. Upon the first power-on control circuitry 308a determining that the first electronic component 322a is no longer powering-up and is now in the operational state, the first power-on control circuitry 308a may send a signal to the main power-on control circuitry 120 informing the main power-on control circuitry 112 that the first electronic components 322a is no longer powering-up and is now in the operational state. This may inform the main power-on control circuitry 120 of the operational status of the first electronic component 322a so that if the second power-on control circuitry 308b or the nth power-on control circuitry 308n requests power-up of the second electronic component 322b (for example, the second set of one or more processors 206b) or the nth electronic component 322n (for example, the nth set of one or more processors 206n), respectively, the main power-on control circuitry 120 may know the status of the first electronic component 322a and provide a signal to the second power-on control circuitry 308b or the nth power-on control circuitry 308n, respectively, indicating whether the second electronic component 322b or the nth electronic component 322n, respectively, have permission to fully power-up. This may be important because powering-up the first electronic component 322a may require more power from the one or more power sources 104 compared to when the first electronic component 322a are in the operational state. As such, inform the main power-on control circuitry 120 of the operational status of the first electronic component 322a may allow the main power-on control circuitry 120 to ensure that the amount of power from the one or more power sources 104 stays below the maximum amount of power that the one or more power sources 104 are capable of providing (for example, supplying) to the plurality of electronic components 322 and/or are permitted to provide to the plurality of electronic components 322.

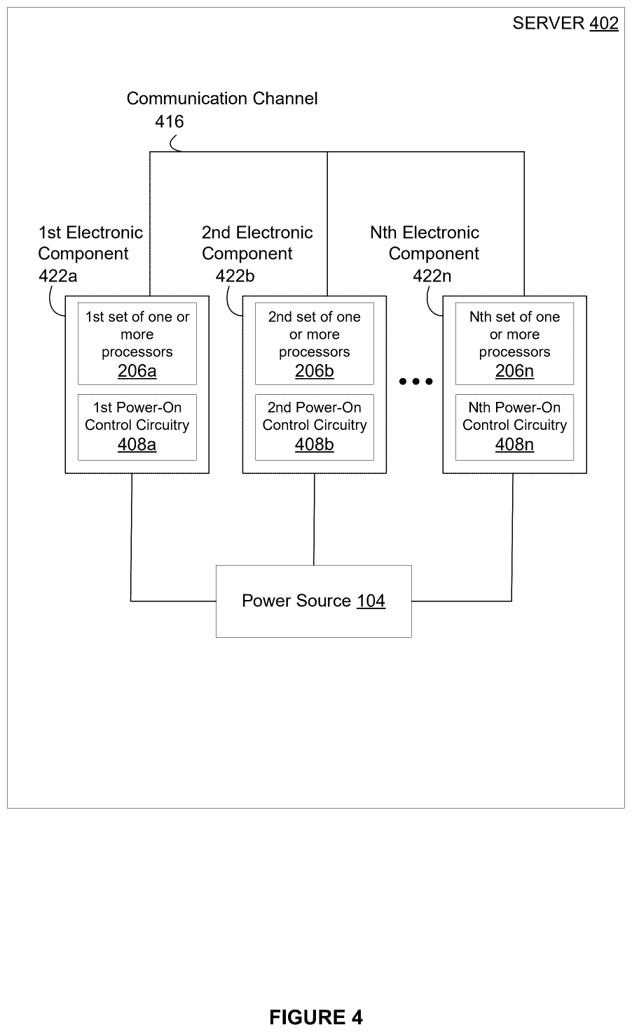

As shown in FIG. 4, in at least one embodiment, respective power-on control circuitries 408a, 408b, and 408n may modulate the time when the respective electronic components 422 (for, example sets of processor(s) 206a, 206b, and 206n) fully power-up based on direct communication between the power-on control circuitry 408 and at least one other power-on control circuitry 408 of at least one other electronic component 422, the direct communication indicating a respective power on status for one or more other processors 206. For example, a plurality of power-on control circuitries 408a, 408b, and 408n of the respective electronic components 422a. 422b, and 422n may be in electronic communication with each other and electrically connected to power sources 104 for receiving electrical power. For instance, the plurality of power-on control circuitries 208a, 208b, and 208n of the respective electronic components 422 may be in electronic communication with each other via a direct communication channel 416. For example, when the plurality of electronic components 422 are in either an off-state or an operation state, a respective power-on control circuits 408a, 408b, and 408n may transmit a low signal via the direction communication channel 416 informing the other power-on control circuitries 408a, 408b, and 408n that none of the plurality of electronic components 422 are fully powering-up (for example, in power-up state). In at least one embodiment, one or more of the power-on control circuitries 408a, 408b, and 408n may transmit a high signal via the direct communication channel 416 informing the other power-on control circuitries 408a. 408b, and 408n when, for example, those electronic components 422 are fully powering-up. As described herein, respective power-on control circuitries 408a, 408b, and 408n may use high and low signals on the direct communication channel 416 to determine whether to initiate a fully powering-up of the respective electronic components 422.

The plurality of power-on control circuitries 408a, 408b, and 408n of the respective electronic components 422a. 422b, and 422n may also be in electronic communication with the one or more networks 110 so that the plurality of power-on control circuitries 408 are able to receive and send electronic communications with a higher level main power-on control circuitry, a user terminal, or the like. In at least one embodiment, the plurality of power-on control circuitries 408 of the respective electronic components 422a, 422b, and 422n may be in electronic communication with the one or more networks 110. In at least one embodiment, the plurality of electronic components 422a, 422b, and 422n and their respective power-on control circuitries 408a, 408b, and 408n may be electrically connected to one or more power sources 104 for receiving electrical power.

One or more signals may be transmitted (for example, from a higher level main power-on control circuitry, from a user terminal, or the like) for respective electronic components 422 requesting/commanding/instructing that those respective electronic components 422 be fully powered-up for use. The power-on control circuitries 408 of the electronic components 422 may receive the one or more signals and may individually and autonomously modulate a time when the respective electronic components 422 (for example, the respective sets of processor(s) 206a. 206b, and 206n and/or other components) fully power on. For example, the power-on control circuitries 408 of the respective electronic components 422 may individually and autonomously generate a random time for their respective electronic components 422 to fully power-up in response to receiving the one or more signals. The random time generated by the power-on control circuitries 408 for their respective electronic components 422 to fully power-up may include a random time within a limited time window. As described herein, the limited time window may be a predetermined limited time window or a variable or configurable limited time window. In at least one embodiment, the power-on control circuitries 408 for the respective electronic components 422 may subsequently power-up their respective electronic components 422 (for example, their respective sets of processor(s) 206a. 206b, and 206n) in accordance with their individually generated random power-up times. The power-on control circuitries 408 may then determine whether a high signal is present on the direct communication channel 416 indicating that one or more particular electronic components 422 associated with one or more particular power-on control circuitry 408 is fully powering-up or whether a low signal is present on the direct communication channel 416 indicating that few or none of the electronic components 422 associated with respective power-on control circuitries 408 are fully powering-up and that respective electronic components 422 have been powered-up and/or have completed power-up and are currently operating.

For instance, a server 402 of a plurality of servers 402 may include a plurality of electronic components 422. The plurality of electronic components 422 may each include power-on control circuitry 408 and a set of one or more processors 206. The electronic components 422 may be in electronic communication with each other via a direct communication channel 416 and a network 110 (for example, for communicating with a higher level main power-on control circuitry, a user terminal, or the like). The electronic components 422 may also be in electrical communication with the power source(s) 104 for powering-up the electronic components 422 and for providing power for the electronic components 422 during operation(s). A first power-on control circuitry 408a of a first electronic component 422a on a server 402 may receive an input (for example, a signal or power) indicating that the first electronic component 422a is to fully power-up. For example, the first power-on control circuitry 208a may receive one or more signals (for example, an input) (for example, from a higher level main power-on control circuitry, from a user terminal, or the like) requesting/commanding/instructing that the first set of one or more processors 206a is to powered-up for use. Responsive to receiving the one or more signals, the first power-on control circuitry 408a may generate a random time for the first electronic component 422a (for example, the first set of one or more processors 206a) to fully power-up. The random time generated by the first power-on control circuitry 408a to power-up the first electronic component 422a may include a random time within a limited time window. As described herein, the limited time window may be a predetermined limited time window or a variable or configurable limited time window.

When the random generated time expires, the first power-on control circuitry 408a may determine whether one or more other electronic components 422 are powering-up. For instance, the first power-on control circuitry 408a may determine whether a high signal is present on the direct communication channel 416 shared by the first electronic component 422a, the second electronic component 422b, and the nth electronic component 422n. A high signal on the direct communication channel 416 may indicate that the second electronic component 422b and/or the nth electronic component 422n is fully powering-up. Conversely, a low signal on the direct communication channel 116 may indicate that fewer or none of the second electronic component 422b and/or the nth electronic component 422n is powering-up (for example, are in an off state or an operational state).

Based on whether the first power-on control circuitry 408a detects a high signal (for example, indicating that at least one other set of one or more processors are fully powering-up) or a low signal (for example, indicating that fewer or no other electronic components are fully powering-up) on the direct communication channel 416 between the plurality of power-on control circuitries 206, the first power-on control circuitry 408a may determine whether the first electronic component 422a can or should fully power-up. For instance, if the first power-on control circuitry 408a determines based on receiving a high signal on the direct communication channel 416 indicating that at least one electronic component is currently fully powering-up, then the first power-on control circuitry 408a may generate another random time for the first electronic component 422a to subsequently fully power-up repeating the aforementioned processes. If the first power-on control circuitry 408a determines based on receiving a low signal on the direct communication channel 416 indicating that fewer or no electronic component 422 are currently powering-up, then the first power-on control circuitry 408a may initiate power-up of the first electronic component 422a.

Upon the first power-on control circuitry 408a initiating power-up of the first electronic component 422a, the first power-on control circuitry 408a may send a high signal on the direct communication channel 416 indicating to the other power-on control circuitries 408b, 408n that the first electronic component 422a is fully powering-up. This may inform the other electronic components (for example, the other power-on control circuitries 408b, 408n) of the powering-up status of the first electronic component 422a so that if the second electronic component 422b or the nth electronic component 422n seeks power-up, those other power-on control circuitries 408b, 408n may know the status of the first electronic component 422a and may each generate another random time for the second electronic component 422b and the nth electronic component 422n to subsequently power-up repeating the aforementioned processes. Doing so may allow the amount of power from the power source(s) 104 to stay below the maximum amount of power that the power source(s) 104 are capable of providing (for example, supplying) to the plurality of electronic components 422 and/or are permitted to provide to the plurality of electronic components 422.

Subsequently, the first power-on control circuitry 208a may continue to monitor the first electronic components 422a to determine when the first electronic components 422a is no longer fully powering-up (for example, is finished fully powering-up) and is now in an operational state. Upon the first power-on control circuitry 408a determining that the first electronic components 422a is no longer powering-up and is now in the operational state, the first power-on control circuitry 408a may no longer send a high signal on the direct communication channel 416 (for example, and send a low signal, send no signal at all) informing the other power-on control circuitries 408b, 408n that the first electronic components 422a is no longer powering-up and is now in the operational state. This may inform the other power-on control circuitries 408b, 408n of the operational status of the first electronic components 422a so that if the second power-on control circuitry 408b or the nth power-on control circuitry 408n seeks power-up of the second electronic components 422b or the nth electronic components 422n, respectively, the other power-on control circuities 408b, 408n may know the status of the first electronic components 422a and determine whether the second electronic components 422b or the nth electronic components 422n, respectively, have permission to fully power-up. This may be important because powering-up the first electronic components 422a may require more power from the power source(s) 104 compared to when the first electronic components 422a is in the operational state. As such, informing the other power-on control circuitries 408b, 408n of the operational status of the first electronic components 422a may allow the other power-on control circuitries 408b, 408n to ensure that the amount of power from the power source(s) 104 stays below the maximum amount of power that the power source(s) 104 are capable of providing (for example, supplying) to the plurality of electronic components 422 and/or are permitted to provide to the plurality of electronic components 422.

Additionally, or alternatively, each of the first power-on control circuitry 408a, the second power-on control circuitry 408b, and the nth power-on control circuitry 408n may sending signals to each other on the direct communication channel 116 indicating whether their respective electronic components 422 are specifically in an off state, a power-up state, or an operation state. The first power-on control circuitry 408a may also determine the maximum amount of power that the power source(s) 104 are capable of providing (for example, supplying) to the plurality of electronic components 422 and/or are permitted to provide to the plurality of electronic components 422. In at least one embodiment, the signals sent between the respective power-on control circuitries may allow the first power-on control circuitry 408a to determine how much time is needed for the power-up procedures for each of the other respective sets of electronic components 422 to completely power-up, how much time is needed for the power-up procedures for the combined electronic components 422 to completely power-up, how many electronic components 422 of the plurality of electronic components 422 have previously powered-up and are currently drawing power from the power source(s) for operation(s), how many electronic components 422 of the plurality of electronic components 422 are currently powering-up and are currently drawing power from the power sources for powering-up, how many electronic components 422 of the plurality of electronic components 422 are going to power-up but have not yet done so, how much power is needed to power-up each of the respective electronic components 422 relative to the maximum amount of power that the one or more power sources are capable of providing (for example, supplying) to the plurality of electronic components 422 and/or are permitted to provide to the plurality of electronic components 422, the quantity of electronic components 422 using the same power source(s) and receiving a signal to power-up, how much power is needed to maintain power for each of the respective electronic components 422 after power-up and during operation relative to the maximum amount of power that the power sources are capable of providing (for example, supplying) to the plurality of electronic components 422 and/or are permitted to provide to the plurality of electronic components 422, the quantity of electronic components 422 using the same one or more power sources and receiving a signal to power-up, and/or the like.

Based on a power-up status of each of the second and nth electronic components 422, and/or the maximum amount of power that the one or more power sources 104 are capable of providing (for example, supplying) to the plurality of electronic components 422 and/or are permitted to provide to the plurality of electronic components 422, for example, the first power-on control circuitry 408a may determine whether the first electronic components 422a can or should power-up. If the first power-on control circuitry 408a determines based on the signals from the other power-on control circuities 408b, 408n that the first electronic components 422a is not to power-up, then the first power-on control circuitry 408a may generate another random time for the first electronic components 422a to subsequently power-up repeating the aforementioned processes. If the first power-on control circuitry 408a determines based on the signal from the other power-on control circuities 408b, 408n that the first electronic components 422a is to power-up, then the first power-on control circuitry 408a may initiate full power-up of the first electronic components 422a.

Upon the first power-on control circuitry 408a initiating power-up of the first electronic components 422a, the first power-on control circuitry 408a may send a signal to the other power-on control circuities 408b, 408n informing the other power-on control circuities 408b, 408n that the first electronic components 422a is fully powering-up. This may inform the other power-on control circuities 408b, 408n of the powering-up status of the first electronic components 422a so that if the second power-on control circuitry 408b or the nth power-on control circuitry 408n seeks power-up of the second electronic components 422b or the nth electronic components 422n, respectively, the other power-on control circuities 408b, 408n may know the status of the first electronic components 422a and determine whether their respective electronic components 422b, 422n (for example, respective sets of one or more processors 206b, 206n) can or should fully power-up. Doing so may allow the power-on control circuities 408a, 408b, and 408n to ensure that the amount of power from the power source 104 stays below the maximum amount of power that the power source 104 is capable of providing (for example, supplying) to the plurality of electronic components 422 and/or are permitted to provide to the plurality of electronic components 422.

Subsequently, the first power-on control circuitry 408a may continue to monitor the first electronic components 422a to determine when the first electronic components 422a are no longer powering-up (for example, are finished powering-up) and are now in an operational state. Upon the first power-on control circuitry 408a determining that the first electronic components 422a is no longer powering-up and is now in the operational state, the first power-on control circuitry 408a may send a signal via the direct communication channel 416 to the other power-on control circuities 408b, 408n informing the other power-on control circuities 408b, 408n that the first electronic components 422a is no longer powering-up and is now in the operational state. This may inform the other power-on control circuities 408b, 408n of the operational status of the first electronic components 422a so that if the second power-on control circuitry 408b or the nth power-on control circuitry 408n seeks power-up of the second electronic components 422b or the nth electronic components 422n, respectively, the other power-on control circuities 408b, 408n may know the status of the first electronic components 422a and determine whether their respective electronic components 422b, 442n can or should fully power-up. This may be important because powering-up the first electronic components 422a may require more power from the power sources 104 compared to when the first electronic components 422a are in the operational state. As such, informing the other power-on control circuities 408b, 408n of the operational status of the first electronic components 422a may allow the power-on control circuities 408b, 408n to ensure that the amount of power from the power sources 104 stays below the maximum amount of power that the one or more power sources 104 are capable of providing (for example, supplying) to the plurality of electronic components 422 and/or are permitted to provide to the plurality of electronic components 422.

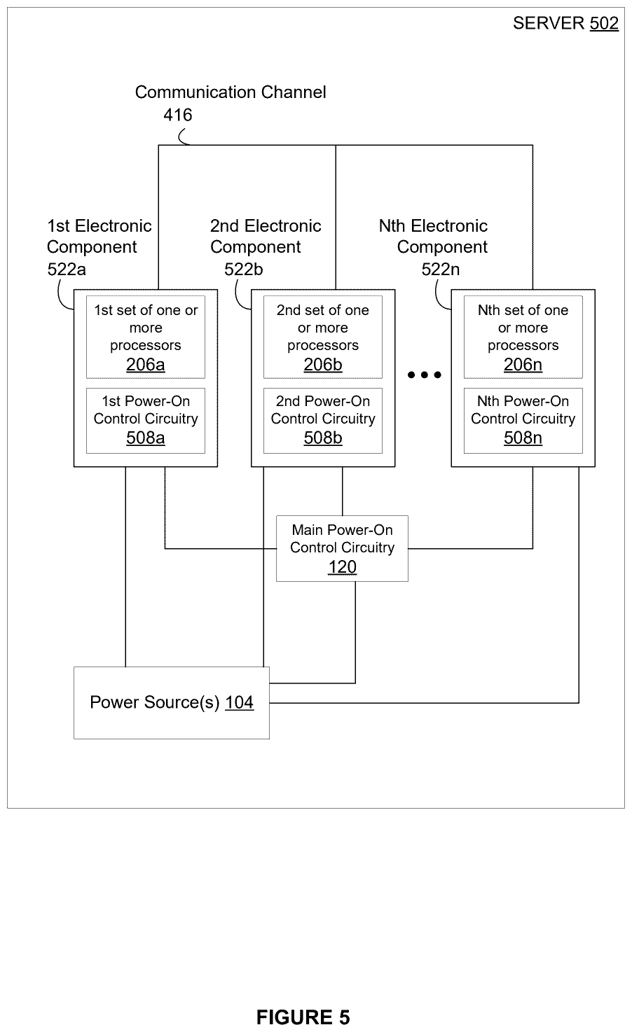

As shown in FIG. 5, the server 502 may include both the communication channel 416 for direction communication between the respective electronic components 522 (including their respective power-on control circuitries 508), as described with respect to FIG. 4 and the main power-on control circuitry 120 as described with respect to FIG. 3. For example, the communication channel 416 and the main power-on control circuitry 120 may be used in tandem with each other or as back-up components to the other.

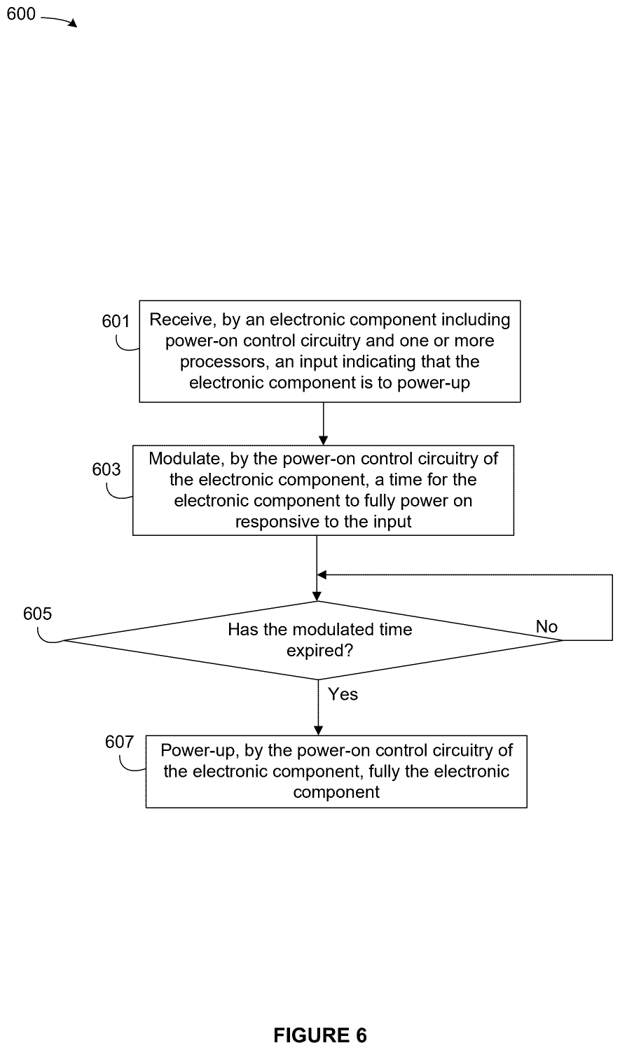

FIG. 6 illustrates an example method 600 of power-surge mitigation, in accordance with at least one embodiment. The method 600 illustrated in FIG. 6 may implement and/or include any of the components, systems, or operations described in any one or more figures of the figures provided herein including those from FIGS. 1 through 5 and 7 through 46. For instance, the method 600 may be implemented by electronic components 122, 322, 422, or 522 and/or the respective power-on control circuitries 208, 308, 408, or 508 as described herein with respect to FIGS. 1-5. Additionally, any one or more of the components, system, or operations described in any one or more figures of the figures provided herein including those from FIGS. 1 through 5 and 7 through 46 may be used to implement any one or more operations described with respect to the method 600 of FIG. 6.

At step 601, an electronic component including power-on control circuitry and one or more processors may receive an input indicating that the electronic component is to power-up. For example, one or more signals may be transmitted (for example, from a higher level main power-on control circuitry, from a user terminal, or the like) via the one or more networks 110 for respective electronic components 122 of a plurality of electronic components 122 requesting/commanding/instructing that those respective electronic components 122 be powered-up for use. Additionally, or alternatively, the electronic components 122 may receive power indicating that the electronic components 122 are to power-up. Power-on control circuitry 208 of an electronic component 122 may receive a signal to initiate power-up for that particular electronic component to power-up (for example, set of processors). In other words, each power-on control circuitry 208 for each individual electronic component 122 may individually receive a signal to power-up (for example, a power-up signal) so the plurality of electronic components each receive a signal to power-up (for example, at the same time or at contemporaneous times).

At step 603, the power-on control circuitry of the electronic component may modulate a time when the electronic component fully powers on responsive to receiving the input. For example, in response to receiving the signal for the individual electronic components to power-up or in response to the electronic component (for example, the power-on control circuitry receiving power), the power-on control circuitry may modulate a time when that individual electronic component 122 powers-up as described with respect to FIGS. 2 through 5. As such, the plurality of electronic components 122 may receive a signal to power-up so that each individual power-on control circuitry may modulate a time when that individual electronic components 122 powers-up so that the individual power-on control circuitries for respective processors may vary when power is drawn by the plurality of electronic components 122 and from the power source 104. This creates a high likelihood that power drawn from the one or more power sources 104 does not occur at the same time. Preventing power from being drawn by the individual electronic components 122 from the power source 104 at the same time may reduce the total amount of power drawn by the plurality of electronic components 122 for power-up to an amount that is below a maximum amount of power that one or more power sources 104 is capable of providing (for example, supplying) to the server 202 and/or is permitted to provide to the server 202.

At step 605, the power-on control circuitry may determine whether the modulated time has expired. At step 607, the power-on control circuitry of the electronic component may fully power-up the electronic component. For example, when the electronic component initially receives power, some components of the electronic component including the power-on control circuitry may automatically begin powering-up. These components may not draw a lot power when powering up. The power-on control circuitry may modulate other components of the electronic component (for example, one or more processors, one or more GPUs) so that the other components do not power-up immediately upon the electronic component receiving the input (for example, power). The other components may draw substantial power during power-up. As such, the power-on control circuitry may modulate a time when the other components (for example, a set of one or more processors) power-up to mitigate power-up surge on the server. When the modulated time generated by the power-on control circuitry expires, the other components of the electronic component begin powering-up so that the electronic component fully powers-up.

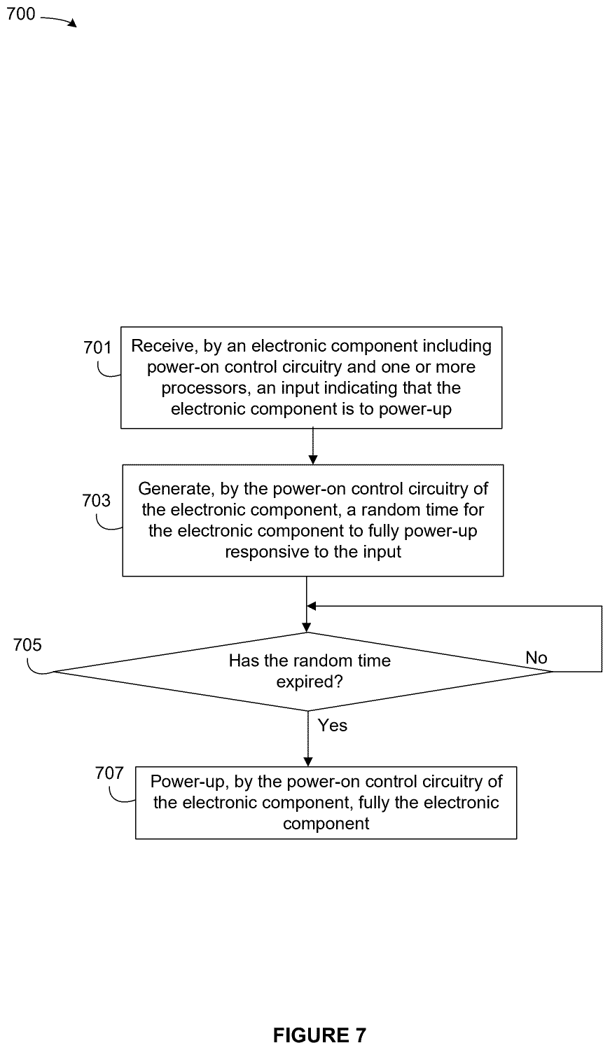

FIG. 7 illustrates an example method 700 of power-surge mitigation, in accordance with at least one embodiment. The method 700 illustrated in FIG. 7 may implement and/or include any of the components, systems, or operations described in any one or more figures of the figures provided herein including those from FIGS. 1 through 6 and 8 through 46. For instance, the method 700 may be implemented by electronic components 122, 322, 422, or 522 and/or the respective power-on control circuitries 208, 308, 408, or 508 as described herein with respect to FIGS. 1-5. Additionally, any one or more of the components, system, or operations described in any one or more figures of the figures provided herein including those from FIGS. 1 through 6 and 8 through 46 may be used to implement any one or more operations described with respect to the method 700 of FIG. 7.

At step 701, an electronic component including power-on control circuitry and one or more processors may receive an input indicating that the electronic component is to power-up. For example, one or more signals may be transmitted (for example, from a higher level main power-on control circuitry, from a user terminal, or the like) via the one or more networks 110 for respective electronic components 122 of a plurality of electronic components 122 requesting/commanding/instructing that those respective electronic components 122 be powered-up for use. Additionally, or alternatively, the electronic components 122 may receive power indicating that the electronic components 122 are to power-up. Power-on control circuitry 208 of an electronic component 122 may receive a signal to initiate power-up for that particular electronic component to power-up (for example, set of processors). In other words, each power-on control circuitry 208 for each individual electronic component 122 may individually receive a signal to power-up (for example, a power-up signal) so the plurality of electronic components each receive a signal to power-up (for example, at the same time or at contemporaneous times).

At step 703, the power-on control circuitry of the electronic component may generate a random time for the electronic component to fully power on responsive to receiving the input. For example, in response to receiving the signal for the individual electronic components to power-up or in response to the electronic component (for example, the power-on control circuitry receiving power), the power-on control circuitry may generate a random time when that individual electronic component 122 fully powers-up as described with respect to FIGS. 2 through 5. As such, the plurality of electronic components 122 may receive a signal to power-up so that each individual power-on control circuitry may generate a random time when that individual electronic components 122 powers-up so that the individual power-on control circuitries for respective processors may vary when power is drawn by the plurality of electronic components 122 and from the power source 104. This creates a high likelihood that power drawn from the one or more power sources 104 does not occur at the same time. Preventing power from being drawn by the individual electronic components 122 from the power source 104 at the same time may reduce the total amount of power drawn by the plurality of electronic components 122 for power-up to an amount that is below a maximum amount of power that one or more power sources 104 is capable of providing (for example, supplying) to the server 202 and/or is permitted to provide to the server 202.

At step 705, the power-on control circuitry may determine whether the modulated time has expired. At step 707, the power-on control circuitry of the electronic component may fully power-up the electronic component. For example, when the electronic component initially receives power, some components of the electronic component including the power-on control circuitry may automatically begin powering-up. These components may not draw a lot power when powering up. The power-on control circuitry may modulate other components of the electronic component (for example, one or more processors, one or more GPUs) so that the other components do not power-up immediately upon the electronic component receiving the input (for example, power). The other components may draw substantial power during power-up. As such, the power-on control circuitry may modulate a time when the other components (for example, a set of one or more processors) power-up to mitigate power-up surge on the server. When the modulated time generated by the power-on control circuitry expires, the other components of the electronic component begin powering-up so that the electronic component fully powers-up.

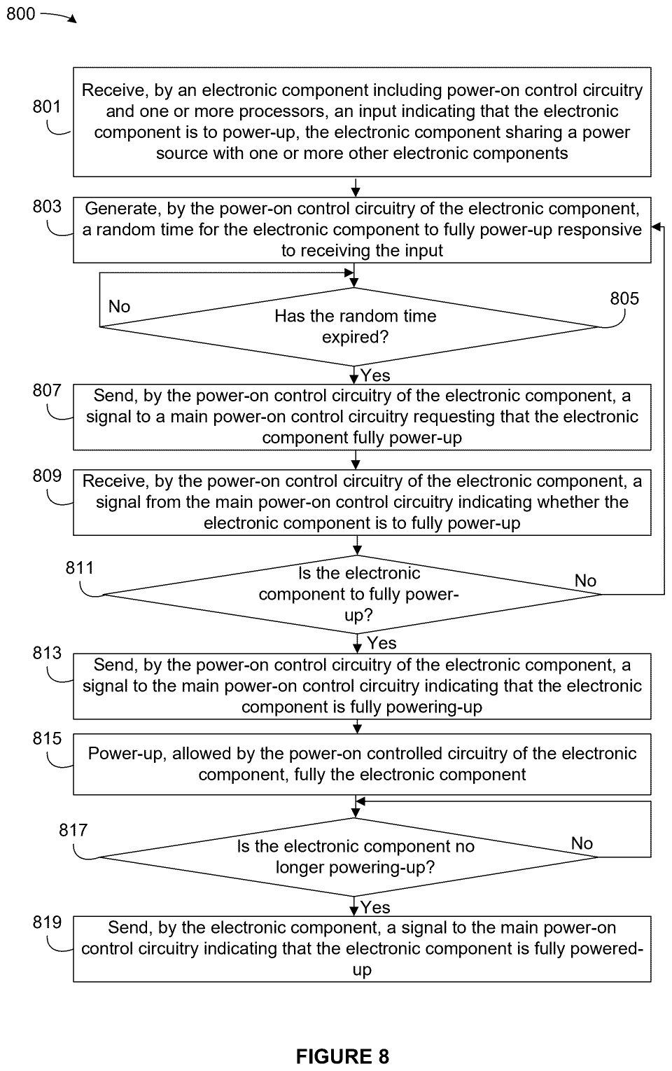

FIG. 8 illustrates an example method 800 of power-surge mitigation, in accordance with at least one embodiment. The method 800 illustrated in FIG. 8 may implement and/or include any of the components, systems, or operations described in any one or more figures of the figures provided herein including those from FIGS. 1 through 7 and 9 through 46. For instance, the method 800 may be implemented by electronic components 122, 322, 422, or 522 and/or the respective power-on control circuitries 208, 308, 408, or 508 as described herein with respect to FIGS. 1-5. Additionally, any one or more of the components, system, or operations described in any one or more figures of the figures provided herein including those from FIGS. 1 through 7 and 9 through 46 may be used to implement any one or more operations described with respect to the method 800 of FIG. 8.

At step 801, an electronic component 322 including power-on control circuitry 308 and one or more processors 206, may receive an input indicating that the electronic component 322 is to power-up. The electronic component 322 may be sharing a power source with one or more other electronic components. For example, one or more signals may be transmitted (for example, from a higher level main power-on control circuitry, from a user terminal, or the like via the one or more networks 110) for respective electronic components 322 requesting/commanding/instructing that those respective electronic components 322 be powered-up for use. Additionally, or alternatively, the electronic component 322 may receive power as the signal or input.

At step 803, the power-on control circuitry 308 of the electronic component 322 may generate a random time for the electronic component 322 to fully power-up responsive to receiving the input. For example, the power-on control circuitries 308 of the respective electronic components 322 may individually and autonomously generate a random time for their respective sets of processor(s) 206a, 206b, and 206n (and/or other components of the electronic component 322) to power-up in response to receiving the one or more signals or inputs. The random time generated by the power-on control circuitries 308 for the respective electronic components 322 (for example, sets of processor(s) 206a, 206b, and 206n) to power-up may include a random time within a limited time window. As described herein, the limited time window may be a predetermined limited time window or a variable or configurable limited time window.

At step 805, the power-on control circuitry 308 of the electronic component 322 may determine whether the random time has expired. If the power-on control circuitry 308 of the electronic component 322 determines that the random time has not expired, then the power-on control circuitry 308 repeats step 805. If the power-on control circuitry 308 of the electronic component 322 determines that the random time has expired, then the power-on control circuitry 308, at step 807, may then transmit a signal to the main power-on control circuitry 120 requesting that the electronic component 322 fully power-up. For example, when the random generated time expires, the power-on control circuitry 308 may send a signal to the main power-on control circuitry 120 requesting that the electronic component 322 fully power-up. The main power-on control circuitry 120 in communication with the power-on control circuitry 308 of the electronic component 322 may determine a power-up status of each of the respective electronic components 322 and/or the maximum amount of power that the power source 104 is capable of providing (for example, supplying) to the electronic components 322 and/or are permitted to provide to the electronic components 322. In at least one embodiment, the main power-on control circuitry 120 may determine how much time is needed for the power-up procedures for each of the respective electronic components 322 to completely power-up, how much time is needed for the power-up procedures for the combined electronic components 322 to completely power-up, how many electronic components 322 of the plurality of electronic components 322 have previously powered-up and are currently drawing power from the one or more power sources for operation(s), how many electronic components 322 of the plurality of electronic components 322 are currently powering-up and are currently drawing power from the one or more power sources for powering-up, how many electronic components 322 of the plurality of electronic components 322 are going to power-up but have not yet done so, how much power is needed to power-up each of the respective electronic components 322 relative to the maximum amount of power that the one or more power sources are capable of providing (for example, supplying) to the plurality of electronic components 322 and/or are permitted to provide to the plurality of electronic components 322, the quantity of electronic components 322 using the same one or more power sources and receiving a signal to power-up, how much power is needed to maintain power for each of the respective sets of electronic components 322 after power-up and during operation relative to the maximum amount of power that the one or more power sources are capable of providing (for example, supplying) to the plurality of electronic components 322 and/or are permitted to provide to the plurality of electronic components 322, the quantity of electronic components 322 using the same one or more power sources and receiving a signal to power-up, and/or the like.

At step 809, the power-on control circuitry 308 of the electronic component 322 may receive a signal from the main power-on control circuitry 120 indicated whether the electronic component is to fully power-on. For example, based on a power-up status of each of the electronic components 322, and/or the maximum amount of power that the one or more power sources 104 are capable of providing (for example, supplying) to the plurality of electronic components 322 and/or are permitted to provide to the plurality of electronic components 322, for example, the main power-on control circuitry 120 may determine whether the electronic components 322 can or should power-up. For instance, the main power-on control circuitry 120 may send a signal to the electronic component 322 indicating whether or not the first electronic component 322 is to fully power-up. At step 811, if the power-on control circuitry 308 determines based on the signal from the main power-on control circuitry 120 that, for example, the electronic component 322 is not to power-up, then processes returns to step 803 and the power-on control circuitry 308 generates another random time for the electronic component 322 to subsequently power-up repeating the aforementioned processes. At step 811, if the power-on control circuitry 308 determines based on the signal from the main power-on control circuitry 120 that the electronic component is to fully power-up, then, at step 813, the power-on control circuitry 308 sends a signal to the main power-on control circuitry 120 indicating that the electronic component 322 is fully powering-up so that, for example, all of the components (instead of some of the components) of the electronic component 322 receive power. This may inform the main power-on control circuitry 120 of the powering-up status of the electronic component 322 so that if another power-on control circuitry 308 requests power-up of another electronic component 322, the main power-on control circuitry 120 may know the status of the electronic component 322 and provide a signal to the other electronic component 322 indicating whether the other electronic component 322 has permission to fully power-up. Doing so may allow the main power-on control circuitry 120 to ensure that the amount of power from the power source 104 stays below the maximum amount of power that the power source 104 is capable of providing (for example, supplying) to a plurality of electronic components 322 and/or are permitted to provide to a plurality of electronic components 322. At step 815, the power-on control circuitry 308 may allow the electronic component 322 to fully power-up.

Subsequently, the power-on control circuitry 308 may continue to monitor the electronic component 322 to determine when the electronic component 322 (for example, the set of one or more processors 206 of the electronic component) are no longer powering-up (for example, are finished powering-up) and are now in an operational state. At step 817, if the power-on control circuitry 308 determines that the electronic component 308 is still powering-up, then the power-on control circuitry 308 repeats step 817. If, at step 817, the power-on control circuitry 308 determines is no longer powering-up, then, at step 819, the electronic component may send a signal to the main power-up control circuitry 120 indicating that the electronic component 322 is fully powered-up. For example, upon the power-on control circuitry 308 determining that the electronic component 322 is no longer powering-up and is now in the operational state, the power-on control circuitry 308 may send a signal to the main power-on control circuitry 120 informing the main power-on control circuitry 120 that the electronic component 322 is no longer powering-up and is now in the operational state. This may inform the main power-on control circuitry 120 of the operational status of the electronic component 322 so that if another power-on control circuitry 308 requests power-up of another electronic component 322 (for example, another set of one or more processors 206), the main power-on control circuitry 120 may know the status of the electronic component 322 and provide a signal to the other power-on control circuitry 308 indicating whether the other electronic component 322 has permission to fully power-up. This may be important because powering-up the electronic component 322 may require more power from the power source 104 compared to when the electronic component 322 is in the operational state. As such, informing the main power-on control circuitry 120 of the operational status of the electronic component 322 may allow the main power-on control circuitry 120 to ensure that the amount of power from the power source 104 stays below the maximum amount of power that the power source 104 is capable of providing (for example, supplying) to a plurality of electronic components 322 and/or are permitted to provide to a plurality of electronic components 322.

FIG. 9 illustrates an example method 900 of power-surge mitigation, in accordance with at least one embodiment. The method 900 illustrated in FIG. 9 may implement and/or include any of the components, systems, or operations described in any one or more figures of the figures provided herein including those from FIGS. 1 through 8 and 10 through 46. For instance, the method 900 may be implemented by electronic components 122, 322, 422, or 522 and/or the respective power-on control circuitries 208, 308, 408, or 508 as described herein with respect to FIGS. 1-5. Additionally, any one or more of the components, system, or operations described in any one or more figures of the figures provided herein including those from FIGS. 1 through 8 and 10 through 46 may be used to implement any one or more operations described with respect to the method 900 of FIG. 9.

At step 901, an electronic component 422 including power-on control circuitry 408 and one or more processors 206, may receive an input indicating that the electronic component 422 is to power-up. The electronic component 422 may be sharing a power source with one or more other electronic components. For example, one or more signals may be transmitted (for example, from a higher level main power-on control circuitry, from a user terminal, or the like via the one or more networks 110) for respective electronic components 422 requesting/commanding/instructing that those respective electronic components 422 be powered-up for use. Additionally, or alternatively, the electronic component 422 may receive power as the signal or input.

At step 903, the power-on control circuitry 408 of the electronic component 422 may generate a random time for the electronic component 422 to fully power-up responsive to receiving the input. For example, the power-on control circuitries 408 of the respective electronic components 422 may individually and autonomously generate a random time for their respective sets of processor(s) 206a, 206b, and 206n (and/or other components of the electronic component 422) to power-up in response to receiving the one or more signals or inputs. The random time generated by the power-on control circuitries 408 for the respective electronic components 422 (for example, sets of processor(s) 206a, 206b, and 206n) to power-up may include a random time within a limited time window. As described herein, the limited time window may be a predetermined limited time window or a variable or configurable limited time window.

At step 905, the power-on control circuitry 408 of the electronic component 422 may determine whether the random time has expired. If, at step 905, the power-on control circuitry 408 of the electronic component 422 determines that the random time has not expired, then the power-on control circuitry 408 repeats step 905. If, at step 905, the power-on control circuitry 408 of the electronic component 422 determines that the random time has expired, then, at step 907, the power-on control circuitry 408 determines whether one or more other electronic components 422 of the server 402 are currently powering-up. For example, the power-on control circuitry 408 may determine whether a high or higher signal is present on the communication channel 416 shared by the electronic component 422 and one or more other electronic components 422. A high signal on the direct communication channel 416 may indicate that one or more other electronic component 422 are currently fully powering-up. Conversely, a low or lower signal on the direct communication channel 416 may indicate that fewer or none of the one or more other electronic component 422 are currently powering-up (for example, are in an off state or an operational state).

At step 909, the power-on control circuitry 408 of the electronic component 422 may determine whether too many other electronic components are currently powering-up. For example, based on whether the power-on control circuitry 408 detects a high or higher signal or a low or lower signal on the direct communication channel 416, the power-on control circuitry 408 may determine whether the electronic component 422 can or should fully power-up. For instance, at step 909, if the power-on control circuitry 408 determines based on receiving a high or higher signal on the direct communication channel 416 indicating that one or more other electronic components 422 are currently fully powering-up, then, the power-on control circuitry 408 may return to step 903 and generate another random time for the electronic component 422a to subsequently fully power-up repeating the aforementioned processes.

If, at step 909, the power-on control circuitry 408 determines based on receiving a low or lower signal on the direct communication channel 416 indicating that fewer or no other electronic components 422 are currently fully powering-up, then, at step 911, the power-on control circuitry 408 may send a signal to the one or more other electronic components 422 on the server 402 indicating that the electronic component is fully powering-up. For example, upon the power-on control circuitry 408 initiating power-up of the electronic component 422, the power-on control circuitry 408 may send a high or higher signal on the direct communication channel 416 indicating to other power-on control circuitries 408 that the electronic component 422 is fully powering-up. This may inform the other electronic components (for example, the other power-on control circuitries 408b, 408n) of the powering-up status of the electronic component 422 so that if other electronic components seek power-up, those other power-on control circuitries 408 may know the status of the electronic component 422 and may either each generate another random time to subsequently power-up or continue to also fully power-up, for example, depending on how high or how low the signa on the direct communication channel 416 is. Doing so may allow the amount of power from the power source 104 to stay below the maximum amount of power that the power source 104 is capable of providing (for example, supplying) to the plurality of electronic components 422 and/or are permitted to provide to the plurality of electronic components 422.

Subsequently, at step 915, the power-on control circuitry 208 may continue to monitor the electronic component 422 to determine when the electronic component 422 is no longer fully powering-up (for example, is finished fully powering-up) and is now in an operational state. If, at step 915, the power-on control circuitry 408 determines that the electronic component 422 is still or currently powering-up, then the electronic component 422 repeats step 915. If, at step 915, the power-on control circuitry determines that the electronic component 422 is no longer powering-up, then, at step 917, the electronic component 422 may send a signal to other electronic components 422 on the server 402 indicating that the electronic component 422 is fully powered-up. For example, upon the power-on control circuitry 408 determining that the electronic component 422 is no longer powering-up and is now in the operational state, the power-on control circuitry 408 may no longer send a high signal on the direct communication channel 416 (for example, and send a low or lower signal, send no signal at all) informing the other power-on control circuitries 408 that the electronic component 422 is no longer powering-up and is now in the operational state. This may inform the other power-on control circuitries 408 of the operational status of the electronic components 422 so that if other power-on control circuitry 408 on the server 402 seek power-up of the other electronic components 422, the other power-on control circuities 408 may know the status of the electronic components 422 and determine whether the other electronic component 422 have permission to fully power-up. This may be important because powering-up the electronic components 422 may require more power from the power source 104 compared to when the electronic components 422 is in the operational state. As such, informing the other power-on control circuitries 408 of the operational status of the electronic component 422 may allow the other power-on control circuitries 408 to ensure that the amount of power from the power source 104 stays below the maximum amount of power that the power source 104 is capable of providing (for example, supplying) to the plurality of electronic components 422 and/or are permitted to provide to the plurality of electronic components 422.

### Servers and Data Centers

The following figures set forth, without limitation, exemplary network server and data center based systems that can be used to implement at least one embodiment.

FIG. 10 illustrates a distributed system 1000, in accordance with at least one embodiment. In at least one embodiment, distributed system 1000 includes one or more client computing devices 1002, 1004, 1006, and 1008, which are configured to execute and operate a client application such as a web browser, proprietary client, and/or variations thereof over one or more network(s) 1010. In at least one embodiment, server 1012 may be communicatively coupled with remote client computing devices 1002, 1004, 1006, and 1008 via network 1010. The server 1012 may be the same as or at least similar to the servers illustrated in FIGS. 1 through 5 and may include one or more same or similar features as the servers illustrated in FIGS. 1 through 5. The network 1010 may be the same as or at least similar to the network 110 illustrated in FIG. 1 and may include one or more same or similar features as the network 110 illustrated in FIG. 1. The components 1018, 1022, and 1022 may be the same as or at least similar to the electronic components illustrated in FIGS. 1 through 5 and may include one or more same or similar features as the electronic components illustrated in FIGS. 1 through 5.

In at least one embodiment, server 1012 may be adapted to run one or more services or software applications such as services and applications that may manage session activity of single sign-on (SSO) access across multiple data centers. In at least one embodiment, server 1012 may also provide other services or software applications can include non-virtual and virtual environments. In at least one embodiment, these services may be offered as web-based or cloud services or under a Software as a Service (SaaS) model to users of client computing devices 1002, 1004, 1006, and/or 1008. In at least one embodiment, users operating client computing devices 1002, 1004, 1006, and/or 1008 may in turn utilize one or more client applications to interact with server 1012 to utilize services provided by these components.

In at least one embodiment, software components 1018, 1020 and 1022 of distributed system 1000 are implemented on server 1012. In at least one embodiment, one or more components of distributed system 1000 and/or services provided by these components may also be implemented by one or more of client computing devices 1002, 1004, 1006, and/or 1008. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 1000. The embodiment shown in FIG. 10 is thus one example of a distributed system for implementing an embodiment system and is not intended to be limiting.

In at least one embodiment, client computing devices 1002, 1004, 1006, and/or 1008 may include various types of computing systems. In at least one embodiment, a client computing device may include portable handheld devices (for example, an iPhone®, cellular telephone, an iPad®, computing tablet, a personal digital assistant (PDA)) or wearable devices (for example, a Google Glass® head mounted display), running software such as Microsoft Windows Mobile®, and/or a variety of mobile operating systems such as iOS, Windows Phone, Android, BlackBerry 100, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (for example, a Microsoft Xbox gaming console with or without a Kinect® gesture input device), and/or a personal messaging device, capable of communicating over network(s) 1010. Although distributed system 1000 in FIG. 10 is shown with four client computing devices, any number of client computing devices may be supported. Other devices, such as devices with sensors, etc., may interact with server 1012.

In at least one embodiment, network(s) 1010 in distributed system 1000 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 1010 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (for example, a network operating under any of the Institute of Electrical and Electronics (IEEE) 802.11 suite of protocols, Bluetooth®, and/or any other wireless protocol), and/or any combination of these and/or other networks.

In at least one embodiment, server 1012 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 1012 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 1012 using software defined networking. In at least one embodiment, server 1012 may be adapted to run one or more services or software applications.

In at least one embodiment, server 1012 may run any operating system, as well as any commercially available server operating system. In at least one embodiment, server 1012 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 1012 may include one or more applications to analyze and consolidate data feeds and/or event updates received from users of client computing devices 1002, 1004, 1006, and 1008. In at least one embodiment, data feeds and/or event updates may include, but are not limited to, Twitter® feeds, Facebook® updates or real-time updates received from one or more nth party information sources and continuous data streams, which may include real-time events related to sensor data applications, financial tickers, network performance measuring tools (for example, network monitoring and traffic management applications), clickstream analysis tools, automobile traffic monitoring, and/or variations thereof. In at least one embodiment, server 1012 may also include one or more applications to display data feeds and/or real-time events via one or more display devices of client computing devices 1002, 1004, 1006, and 1008.

In at least one embodiment, distributed system 1000 may also include one or more databases 1014 and 1016. In at least one embodiment, databases may provide a mechanism for storing information such as user interactions information, usage patterns information, adaptation rules information, and other information. In at least one embodiment, databases 1014 and 1016 may reside in a variety of locations. In at least one embodiment, one or more of databases 1014 and 1016 may reside on a non-transitory storage medium local to (and/or resident in) server 1012. In at least one embodiment, databases 1014 and 1016 may be remote from server 1012 and in communication with server 1012 via a network-based or dedicated connection. In at least one embodiment, databases 1014 and 1016 may reside in a storage-area network (SAN). In at least one embodiment, any necessary files for performing functions attributed to server 1012 may be stored locally on server 1012 and/or remotely, as appropriate. In at least one embodiment, databases 1014 and 1016 may include relational databases, such as databases that are adapted to store, update, and retrieve data in response to SQL-formatted commands.

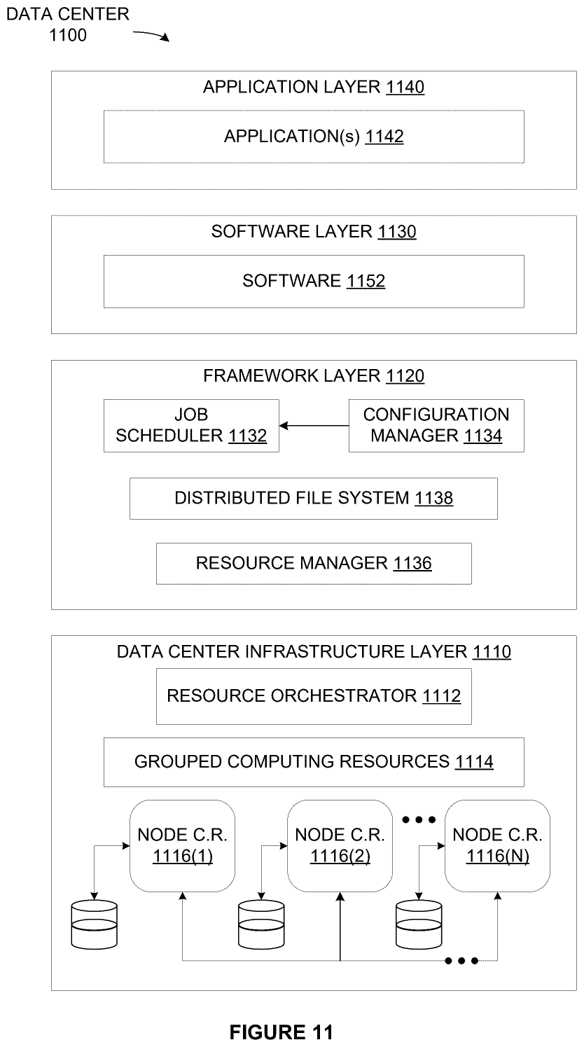

FIG. 11 illustrates an exemplary data center 1100, in accordance with at least one embodiment. In at least one embodiment, data center 1100 includes, without limitation, a data center infrastructure layer 1110, a framework layer 1120, a software layer 1130 and an application layer 1140. The data center 1100 may be the same as or at least similar to the datacenter 100 illustrated in FIG. 1 and/or the servers illustrated in FIGS. 1 through 5 and may include one or more same or similar features as the datacenter 100 illustrated in FIG. 1 and/or the servers illustrated in FIGS. 1 through 5.

In at least one embodiment, as shown in FIG. 11, data center infrastructure layer 1110 may include a resource orchestrator 1112, grouped computing resources 1114, and node computing resources (“node C.R.s”) 1116(1)-216(N), where “N” represents any whole, positive integer. In at least one embodiment, node C.R.s 1116(1)-216(N) may include, but are not limited to, any number of central processing units (“CPUs”) or other processors (including accelerators, field programmable gate arrays (“FPGAs”), graphics processors, etc.), memory devices (for example, dynamic read-only memory), storage devices (for example, solid state or disk drives), network input/output (“NW I/O”) devices, network switches, virtual machines (“VMs”), power modules, and cooling modules, etc. In at least one embodiment, one or more node C.R.s from among node C.R.s 1116(1)-216(N) may be a server having one or more of above-mentioned computing resources.

In at least one embodiment, grouped computing resources 1114 may include separate groupings of node C.R.s housed within one or more racks (not shown), or many racks housed in data centers at various geographical locations (also not shown). Separate groupings of node C.R.s within grouped computing resources 1114 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1112 may configure or otherwise control one or more node C.R.s 1116(1)-216(N) and/or grouped computing resources 1114. In at least one embodiment, resource orchestrator 1112 may include a software design infrastructure (“SDI”) management entity for data center 1100. In at least one embodiment, resource orchestrator 1112 may include hardware, software or some combination thereof.

In at least one embodiment, as shown in FIG. 11, framework layer 1120 includes, without limitation, a job scheduler 1132, a configuration manager 1134, a resource manager 1136 and a distributed file system 1138. In at least one embodiment, framework layer 1120 may include a framework to support software 1152 of software layer 1130 and/or one or more application(s) 1142 of application layer 1140. In at least one embodiment, software 1152 or application(s) 1142 may respectively include web-based service software or applications, such as those provided by Amazon Web Services, Google Cloud and Microsoft Azure. In at least one embodiment, framework layer 1120 may be, but is not limited to, a type of free and open-source software web application framework such as Apache Spark™ (hereinafter “Spark”) that may utilize distributed file system 1138 for large-scale data processing (for example, “big data”). In at least one embodiment, job scheduler 1132 may include a Spark driver to facilitate scheduling of workloads supported by various layers of data center 1100. In at least one embodiment, configuration manager 1134 may be capable of configuring different layers such as software layer 1130 and framework layer 1120, including Spark and distributed file system 1138 for supporting large-scale data processing. In at least one embodiment, resource manager 1136 may be capable of managing clustered or grouped computing resources mapped to or allocated for support of distributed file system 1138 and job scheduler 1132. In at least one embodiment, clustered or grouped computing resources may include grouped computing resources 1114 at data center infrastructure layer 1110. In at least one embodiment, resource manager 1136 may coordinate with resource orchestrator 1112 to manage these mapped or allocated computing resources.

In at least one embodiment, software 1152 included in software layer 1130 may include software used by at least portions of node C.R.s 1116(1)-216(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. In at least one or more types of applications may include, without limitation, CUDA applications, 5G network applications, artificial intelligence application, data center applications, and/or variations thereof.

In at least one embodiment, any of configuration manager 1134, resource manager 1136, and resource orchestrator 1112 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underutilized and/or poor performing portions of a data center.

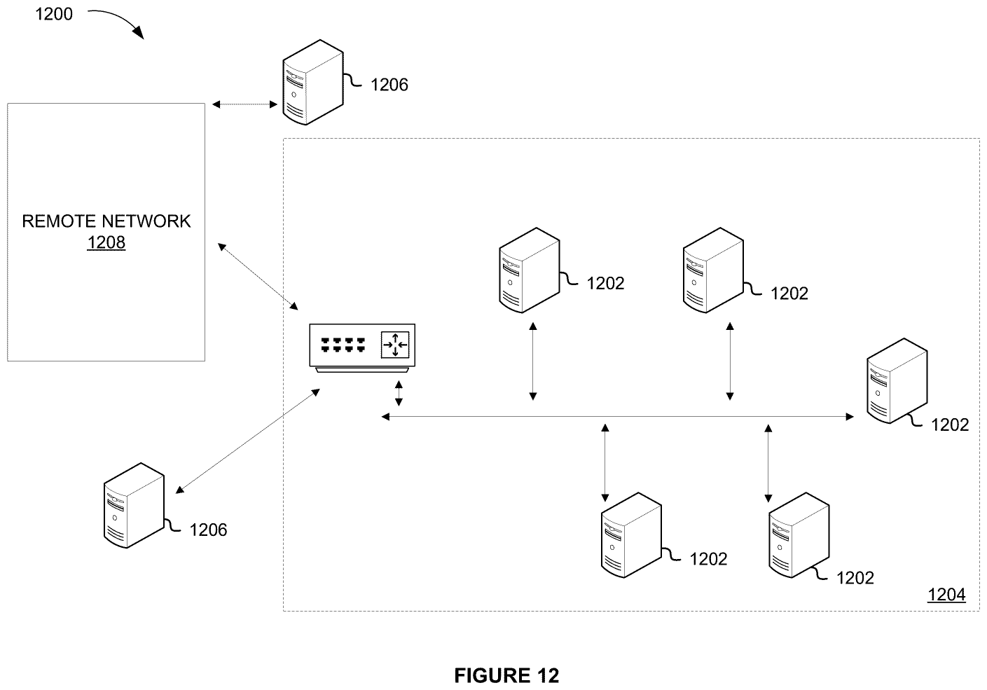

FIG. 12 illustrates a client-server network 1204 formed by a plurality of network server computers 1202 which are interlinked, in accordance with at least one embodiment. In at least one embodiment, each network server computer 1202 stores data accessible to other network server computers 1202 and to client computers 1206 and networks 1208 which link into a wide area network 1204. In at least one embodiment, configuration of a client-server network 1204 may change over time as client computers 1206 and one or more networks 1208 connect and disconnect from a network 1204, and as one or more trunk line server computers 1202 are added or removed from a network 1204. In at least one embodiment, when a client computer 1206 and a network 1208 are connected with network server computers 1202, client-server network includes such client computer 1206 and network 1208. In at least one embodiment, the term computer includes any device or machine capable of accepting data, applying prescribed processes to data, and supplying results of processes. The network 1204 may be the same as or at least similar to the datacenter 100 illustrated in FIG. 1 and may include one or more same or similar features as the datacenter 100 illustrated in FIG. 1. The one or more trunk line server computers 1202 may be the same as or at least similar to the electronic components illustrated in FIGS. 1 through 5 and may include one or more same or similar features as the electronic components illustrated in FIGS. 1 through 5.

In at least one embodiment, client-server network 1204 stores information which is accessible to network server computers 1202, remote networks 1208 and client computers 1206. In at least one embodiment, network server computers 1202 are formed by main frame computers minicomputers, and/or microcomputers having one or more processors each. In at least one embodiment, server computers 1202 are linked together by wired and/or wireless transfer media, such as conductive wire, fiber optic cable, and/or microwave transmission media, satellite transmission media or other conductive, optic or electromagnetic wave transmission media. In at least one embodiment, client computers 1206 access a network server computer 1202 by a similar wired or a wireless transfer medium. In at least one embodiment, a client computer 1206 may link into a client-server network 1204 using a modem and a standard telephone communication network. In at least one embodiment, alternative carrier systems such as cable and satellite communication systems also may be used to link into client-server network 1204. In at least one embodiment, other private or time-shared carrier systems may be used. In at least one embodiment, network 1204 is a global information network, such as the Internet. In at least one embodiment, network is a private intranet using similar protocols as the Internet, but with added security measures and restricted access controls. In at least one embodiment, network 1204 is a private, or semi-private network using proprietary communication protocols.

In at least one embodiment, client computer 1206 is any end user computer, and may also be a mainframe computer, mini-computer or microcomputer having one or more microprocessors. In at least one embodiment, server computer 1202 may at times function as a client computer accessing another server computer 1202. In at least one embodiment, remote network 1208 may be a local area network, a network added into a wide area network through an independent service provider (ISP) for the Internet, or another group of computers interconnected by wired or wireless transfer media having a configuration which is either fixed or changing over time. In at least one embodiment, client computers 1206 may link into and access a network 1204 independently or through a remote network 1208.

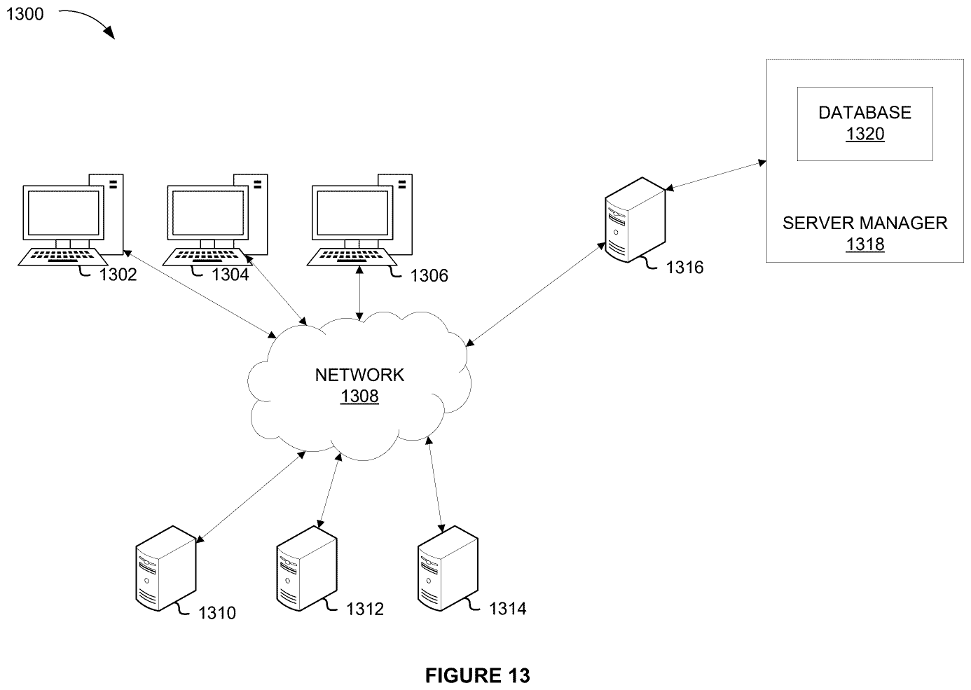

FIG. 13 illustrates a computer network 1308 connecting one or more computing machines, in accordance with at least one embodiment. In at least one embodiment, network 1308 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 1308 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1308 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1308 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (for example, www.site.com) which maps to an IP address of a network server.

In at least one embodiment, a plurality of clients 1302, 1304, and 1306 are connected to a network 1308 via respective communication links. In at least one embodiment, each of these clients may access a network 1308 via any desired form of communication, such as via a dial-up modem connection, cable link, a digital subscriber line (DSL), wireless or satellite link, or any other form of communication. In at least one embodiment, each client may communicate using any machine that is compatible with a network 1308, such as a personal computer (PC), work station, dedicated terminal, personal data assistant (PDA), or other similar equipment. In at least one embodiment, clients 1302, 1304, and 1306 may or may not be located in a same geographical area.

In at least one embodiment, a plurality of servers 1310, 1312, and 1314 are connected to a network 1308 to serve clients that are in communication with a network 1308. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1310, 1312, 1314 run application programs that respond to client commands. In at least one embodiment, server 1310 may run a web server application for responding to client requests for HTML pages and may also run a mail server application for receiving and routing electronic mail. In at least one embodiment, other application programs, such as an FTP server or a media server for streaming audio/video data to clients may also be running on a server 1310. In at least one embodiment, different servers may be dedicated to performing different tasks. In at least one embodiment, server 1310 may be a dedicated web server that manages resources relating to web sites for various users, whereas a server 1312 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1310, 1312, 1314 are under control of a web hosting provider in a business of maintaining and delivering nth party content over a network 1308. The servers 1310, 1312, 1314 may be the same as or at least similar to the servers illustrated in FIGS. 1 through 5 and may include one or more same or similar features as the servers illustrated in FIGS. 1 through 5.

In at least one embodiment, web hosting providers deliver services to two different types of clients. In at least one embodiment, one type, which may be referred to as a browser, requests content from servers 1310, 1312, 1314 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1316 is in communication with a network 1308 via a communication link. In at least one embodiment, intranet server 1316 is in communication with a server manager 1318. In at least one embodiment, server manager 1318 comprises a database of an application program configuration parameters which are being utilized in servers 1310, 1312, 1314. In at least one embodiment, users modify a database 1320 via an intranet 1316, and a server manager 1318 interacts with servers 1310, 1312, 1314 to modify application program parameters so that they match a content of a database. In at least one embodiment, a user logs onto an intranet server 1316 by connecting to an intranet 1316 via client 1302 and entering authentication information, such as a username and password.

In at least one embodiment, when a user wishes to sign up for new service or modify an existing service, an intranet server 1316 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1316 updates a database 1320. In at least one embodiment, server manager 1318 forwards this information to an appropriate server, and a new parameter is used during application program operation. In at least one embodiment, an intranet server 1316 is configured to provide users with access to configuration parameters of hosted network resources (for example, web pages, email, FTP sites, media sites, etc.), for which a user has contracted with a web hosting service provider.

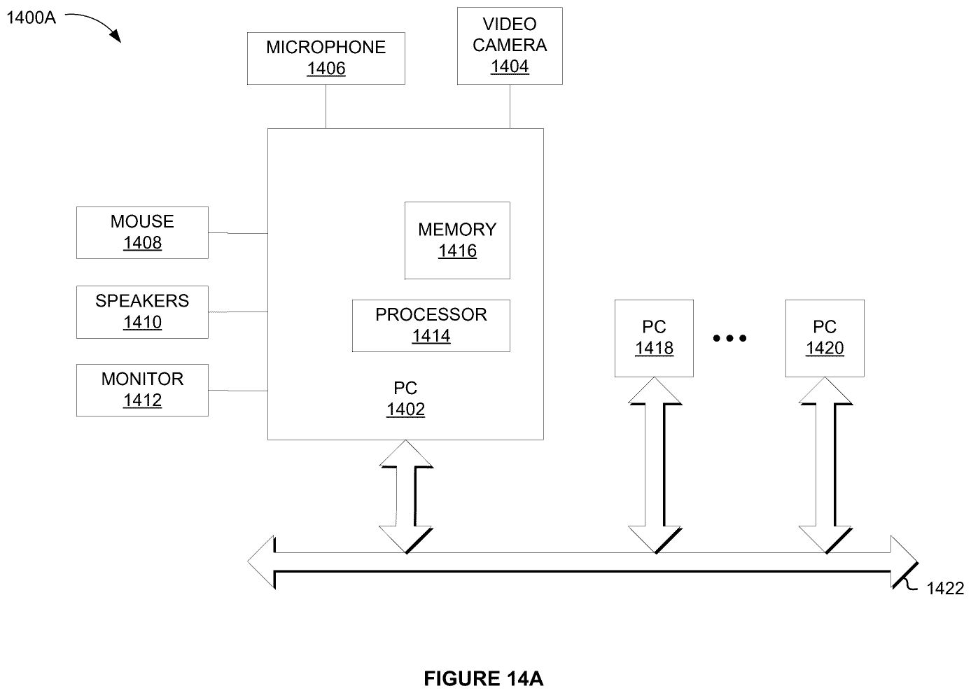

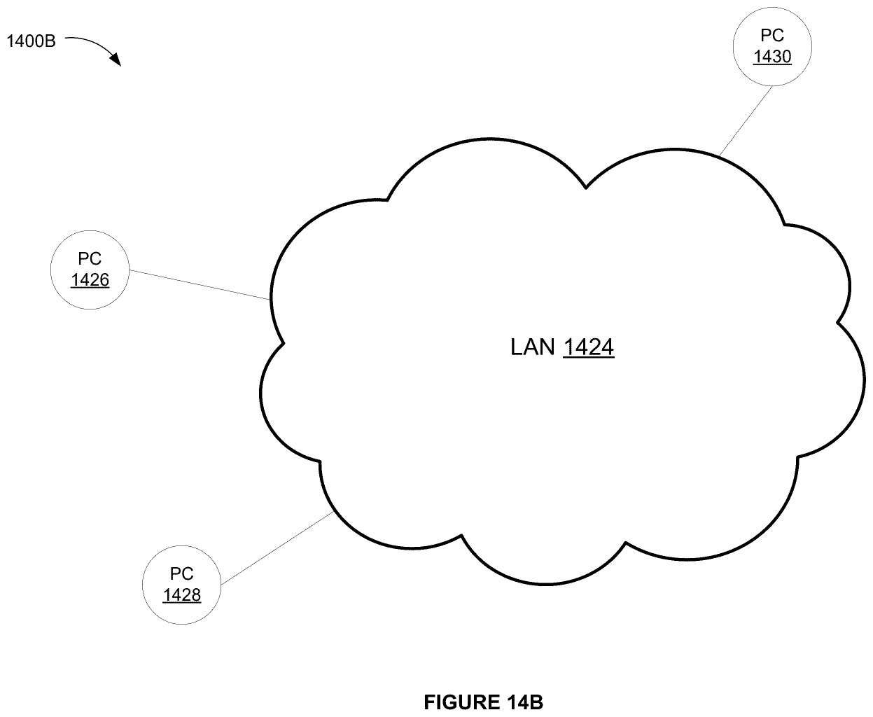

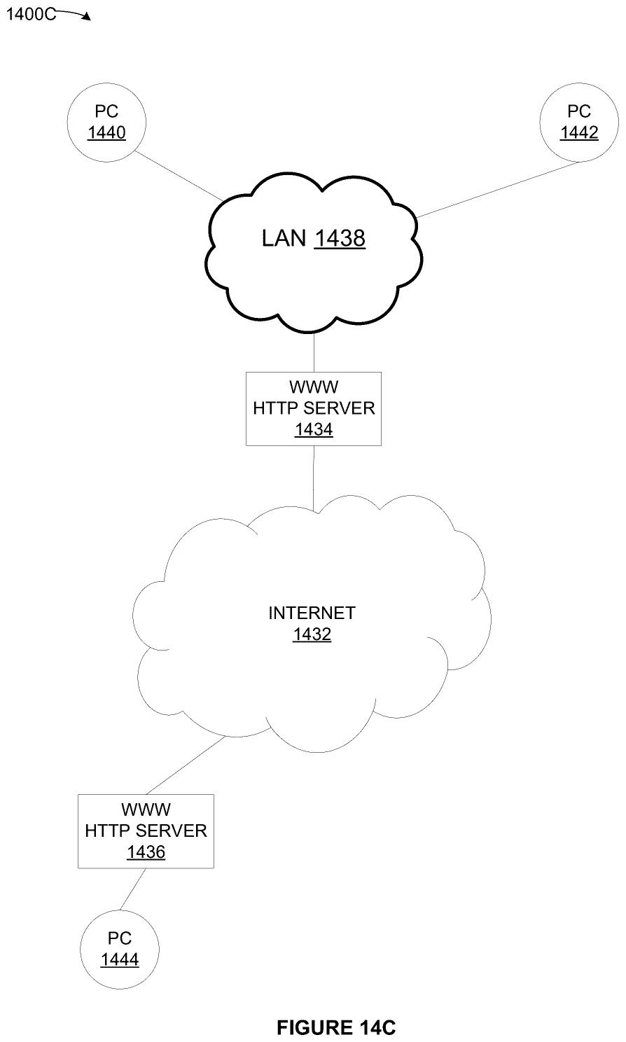

FIG. 14A illustrates a networked computer system 1400A, in accordance with at least one embodiment. In at least one embodiment, networked computer system 1400A comprises a plurality of nodes or personal computers (“PCs”) 1402, 1418, 1420. In at least one embodiment, personal computer or node 1402 comprises a processor 1414, memory 1416, video camera 1404, microphone 1406, mouse 1408, speakers 1410, and monitor 1412. In at least one embodiment, nodes 1402, 1418, 1420 may each run one or more desktop servers of an internal network within a given company, for instance, or may be servers of a general network not limited to a specific environment. In at least one embodiment, there is one server per PC node of a network, so that each PC node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 1402, 1418, 1420 and other nodes of a network are interconnected via medium 1422. In at least one embodiment, medium 1422 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 1414 is a general-purpose programmable processor. In at least one embodiment, processors of nodes of networked computer system 1400A may also be special-purpose video processors. In at least one embodiment, various peripherals and components of a node such as those of node 1402 may vary from those of other nodes. In at least one embodiment, node 1418 and node 1420 may be configured identically to or differently than node 1402. In at least one embodiment, a node may be implemented on any suitable computer system in addition to PC systems.

FIG. 14B illustrates a networked computer system 1400B, in accordance with at least one embodiment. In at least one embodiment, system 1400B illustrates a network such as LAN 1424, which may be used to interconnect a variety of nodes that may communicate with each other. In at least one embodiment, attached to LAN 1424 are a plurality of nodes such as PC nodes 1426, 1428, 1430. In at least one embodiment, a node may also be connected to the LAN via a network server or other means. In at least one embodiment, system 1400B comprises other types of nodes or elements, for example including routers, servers, and nodes.

FIG. 14C illustrates a networked computer system 1400C, in accordance with at least one embodiment. In at least one embodiment, system 1400C illustrates a WWW system having communications across a backbone communications network (“network”) such as the Internet, which may be used to interconnect a variety of nodes of a network. In at least one embodiment, WWW is a set of protocols operating on top of the Internet, and allows a graphical interface system to operate thereon for accessing information through the Internet. In at least one embodiment, attached to network 1432 in WWW are a plurality of nodes such as PCs 1440, 1442, 1444. In at least one embodiment, a node is interfaced to other nodes of WWW through a WWW HTTP server such as servers 1434, 1436. In at least one embodiment, PC 1444 may be a PC forming a node of network 1432 and itself running its server 1436, although PC 1444 and server 1436 are illustrated separately in FIG. 14C for illustrative purposes.

In at least one embodiment, WWW is a distributed type of application, characterized by WWW HTTP. WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 1438 as illustrated with respect to WWW HTTP server 1434. In at least one embodiment, system 1400C may also comprise other types of nodes or elements. In at least one embodiment, a WWW HTTP server is an application running on a machine, such as a PC. In at least one embodiment, each user may be considered to have a unique “server.” as illustrated with respect to PC 1444. In at least one embodiment, a server may be considered to be a server such as WWW HTTP server 1434, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

### Cloud Computing and Services

The following figures set forth, without limitation, exemplary cloud-based systems that can be used to implement at least one embodiment.

In at least one embodiment, cloud computing is a style of computing in which dynamically scalable and often virtualized resources are provided as a service over the Internet. In at least one embodiment, users need not have knowledge of, expertise in, or control over technology infrastructure, which can be referred to as “in the cloud,” that supports them. In at least one embodiment, cloud computing incorporates infrastructure as a service, platform as a service, software as a service, and other variations that have a common theme of reliance on the Internet for satisfying computing needs of users. In at least one embodiment, a typical cloud deployment, such as in a private cloud (for example, enterprise network), or a data center (DC) in a public cloud (for example, Internet) can consist of thousands of servers (or alternatively, VMs), hundreds of Ethernet, Fiber Channel or Fiber Channel over Ethernet (FCOE) ports, switching and storage infrastructure, etc. In at least one embodiment, cloud can also consist of network services infrastructure like IPsec VPN hubs, firewalls, load balancers, wide area network (WAN) optimizers etc. In at least one embodiment, remote subscribers can access cloud applications and services securely by connecting via a VPN tunnel, such as an IPsec VPN tunnel.

In at least one embodiment, cloud computing is a model for enabling convenient, on-demand network access to a shared pool of configurable computing resources (for example, networks, servers, storage, applications, and services) that can be rapidly provisioned and released with minimal management effort or service provider interaction.

In at least one embodiment, cloud computing is characterized by on-demand self-service, in which a consumer can unilaterally provision computing capabilities, such as server time and network storage, as needed automatically without requiring human inter-action with each service's provider. In at least one embodiment, cloud computing is characterized by broad network access, in which capabilities are available over a network and accessed through standard mechanisms that promote use by heterogeneous thin or thick client platforms (for example, mobile phones, laptops, and PDAs). In at least one embodiment, cloud computing is characterized by resource pooling, in which a provider's computing resources are pooled to serve multiple consumers using a multi-tenant model, with different physical and virtual resources dynamically as-signed and reassigned according to consumer demand. In at least one embodiment, there is a sense of location independence in that a customer generally has no control or knowledge over an exact location of provided resources, but may be able to specify location at a higher level of abstraction (for example, country, state, or data center). In at least one embodiment, examples of resources include storage, processing, memory, network bandwidth, and virtual machines. In at least one embodiment, cloud computing is characterized by rapid elasticity, in which capabilities can be rapidly and elastically provisioned, in some cases automatically, to quickly scale out and rapidly released to quickly scale in. In at least one embodiment, to a consumer, capabilities available for provisioning often appear to be unlimited and can be purchased in any quantity at any time. In at least one embodiment, cloud computing is characterized by measured service, in which cloud systems automatically control and optimize resource use by leveraging a metering capability at some level of abstraction appropriate to a type of service (for example, storage, processing, bandwidth, and active user accounts). In at least one embodiment, resource usage can be monitored, controlled, and reported providing transparency for both a provider and consumer of a utilized service.

In at least one embodiment, cloud computing may be associated with various services. In at least one embodiment, cloud Software as a Service (SaaS) may refer to as service in which a capability provided to a consumer is to use a provider's applications running on a cloud infrastructure. In at least one embodiment, applications are accessible from various client devices through a thin client interface such as a web browser (for example, web-based email). In at least one embodiment, consumer does not manage or control underlying cloud infrastructure including network, servers, operating systems, storage, or even individual application capabilities, with a possible exception of limited user-specific application configuration settings.

In at least one embodiment, cloud Platform as a Service (PaaS) may refer to a service in which a capability provided to a consumer is to deploy onto cloud infrastructure consumer-created or acquired applications created using programming languages and tools supported by a provider. In at least one embodiment, consumer does not manage or control underlying cloud infrastructure including networks, servers, operating systems, or storage, but has control over deployed applications and possibly application hosting environment configurations.

In at least one embodiment, cloud Infrastructure as a Service (IaaS) may refer to a service in which a capability provided to a consumer is to provision processing, storage, networks, and other fundamental computing resources where a consumer is able to deploy and run arbitrary software, which can include operating systems and applications. In at least one embodiment, consumer does not manage or control underlying cloud infrastructure, but has control over operating systems, storage, deployed applications, and possibly limited control of select networking components (for example, host firewalls).

In at least one embodiment, cloud computing may be deployed in various ways. In at least one embodiment, a private cloud may refer to a cloud infrastructure that is operated solely for an organization. In at least one embodiment, a private cloud may be managed by an organization or a nth party and may exist on-premises or off-premises. In at least one embodiment, a community cloud may refer to a cloud infrastructure that is shared by several organizations and supports a specific community that has shared concerns (for example, mission, security requirements, policy, and compliance considerations). In at least one embodiment, a community cloud may be managed by organizations or a nth party and may exist on-premises or off-premises. In at least one embodiment, a public cloud may refer to a cloud infrastructure that is made available to a general public or a large industry group and is owned by an organization providing cloud services. In at least one embodiment, a hybrid cloud may refer to a cloud infrastructure is a composition of two or more clouds (private, community, or public) that remain unique entities, but are bound together by standardized or proprietary technology that enables data and application portability (for example, cloud bursting for load-balancing between clouds). In at least one embodiment, a cloud computing environment is service oriented with a focus on statelessness, low coupling, modularity, and semantic interoperability.

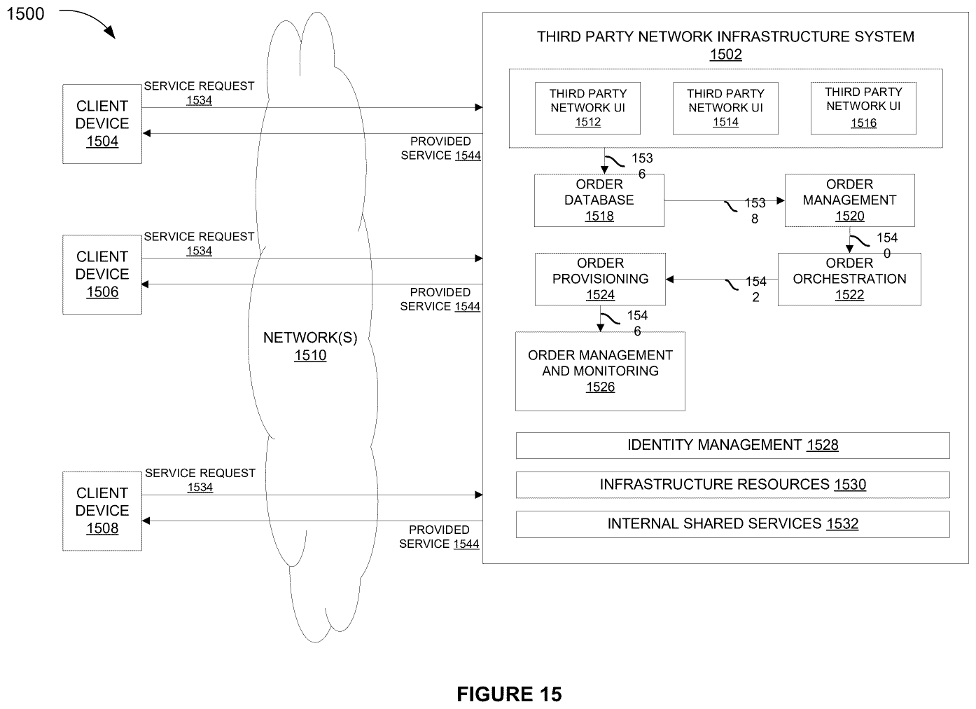

FIG. 15 illustrates one or more components of a system environment 1500 in which services may be offered as nth party network services, in accordance with at least one embodiment. In at least one embodiment, a nth party network may be referred to as a cloud, cloud network, cloud computing network, and/or variations thereof. In at least one embodiment, system environment 1500 includes one or more client computing devices 1504, 1206, and 1208n that may be used by users to interact with a nth party network infrastructure system 1502 that provides nth party network services, which may be referred to as cloud computing services. In at least one embodiment, nth party network infrastructure system 1502 may comprise one or more computers and/or servers. The nth part network infrastructure system 1502 may be the same as or at least similar to the servers illustrated in FIGS. 1 through 5 and may include one or more same or similar features as the servers illustrated in FIGS. 1 through 5.

It should be appreciated that nth party network infrastructure system 1502 depicted in FIG. 15 may have other components than those depicted. Further, FIG. 15 depicts an embodiment of a nth party network infrastructure system. In at least one embodiment, nth party network infrastructure system 1502 may have more or fewer components than depicted in FIG. 15, may combine two or more components, or may have a different configuration or arrangement of components.

In at least one embodiment, client computing devices 1504, 1606, and 1608n may be configured to operate a client application such as a web browser, a proprietary client application, or some other application, which may be used by a user of a client computing device to interact with nth party network infrastructure system 1502 to use services provided by nth party network infrastructure system 1502. Although exemplary system environment 1500 is shown with three client computing devices, any number of client computing devices may be supported. In at least one embodiment, other devices such as devices with sensors, etc. may interact with nth party network infrastructure system 1502. In at least one embodiment, network(s) 1510 may facilitate communications and exchange of data between client computing devices 1504, 1506, and 1508n and nth party network infrastructure system 1502.

In at least one embodiment, services provided by nth party network infrastructure system 1502 may include a host of services that are made available to users of nth party network infrastructure system 1502 on demand. In at least one embodiment, various services may also be offered including without limitation online data storage and backup solutions, Web-based e-mail services, hosted office suites and document collaboration services, database management and processing, managed technical support services, and/or variations thereof. In at least one embodiment, services provided by nth party network infrastructure system 1502 can dynamically scale to meet needs of its users.

In at least one embodiment, a specific instantiation of a service provided by nth party network infrastructure system 1502 may be referred to as a “service instance.” In at least one embodiment, in general, any service made available to a user via a communication network, such as the Internet, from a nth party network service provider's system is referred to as a “nth party network service.” In at least one embodiment, in a public nth party network environment, servers and systems that make up a nth party network service provider's system are different from a customer's own on-premises servers and systems. In at least one embodiment, a nth party network service provider's system may host an application, and a user may, via a communication network such as the Internet, on demand, order and use an application.

In at least one embodiment, a service in a computer network nth party network infrastructure may include protected computer network access to storage, a hosted database, a hosted web server, a software application, or other service provided by a nth party network vendor to a user. In at least one embodiment, a service can include password-protected access to remote storage on a nth party network through the Internet. In at least one embodiment, a service can include a web service-based hosted relational database and a script-language middleware engine for private use by a networked developer. In at least one embodiment, a service can include access to an email software application hosted on a nth party network vendor's web site.

In at least one embodiment, nth party network infrastructure system 1502 may include a suite of applications, middleware, and database service offerings that are delivered to a customer in a self-service, subscription-based, elastically scalable, reliable, highly available, and secure manner. In at least one embodiment, nth party network infrastructure system 1502 may also provide “big data” related computation and analysis services. In at least one embodiment, term “big data” is generally used to refer to extremely large data sets that can be stored and manipulated by analysts and researchers to visualize large amounts of data, detect trends, and/or otherwise interact with data. In at least one embodiment, big data and related applications can be hosted and/or manipulated by an infrastructure system on many levels and at different scales. In at least one embodiment, tens, hundreds, or thousands of processors linked in parallel can act upon such data in order to present it or simulate external forces on data or what it represents. In at least one embodiment, these data sets can involve structured data, such as that organized in a database or otherwise according to a structured model, and/or unstructured data (for example, emails, images, data blobs (binary large objects), web pages, complex event processing). In at least one embodiment, by leveraging an ability of an embodiment to relatively quickly focus more (or fewer) computing resources upon an objective, a nth party network infrastructure system may be better available to carry out tasks on large data sets based on demand from a business, government agency, research organization, private individual, group of like-minded individuals or organizations, or other entity.

In at least one embodiment, nth party network infrastructure system 1502 may be adapted to automatically provision, manage and track a customer's subscription to services offered by nth party network infrastructure system 1502. In at least one embodiment, nth party network infrastructure system 1502 may provide nth party network services via different deployment models. In at least one embodiment, services may be provided under a public nth party network model in which nth party network infrastructure system 1502 is owned by an organization selling nth party network services and services are made available to a general public or different industry enterprises. In at least one embodiment, services may be provided under a private nth party network model in which nth party network infrastructure system 1502 is operated solely for a single organization and may provide services for one or more entities within an organization. In at least one embodiment, nth party network services may also be provided under a community nth party network model in which nth party network infrastructure system 1502 and services provided by nth party network infrastructure system 1502 are shared by several organizations in a related community. In at least one embodiment, nth party network services may also be provided under a hybrid nth party network model, which is a combination of two or more different models.

In at least one embodiment, services provided by nth party network infrastructure system 1502 may include one or more services provided under Software as a Service (SaaS) category, Platform as a Service (PaaS) category, Infrastructure as a Service (IaaS) category, or other categories of services including hybrid services. In at least one embodiment, a customer, via a subscription order, may order one or more services provided by nth party network infrastructure system 1502. In at least one embodiment, nth party network infrastructure system 1502 then performs processing to provide services in a customer's subscription order.

In at least one embodiment, services provided by nth party network infrastructure system 1502 may include, without limitation, application services, platform services and infrastructure services. In at least one embodiment, application services may be provided by a nth party network infrastructure system via a SaaS platform. In at least one embodiment, SaaS platform may be configured to provide nth party network services that fall under a SaaS category. In at least one embodiment, SaaS platform may provide capabilities to build and deliver a suite of on-demand applications on an integrated development and deployment platform. In at least one embodiment, SaaS platform may manage and control underlying software and infrastructure for providing SaaS services. In at least one embodiment, by utilizing services provided by a SaaS platform, customers can utilize applications executing on a nth party network infrastructure system. In at least one embodiment, customers can acquire an application services without a need for customers to purchase separate licenses and support. In at least one embodiment, various different SaaS services may be provided. In at least one embodiment, examples include, without limitation, services that provide solutions for sales performance management, enterprise integration, and business flexibility for large organizations.

In at least one embodiment, platform services may be provided by nth party network infrastructure system 1502 via a PaaS platform. In at least one embodiment, PaaS platform may be configured to provide nth party network services that fall under a PaaS category. In at least one embodiment, examples of platform services may include without limitation services that enable organizations to consolidate existing applications on a shared, common architecture, as well as an ability to build new applications that leverage shared services provided by a platform. In at least one embodiment, PaaS platform may manage and control underlying software and infrastructure for providing PaaS services. In at least one embodiment, customers can acquire PaaS services provided by nth party network infrastructure system 1502 without a need for customers to purchase separate licenses and support.

In at least one embodiment, by utilizing services provided by a PaaS platform, customers can employ programming languages and tools supported by a nth party network infrastructure system and also control deployed services. In at least one embodiment, platform services provided by a nth party network infrastructure system may include database nth party network services, middleware nth party network services and nth party network services. In at least one embodiment, database nth party network services may support shared service deployment models that enable organizations to pool database resources and offer customers a Database as a Service in a form of a database nth party network. In at least one embodiment, middleware nth party network services may provide a platform for customers to develop and deploy various business applications, and nth party network services may provide a platform for customers to deploy applications, in a nth party network infrastructure system.

In at least one embodiment, various different infrastructure services may be provided by an IaaS platform in a nth party network infrastructure system. In at least one embodiment, infrastructure services facilitate management and control of underlying computing resources, such as storage, networks, and other fundamental computing resources for customers utilizing services provided by a SaaS platform and a PaaS platform.

In at least one embodiment, nth party network infrastructure system 1502 may also include infrastructure resources 1530 for providing resources used to provide various services to customers of a nth party network infrastructure system. In at least one embodiment, infrastructure resources 1530 may include pre-integrated and optimized combinations of hardware, such as servers, storage, and networking resources to execute services provided by a Paas platform and a Saas platform, and other resources.

In at least one embodiment, resources in nth party network infrastructure system 1502 may be shared by multiple users and dynamically re-allocated per demand. In at least one embodiment, resources may be allocated to users in different time zones. In at least one embodiment, nth party network infrastructure system 1502 may enable a first set of users in a first time zone to utilize resources of a nth party network infrastructure system for a specified number of hours and then enable a re-allocation of same resources to another set of users located in a different time zone, thereby maximizing utilization of resources.

In at least one embodiment, a number of internal shared services 1532 may be provided that are shared by different components or modules of nth party network infrastructure system 1502 to enable provision of services by nth party network infrastructure system 1502. In at least one embodiment, these internal shared services may include, without limitation, a security and identity service, an integration service, an enterprise repository service, an enterprise manager service, a virus scanning and white list service, a high availability, backup and recovery service, service for enabling nth party network support, an email service, a notification service, a file transfer service, and/or variations thereof.

In at least one embodiment, nth party network infrastructure system 1502 may provide comprehensive management of nth party network services (for example, SaaS, PaaS, and IaaS services) in a nth party network infrastructure system. In at least one embodiment, nth party network management functionality may include capabilities for provisioning, managing and tracking a customer's subscription received by nth party network infrastructure system 1502, and/or variations thereof.

In at least one embodiment, as depicted in FIG. 15, nth party network management functionality may be provided by one or more modules, such as an order management module 1520, an order orchestration module 1522, an order provisioning module 1524, an order management and monitoring module 1526, and an identity management module 1528. In at least one embodiment, these modules may include or be provided using one or more computers and/or servers, which may be general purpose computers, specialized server computers, server farms, server clusters, or any other appropriate arrangement and/or combination.

In at least one embodiment, at step 1534, a customer using a client device, such as client computing devices 1504, 1206 or 1208n, may interact with nth party network infrastructure system 1502 by requesting one or more services provided by nth party network infrastructure system 1502 and placing an order for a subscription for one or more services offered by nth party network infrastructure system 1502. In at least one embodiment, a customer may access a nth party network User Interface (UI) such as nth party network UI 1512, nth party network UI 1514 and/or nth party network UI 1516 and place a subscription order via these UIs. In at least one embodiment, order information received by nth party network infrastructure system 1502 in response to a customer placing an order may include information identifying a customer and one or more services offered by a nth party network infrastructure system 1502 that a customer intends to subscribe to.

In at least one embodiment, at step 1536, an order information received from a customer may be stored in an order database 1518. In at least one embodiment, if this is a new order, a new record may be created for an order. In at least one embodiment, order database 1518 can be one of several databases operated by nth party network infrastructure system 1502 and operated in conjunction with other system elements.

In at least one embodiment, at step 1538, an order information may be forwarded to an order management module 1520 that may be configured to perform billing and accounting functions related to an order, such as verifying an order, and upon verification, booking an order.

In at least one embodiment, at step 1540, information regarding an order may be communicated to an order orchestration module 1522 that is configured to orchestrate provisioning of services and resources for an order placed by a customer. In at least one embodiment, order orchestration module 1522 may use services of order provisioning module 1524 for provisioning. In at least one embodiment, order orchestration module 1522 enables management of business processes associated with each order and applies business logic to determine whether an order should proceed to provisioning.

In at least one embodiment, at step 1542, upon receiving an order for a new subscription, order orchestration module 1522 sends a request to order provisioning module 1524 to allocate resources and configure resources needed to fulfill a subscription order. In at least one embodiment, order provisioning module 1524 enables an allocation of resources for services ordered by a customer. In at least one embodiment, order provisioning module 1524 provides a level of abstraction between nth party network services provided by nth party network infrastructure system 1500 and a physical implementation layer that is used to provision resources for providing requested services. In at least one embodiment, this enables order orchestration module 1522 to be isolated from implementation details, such as whether or not services and resources are actually provisioned in real-time or pre-provisioned and only allocated/assigned upon request.

In at least one embodiment, at step 1544, once services and resources are provisioned, a notification may be sent to subscribing customers indicating that a requested service is now ready for use. In at least one embodiment, information (for example a link) may be sent to a customer that enables a customer to start using requested services.

In at least one embodiment, at step 1546, a customer's subscription order may be managed and tracked by an order management and monitoring module 1526. In at least one embodiment, order management and monitoring module 1526 may be configured to collect usage statistics regarding a customer use of subscribed services. In at least one embodiment, statistics may be collected for an amount of storage used, an amount data transferred, a number of users, and an amount of system up time and system down time, and/or variations thereof.

In at least one embodiment, nth party network infrastructure system 1500 may include an identity management module 1528 that is configured to provide identity services, such as access management and authorization services in nth party network infrastructure system 1500. In at least one embodiment, identity management module 1528 may control information about customers who wish to utilize services provided by nth party network infrastructure system 1502. In at least one embodiment, such information can include information that authenticates identities of such customers and information that describes which actions those customers are authorized to perform relative to various system resources (for example, files, directories, applications, communication ports, memory segments, etc.). In at least one embodiment, identity management module 1528 may also include management of descriptive information about each customer and about how and by whom that descriptive information can be accessed and modified.

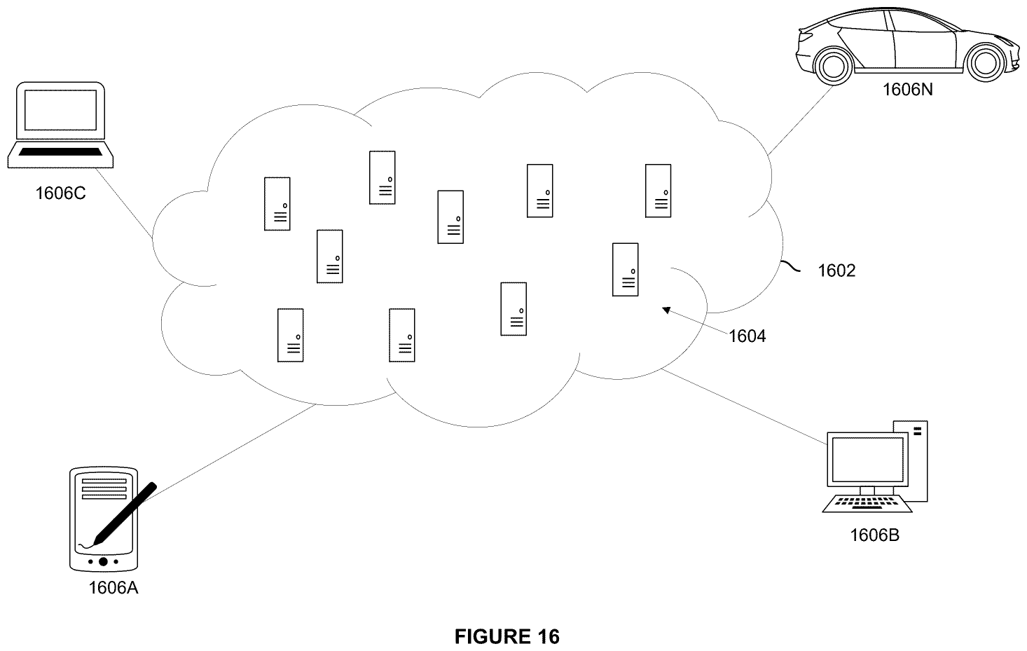

FIG. 16 illustrates a cloud computing environment 1602, in accordance with at least one embodiment. In at least one embodiment, cloud computing environment 1602 comprises one or more computer system/servers 1604 with which computing devices such as, personal digital assistant (PDA) or cellular telephone 1606A, desktop computer 1606B, laptop computer 1606n, and/or automobile computer system 1606N communicate. In at least one embodiment, this allows for infrastructure, platforms and/or software to be offered as services from cloud computing environment 1602, so as to not require each client to separately maintain such resources. It is understood that types of computing devices 1606A-N shown in FIG. 16 are intended to be illustrative only and that cloud computing environment 1602 can communicate with any type of computerized device over any type of network and/or network/addressable connection (for example, using a web browser).

In at least one embodiment, a computer system/server 1604, which can be denoted as a cloud computing node, is operational with numerous other general purpose or special purpose computing system environments or configurations. In at least one embodiment, examples of computing systems, environments, and/or configurations that may be suitable for use with computer system/server 1604 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and/or variations thereof.

In at least one embodiment, computer system/server 1604 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, exemplary computer system/server 1604 may be practiced in distributed loud computing environments where tasks are performed by remote processing devices that are linked through a communications network. In at least one embodiment, in a distributed cloud computing environment, program modules may be located in both local and remote computer system storage media including memory storage devices.

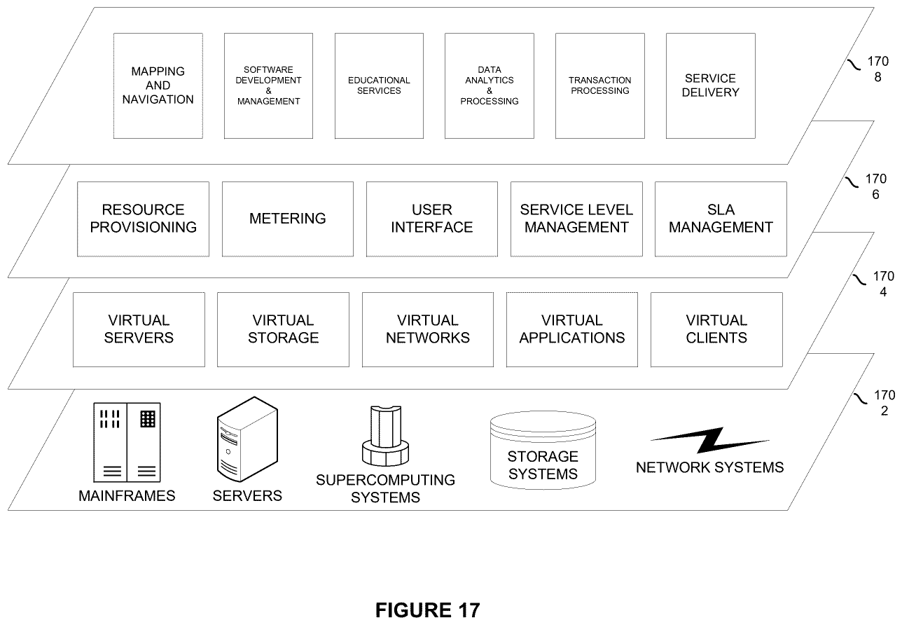

FIG. 17 illustrates a set of functional abstraction layers provided by cloud computing environment 1602 (FIG. 16), in accordance with at least one embodiment. It should be understood in advance that components, layers, and functions shown in FIG. 17 are intended to be illustrative only, and components, layers, and functions may vary.

In at least one embodiment, hardware and software layer 1702 includes hardware and software components. In at least one embodiment, examples of hardware components include mainframes, various RISC (Reduced Instruction Set Computer) architecture based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 1704 provides an abstraction layer from which following exemplary virtual entities may be provided: virtual servers, virtual storage, virtual networks, including virtual private networks, virtual applications, virtual clients, and/or variations thereof.

In at least one embodiment, management layer 1706 provides various functions. In at least one embodiment, resource provisioning provides dynamic procurement of computing resources and other resources that are utilized to perform tasks within a cloud computing environment. In at least one embodiment, metering provides usage tracking as resources are utilized within a cloud computing environment, and billing or invoicing for consumption of these resources. In at least one embodiment, resources may comprise application software licenses. In at least one embodiment, security provides identity verification for users and tasks, as well as protection for data and other resources. In at least one embodiment, user interface provides access to a cloud computing environment for both users and system administrators. In at least one embodiment, service level management provides cloud computing resource allocation and management such that required service levels are met. In at least one embodiment, Service Level Agreement (SLA) management provides pre-arrangement for, and procurement of, cloud computing resources for which a future requirement is anticipated in accordance with an SLA.

In at least one embodiment, workloads layer 1708 provides functionality for which a cloud computing environment is utilized. In at least one embodiment, examples of workloads and functions which may be provided from this layer include: mapping and navigation, software development and management, educational services, data analytics and processing, transaction processing, and service delivery.

### Supercomputing

The following figures set forth, without limitation, exemplary supercomputer-based systems that can be used to implement at least one embodiment.

In at least one embodiment, a supercomputer may refer to a hardware system exhibiting substantial parallelism and comprising at least one chip, where chips in a system are interconnected by a network and are placed in hierarchically organized enclosures. In at least one embodiment, a large hardware system filling a machine room, with several racks, each containing several boards/rack modules, each containing several chips, all interconnected by a scalable network, is one particular example of a supercomputer. In at least one embodiment, a single rack of such a large hardware system is another example of a supercomputer. In at least one embodiment, a single chip exhibiting substantial parallelism and containing several hardware components can equally be considered to be a supercomputer, since as feature sizes may decrease, an amount of hardware that can be incorporated in a single chip may also increase.

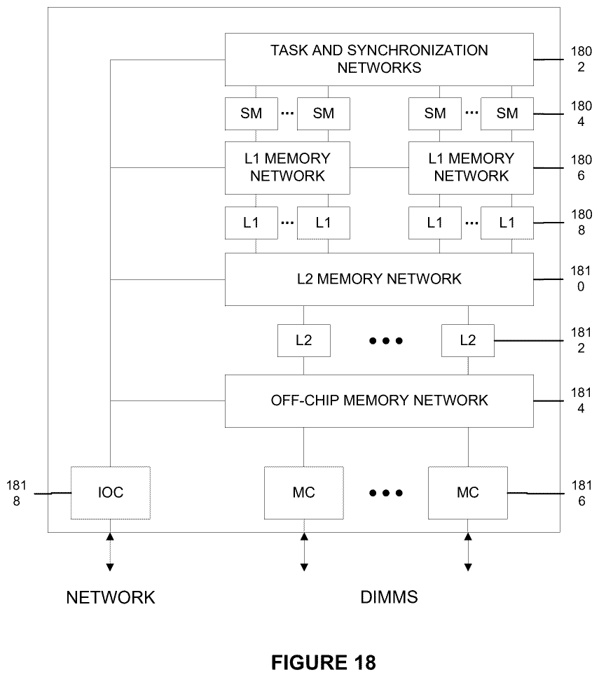

FIG. 18 illustrates a supercomputer at a chip level, in accordance with at least one embodiment. In at least one embodiment, inside an FPGA or ASIC chip, main computation is performed within finite state machines (1404) called thread units. In at least one embodiment, task and synchronization networks (1402) connect finite state machines and are used to dispatch threads and execute operations in correct order. In at least one embodiment, a multi-level partitioned on-chip cache hierarchy (1408, 1812) is accessed using memory networks (1406, 1810). In at least one embodiment, off-chip memory is accessed using memory controllers (1416) and an off-chip memory network (1414). In at least one embodiment, I/O controller (1418) is used for cross-chip communication when a design does not fit in a single logic chip. The supercomputer at a chip level as described with respect to FIG. 18 may be the same as or at least similar to the servers illustrated in FIGS. 1 through 5 and may include one or more same or similar features as the servers illustrated in FIGS. 1 through 5.

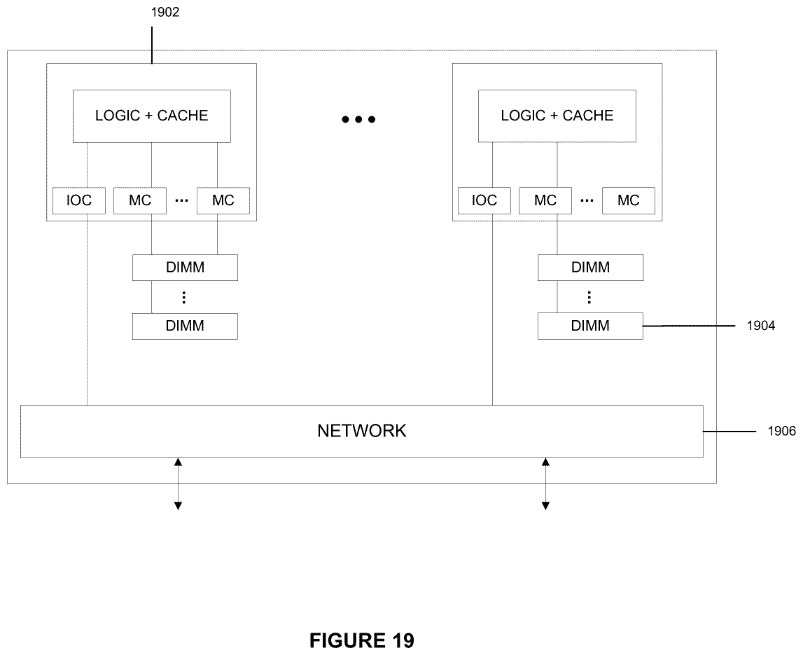

FIG. 19 illustrates a supercomputer at a rock module level, in accordance with at least one embodiment. In at least one embodiment, within a rack module, there are multiple FPGA or ASIC chips (1902) that are connected to one or more DRAM units (1904) which constitute main accelerator memory. In at least one embodiment, each FPGA/ASIC chip is connected to its neighbor FPGA/ASIC chip using wide busses on a board, with differential high speed signaling (1906). In at least one embodiment, each FPGA/ASIC chip is also connected to at least one high-speed serial communication cable. The supercomputer at the rock module level as described with respect to FIG. 159 may be the same as or at least similar to the servers illustrated in FIGS. 1 through 5 and may include one or more same or similar features as the servers illustrated in FIGS. 1 through 5.

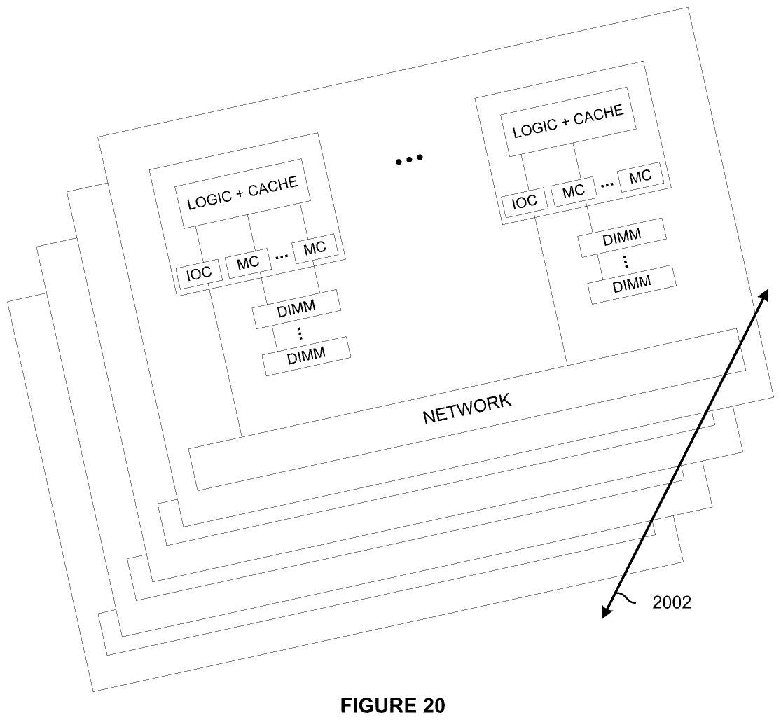

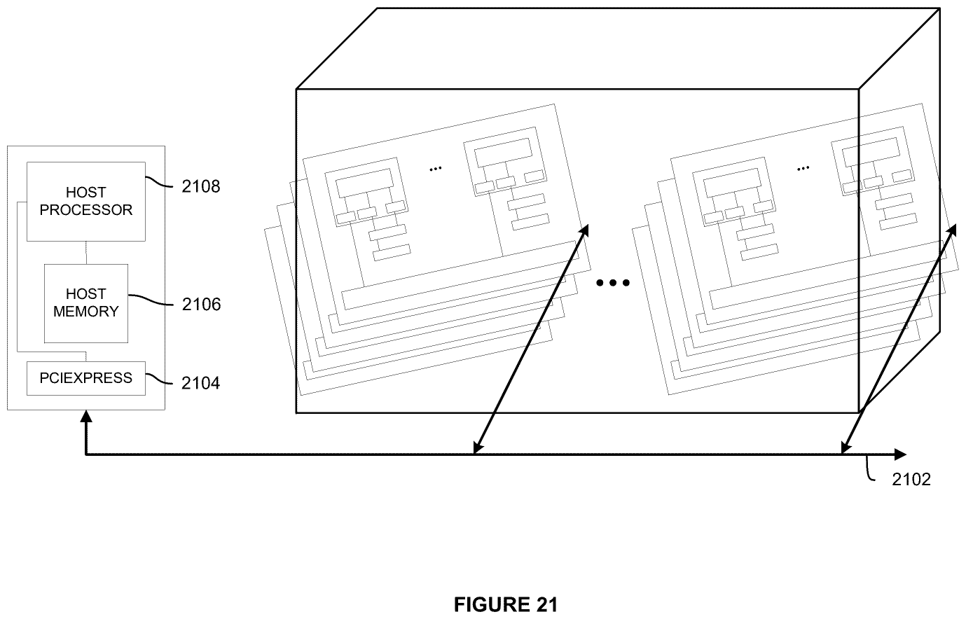

FIG. 20 illustrates a supercomputer at a rack level, in accordance with at least one embodiment. FIG. 21 illustrates a supercomputer at a whole system level, in accordance with at least one embodiment. In at least one embodiment, referring to FIG. 20 and FIG. 21, between rack modules in a rack and across racks throughout an entire system, high-speed serial optical or copper cables (2002, 2102) are used to realize a scalable, possibly incomplete hypercube network. In at least one embodiment, one of FPGA/ASIC chips of an accelerator is connected to a host system through a PCI-Express connection (2104). In at least one embodiment, host system comprises a host microprocessor (2108) that a software part of an application runs on and a memory consisting of one or more host memory DRAM units (2106) that is kept coherent with memory on an accelerator. In at least one embodiment, host system can be a separate module on one of racks, or can be integrated with one of a supercomputer's modules. In at least one embodiment, cube-connected cycles topology provide communication links to create a hypercube network for a large supercomputer. In at least one embodiment, a small group of FPGA/ASIC chips on a rack module can act as a single hypercube node, such that a total number of external links of each group is increased, compared to a single chip. In at least one embodiment, a group contains chips A, B, C and D on a rack module with internal wide differential busses connecting A, B, C and D in a torus organization. In at least one embodiment, there are 12 serial communication cables connecting a rack module to an outside world. In at least one embodiment, chip A on a rack module connects to serial communication cables 0, 1, 2. In at least one embodiment, chip B connects to cables 3, 4, 5. In at least one embodiment, chip C connects to 6, 7, 8. In at least one embodiment, chip D connects to 9, 10, 11. In at least one embodiment, an entire group {A, B, C, D} constituting a rack module can form a hypercube node within a supercomputer system, with up to 212=4096 rack modules (16384 FPGA/ASIC chips). In at least one embodiment, for chip A to send a message out on link 4 of group {A, B, C, D}, a message has to be routed first to chip B with an on-board differential wide bus connection. In at least one embodiment, a message arriving into a group {A, B, C, D} on link 4 (i.e., arriving at B) destined to chip A, also has to be routed first to a correct destination chip (A) internally within a group {A, B, C, D}. In at least one embodiment, parallel supercomputer systems of other sizes may also be implemented. The supercomputer at the rack level as described with respect to FIGS. 20 and 21 may be the same as or at least similar to the servers illustrated in FIGS. 1 through 5 and may include one or more same or similar features as the servers illustrated in FIGS. 1 through 5.

### Artificial Intelligence

The following figures set forth, without limitation, exemplary artificial intelligence-based systems that can be used to implement at least one embodiment.

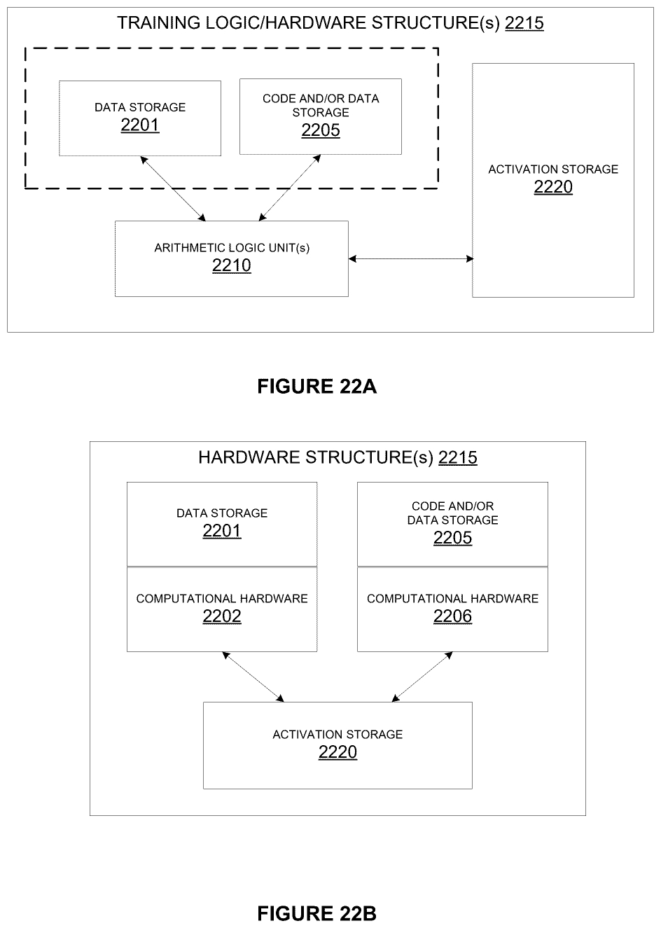

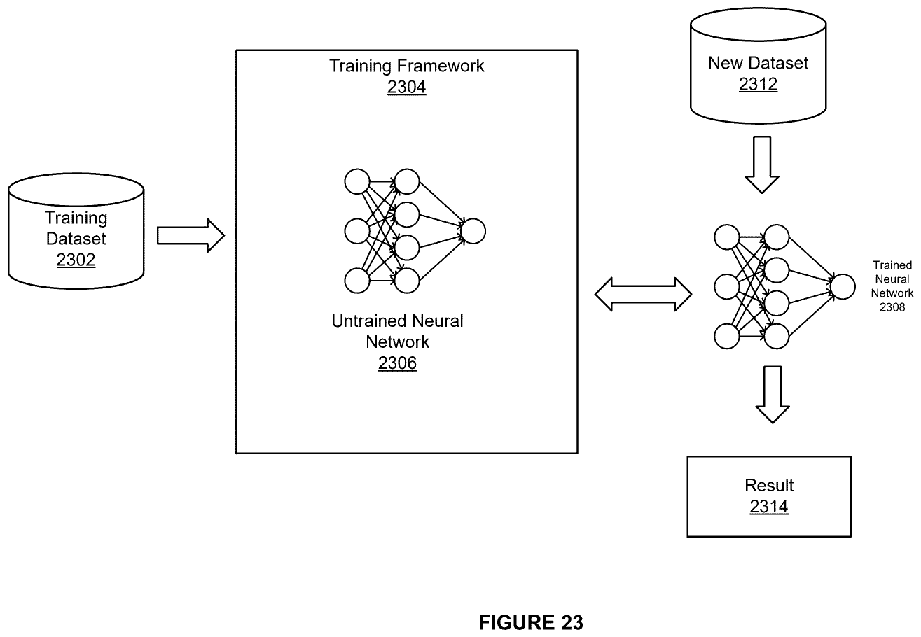

FIG. 22A illustrates inference and/or training logic 2215 used to perform inferencing and/or training operations associated with one or more embodiments. Details regarding inference and/or training logic 2215 are provided below in conjunction with FIGS. 22A and/or 22B. The training logic/hardware structures 2215 may be the same as or at least similar to the servers illustrated in FIGS. 1 through 5 and may include one or more same or similar features as the servers illustrated in FIGS. 1 through 5.

In at least one embodiment, inference and/or training logic 2215 may include, without limitation, code and/or data storage 2201 to store forward and/or output weight and/or input/output data, and/or other parameters to configure neurons or layers of a neural network trained and/or used for inferencing in aspects of one or more embodiments. In at least one embodiment, training logic 2215 may include, or be coupled to code and/or data storage 2201 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which such code corresponds. In at least one embodiment code and/or data storage 2201 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 2201 may be included with other on-chip or off-chip data storage, including a processor's L1, L2, or L3 cache or system memory.

In at least one embodiment, any portion of code and/or data storage 2201 may be internal or external to one or more processors or other hardware logic devices or circuits. In at least one embodiment, code and/or code and/or data storage 2201 may be cache memory, dynamic randomly addressable memory (“DRAM”), static randomly addressable memory (“SRAM”), non-volatile memory (for example, flash memory), or other storage. In at least one embodiment, a choice of whether code and/or code and/or data storage 2201 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2215 may include, without limitation, a code and/or data storage 2205 to store backward and/or output weight and/or input/output data corresponding to neurons or layers of a neural network trained and/or used for inferencing in aspects of one or more embodiments. In at least one embodiment, code and/or data storage 2205 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 2215 may include, or be coupled to code and/or data storage 2205 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes loading of weight or other parameter information into processor ALUs based on an architecture of a neural network to which such code corresponds. In at least one embodiment, any portion of code and/or data storage 2205 may be included with other on-chip or off-chip data storage, including a processor's L1, L2, or L3 cache or system memory. In at least one embodiment, any portion of code and/or data storage 2205 may be internal or external to one or more processors or other hardware logic devices or circuits. In at least one embodiment, code and/or data storage 2205 may be cache memory, DRAM, SRAM, non-volatile memory (for example, flash memory), or other storage. In at least one embodiment, a choice of whether code and/or data storage 2205 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 2201 and code and/or data storage 2205 may be separate storage structures. In at least one embodiment, code and/or data storage 2201 and code and/or data storage 2205 may be a combined storage structure. In at least one embodiment, code and/or data storage 2201 and code and/or data storage 2205 may be partially combined and partially separate. In at least one embodiment, any portion of code and/or data storage 2201 and code and/or data storage 2205 may be included with other on-chip or off-chip data storage, including a processor's L1, L2, or L3 cache or system memory.

In at least one embodiment, inference and/or training logic 2215 may include, without limitation, one or more arithmetic logic unit(s) (“ALU(s)”) 2210, including integer and/or floating point units, to perform logical and/or mathematical operations based, at least in part on, or indicated by, training and/or inference code (for example, graph code), a result of which may produce activations (for example, output values from layers or neurons within a neural network) stored in an activation storage 2220 that are functions of input/output and/or weight parameter data stored in code and/or data storage 2201 and/or code and/or data storage 2205. In at least one embodiment, activations stored in activation storage 2220 are generated according to linear algebraic and or matrix-based mathematics performed by ALU(s) 2210 in response to performing instructions or other code, wherein weight values stored in code and/or data storage 2205 and/or data storage 2201 are used as operands along with other values, such as bias values, gradient information, momentum values, or other parameters or hyperparameters, any or all of which may be stored in code and/or data storage 2205 or code and/or data storage 2201 or another storage on or off-chip.

In at least one embodiment, ALU(s) 2210 are included within one or more processors or other hardware logic devices or circuits, whereas in another embodiment, ALU(s) 2210 may be external to a processor or other hardware logic device or circuit that uses them (for example, a co-processor). In at least one embodiment, ALUs 2210 may be included within a processor's execution units or otherwise within a bank of ALUs accessible by a processor's execution units either within same processor or distributed between different processors of different types (for example, central processing units, graphics processing units, fixed function units, etc.). In at least one embodiment, code and/or data storage 2201, code and/or data storage 2205, and activation storage 2220 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 2220 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 2220 may be cache memory, DRAM, SRAM, non-volatile memory (for example, flash memory), or other storage. In at least one embodiment, activation storage 2220 may be completely or partially within or external to one or more processors or other logical circuits. In at least one embodiment, a choice of whether activation storage 2220 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2215 illustrated in FIG. 22A may be used in conjunction with an application-specific integrated circuit (“ASIC”), such as a TensorFlow®. Processing Unit from Google, an inference processing unit (IPU) from Graphcore™, or a Nervana® (for example, “Lake Crest”) processor from Intel Corp. In at least one embodiment, inference and/or training logic 2215 illustrated in FIG. 22A may be used in conjunction with central processing unit (“CPU”) hardware, graphics processing unit (“GPU”) hardware or other hardware, such as field programmable gate arrays (“FPGAs”).

FIG. 22B illustrates inference and/or training logic 2215, according to at least one embodiment. In at least one embodiment, inference and/or training logic 2215 may include, without limitation, hardware logic in which computational resources are dedicated or otherwise exclusively used in conjunction with weight values or other information corresponding to one or more layers of neurons within a neural network. In at least one embodiment, inference and/or training logic 2215 illustrated in FIG. 22B may be used in conjunction with an application-specific integrated circuit (ASIC), such as TensorFlow® Processing Unit from Google, an inference processing unit (IPU) from Graphcore™, or a Nervana® (for example, “Lake Crest”) processor from Intel Corp. In at least one embodiment, inference and/or training logic 2215 illustrated in FIG. 22B may be used in conjunction with central processing unit (CPU) hardware, graphics processing unit (GPU) hardware or other hardware, such as field programmable gate arrays (FPGAs). In at least one embodiment, inference and/or training logic 2215 includes, without limitation, code and/or data storage 2201 and code and/or data storage 2205, which may be used to store code (for example, graph code), weight values and/or other information, including bias values, gradient information, momentum values, and/or other parameter or hyperparameter information. In at least one embodiment illustrated in FIG. 22B, each of code and/or data storage 2201 and code and/or data storage 2205 is associated with a dedicated computational resource, such as computational hardware 2202 and computational hardware 2206, respectively. In at least one embodiment, each of computational hardware 2202 and computational hardware 2206 comprises one or more ALUs that perform mathematical functions, such as linear algebraic functions, only on information stored in code and/or data storage 2201 and code and/or data storage 2205, respectively, result of which is stored in activation storage 2220.

In at least one embodiment, each of code and/or data storage 2201 and 2205 and corresponding computational hardware 2202 and 2206, respectively, correspond to different layers of a neural network, such that resulting activation from one storage/computational pair 2201/1302 of code and/or data storage 2201 and computational hardware 2202 is provided as an input to a next storage/computational pair 2205/1306 of code and/or data storage 2205 and computational hardware 2206, in order to mirror a conceptual organization of a neural network. In at least one embodiment, each of storage/computational pairs 2201/1302 and 2205/1306 may correspond to more than one neural network layer. In at least one embodiment, additional storage/computation pairs (not shown) subsequent to or in parallel with storage/computation pairs 2201/1302 and 2205/1306 may be included in inference and/or training logic 2215.

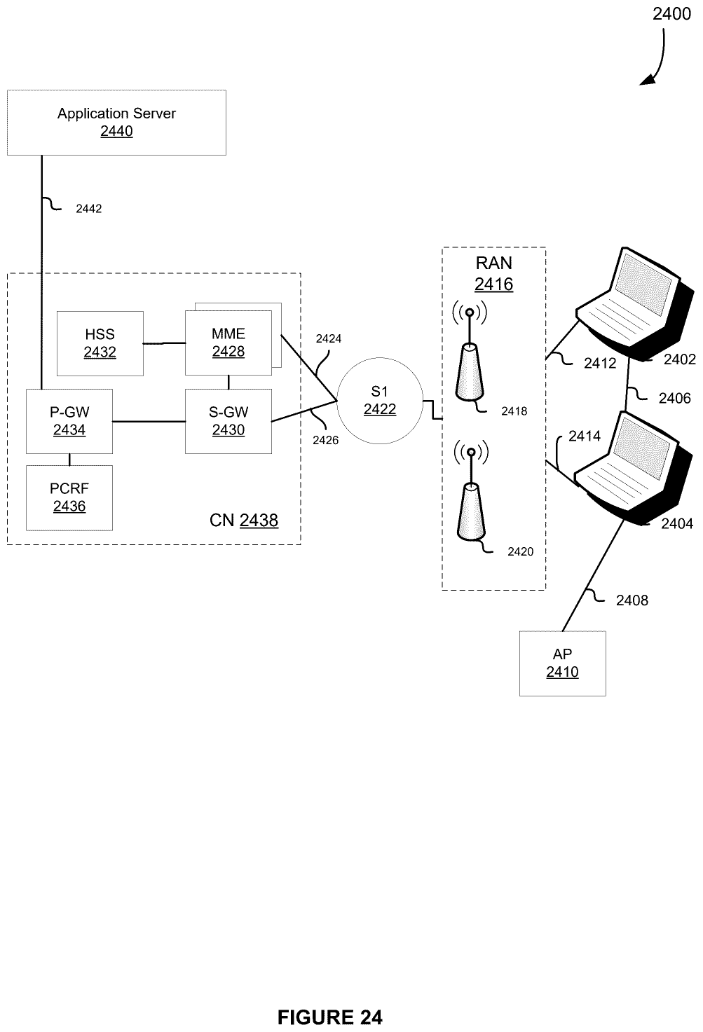

FIG. 23 illustrates training and deployment of a deep neural network, according to at least one embodiment. In at least one embodiment, untrained neural network 2306 is trained using a set of training data 2302. In at least one embodiment, training framework 2304 is a PyTorch framework, whereas in other embodiments, training framework 2304 is a TensorFlow, Boost, Caffe, Microsoft Cognitive Toolkit/CNTK, MXNet, Chainer, Keras, Deeplearning4j, or other training framework. In at least one embodiment, training framework 2304 trains an untrained neural network 2306 and enables it to be trained using processing resources described herein to generate a trained neural network 2308. In at least one embodiment, weights may be chosen randomly or by pre-training using a deep belief network. In at least one embodiment, training may be performed in either a supervised, partially supervised, or unsupervised manner.

In at least one embodiment, untrained neural network 2306 is trained using supervised learning, wherein set of training data 2302 includes an input paired with a desired output for an input, or where set of training data 2302 includes input having a known output and an output of neural network 2306 is manually graded. In at least one embodiment, untrained neural network 2306 is trained in a supervised manner and processes inputs from set of training data 2302 and compares resulting outputs against a set of expected or desired outputs. In at least one embodiment, errors are then propagated back through untrained neural network 2306. In at least one embodiment, training framework 2304 adjusts weights that control untrained neural network 2306. In at least one embodiment, training framework 2304 includes tools to monitor how well untrained neural network 2306 is converging towards a model, such as trained neural network 2308, suitable to generating correct answers, such as in result 2314, based on input data such as a new dataset 2312. In at least one embodiment, training framework 2304 trains untrained neural network 2306 repeatedly while adjust weights to refine an output of untrained neural network 2306 using a loss function and adjustment algorithm, such as stochastic gradient descent. In at least one embodiment, training framework 2304 trains untrained neural network 2306 until untrained neural network 2306 achieves a desired accuracy. In at least one embodiment, trained neural network 2308 can then be deployed to implement any number of machine learning operations.

In at least one embodiment, untrained neural network 2306 is trained using unsupervised learning, wherein untrained neural network 2306 attempts to train itself using unlabeled data. In at least one embodiment, unsupervised learning set of training data 2302 will include input data without any associated output data or “ground truth” data. In at least one embodiment, untrained neural network 2306 can learn groupings within set of training data 2302 and can determine how individual inputs are related to set of training data 2302. In at least one embodiment, unsupervised training can be used to generate a self-organizing map in trained neural network 2308 capable of performing operations useful in reducing dimensionality of new dataset 2312. In at least one embodiment, unsupervised training can also be used to perform anomaly detection, which allows identification of data points in new dataset 2312 that deviate from normal patterns of new dataset 2312.

In at least one embodiment, semi-supervised learning may be used, which is a technique in which in set of training data 2302 includes a mix of labeled and unlabeled data. In at least one embodiment, training framework 2304 may be used to perform incremental learning, such as through transferred learning techniques. In at least one embodiment, incremental learning enables trained neural network 2308 to adapt to new dataset 2312 without forgetting knowledge instilled within trained neural network 2308 during initial training.

### 5G Networks

The following figures set forth, without limitation, exemplary 5G network-based systems that can be used to implement at least one embodiment.

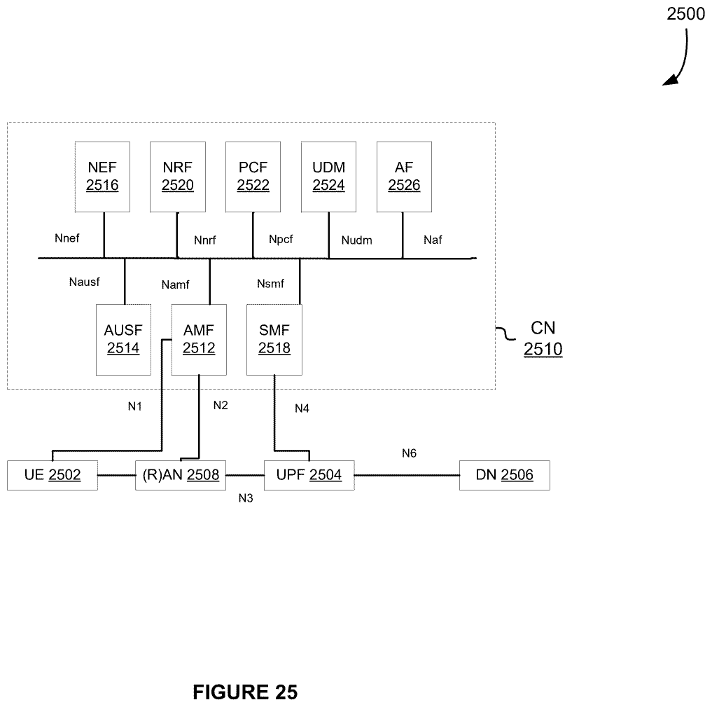

FIG. 24 illustrates an architecture of a system 2400 of a network, in accordance with at least one embodiment. In at least one embodiment, system 2400 is shown to include a user equipment (UE) 2402 and a UE 2404. In at least one embodiment, UEs 2402 and 2404 are illustrated as smartphones (for example, handheld touchscreen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface. The system 240 may be the same as or at least similar to the datacenter system 100 illustrated in FIG. 1 and may include one or more same or similar features as the datacenter system 100 illustrated in FIG. 1.

In at least one embodiment, any of UEs 2402 and 2404 can comprise an Internet of Things (IoT) UE, which can comprise a network access layer designed for low-power IoT applications utilizing short-lived UE connections. In at least one embodiment, an IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. In at least one embodiment, a M2M or MTC exchange of data may be a machine-initiated exchange of data. In at least one embodiment, an IoT network describes interconnecting IoT UEs, which may include uniquely identifiable embedded computing devices (within Internet infrastructure), with short-lived connections. In at least one embodiment, an IoT UEs may execute background applications (for example, keep alive messages, status updates, etc.) to facilitate connections of an IoT network.

In at least one embodiment, UEs 2402 and 2404 may be configured to connect, for example, communicatively couple, with a radio access network (RAN) 2416. In at least one embodiment, RAN 2416 may be, for example, an Evolved Universal Mobile Telecommunications System (UMTS) Terrestrial Radio Access Network (E-UTRAN), a NextGen RAN (NG RAN), or some other type of RAN. In at least one embodiment, UEs 2402 and 2404 utilize connections 2412 and 2414, respectively, each of which comprises a physical communications interface or layer. In at least one embodiment, connections 2412 and 2414 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and variations thereof.

In at least one embodiment, UEs 2402 and 2404 may further directly exchange communication data via a ProSe interface 2406. In at least one embodiment, ProSe interface 2406 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In at least one embodiment, UE 2404 is shown to be configured to access an access point (AP) 2410 via connection 2408. In at least one embodiment, connection 2408 can comprise a local wireless connection, such as a connection consistent with any IEEE 802.11 protocol, wherein AP 2410 would comprise a wireless fidelity (WiFi®) router. In at least one embodiment, AP 2410 is shown to be connected to an Internet without connecting to a core network of a wireless system.

In at least one embodiment, RAN 2416 can include one or more access nodes that enable connections 2412 and 2414. In at least one embodiment, these access nodes (ANs) can be referred to as base stations (BSs), NodeBs, evolved NodeBs (eNBs), next Generation NodeBs (gNB), RAN nodes, and so forth, and can comprise ground stations (for example, terrestrial access points) or satellite stations providing coverage within a geographic area (for example, a cell). In at least one embodiment, RAN 2416 may include one or more RAN nodes for providing macrocells, for example, macro RAN node 2418, and one or more RAN nodes for providing femtocells or picocells (for example, cells having smaller coverage areas, smaller user capacity, or higher bandwidth compared to macrocells), for example, low power (LP) RAN node 2420.

In at least one embodiment, any of RAN nodes 2418 and 2420 can terminate an air interface protocol and can be a first point of contact for UEs 2402 and 2404. In at least one embodiment, any of RAN nodes 2418 and 2420 can fulfill various logical functions for RAN 2416 including, but not limited to, radio network controller (RNC) functions such as radio bearer management, uplink and downlink dynamic radio resource management and data packet scheduling, and mobility management.

In at least one embodiment, UEs 2402 and 2404 can be configured to communicate using Orthogonal Frequency-Division Multiplexing (OFDM) communication signals with each other or with any of RAN nodes 2418 and 2420 over a multi-carrier communication channel in accordance various communication techniques, such as, but not limited to, an Orthogonal Frequency Division Multiple Access (OFDMA) communication technique (for example, for downlink communications) or a Single Carrier Frequency Division Multiple Access (SC-FDMA) communication technique (for example, for uplink and ProSe or sidelink communications), and/or variations thereof. In at least one embodiment, OFDM signals can comprise a plurality of orthogonal sub-carriers.

In at least one embodiment, a downlink resource grid can be used for downlink transmissions from any of RAN nodes 2418 and 2420 to UEs 2402 and 2404, while uplink transmissions can utilize similar techniques. In at least one embodiment, a grid can be a time frequency grid, called a resource grid or time-frequency resource grid, which is a physical resource in a downlink in each slot. In at least one embodiment, such a time frequency plane representation is a common practice for OFDM systems, which makes it intuitive for radio resource allocation. In at least one embodiment, each column and each row of a resource grid corresponds to one OFDM symbol and one OFDM subcarrier, respectively. In at least one embodiment, a duration of a resource grid in a time domain corresponds to one slot in a radio frame. In at least one embodiment, a smallest time-frequency unit in a resource grid is denoted as a resource element. In at least one embodiment, each resource grid comprises a number of resource blocks, which describe a mapping of certain physical channels to resource elements. In at least one embodiment, each resource block comprises a collection of resource elements. In at least one embodiment, in a frequency domain, this may represent a smallest quantity of resources that currently can be allocated. In at least one embodiment, there are several different physical downlink channels that are conveyed using such resource blocks.

In at least one embodiment, a physical downlink shared channel (PDSCH) may carry user data and higher-layer signaling to UEs 2402 and 2404. In at least one embodiment, a physical downlink control channel (PDCCH) may carry information about a transport format and resource allocations related to PDSCH channel, among other things. In at least one embodiment, it may also inform UEs 2402 and 2404 about a transport format, resource allocation, and HARQ (Hybrid Automatic Repeat Request) information related to an uplink shared channel. In at least one embodiment, typically, downlink scheduling (assigning control and shared channel resource blocks to UE 2402 within a cell) may be performed at any of RAN nodes 2418 and 2420 based on channel quality information fed back from any of UEs 2402 and 2404. In at least one embodiment, downlink resource assignment information may be sent on a PDCCH used for (for example, assigned to) each of UEs 2402 and 2404.

In at least one embodiment, a PDCCH may use control channel elements (CCEs) to convey control information. In at least one embodiment, before being mapped to resource elements, PDCCH complex valued symbols may first be organized into quadruplets, which may then be permuted using a sub-block interleaver for rate matching. In at least one embodiment, each PDCCH may be transmitted using one or more of these CCEs, where each CCE may correspond to nine sets of four physical resource elements known as resource element groups (REGs). In at least one embodiment, four Quadrature Phase Shift Keying (QPSK) symbols may be mapped to each REG. In at least one embodiment, PDCCH can be transmitted using one or more CCEs, depending on a size of a downlink control information (DCI) and a channel condition. In at least one embodiment, there can be four or more different PDCCH formats defined in LTE with different numbers of CCEs (for example, aggregation level, L=1, 2, 4, or 8).

In at least one embodiment, an enhanced physical downlink control channel (EPDCCH) that uses PDSCH resources may be utilized for control information transmission. In at least one embodiment, EPDCCH may be transmitted using one or more enhanced control channel elements (ECCEs). In at least one embodiment, each ECCE may correspond to nine sets of four physical resource elements known as an enhanced resource element groups (EREGs). In at least one embodiment, an ECCE may have other numbers of EREGs in some situations.

In at least one embodiment, RAN 2416 is shown to be communicatively coupled to a core network (CN) 2438 via an S1 interface 2422. In at least one embodiment, CN 2438 may be an evolved packet core (EPC) network, a NextGen Packet Core (NPC) network, or some other type of CN. In at least one embodiment, S1 interface 2422 is split into two parts: S1-U interface 2426, which carries traffic data between RAN nodes 2418 and 2420 and serving gateway (S-GW) 2430, and a S1-mobility management entity (MME) interface 2424, which is a signaling interface between RAN nodes 2418 and 2420 and MME(s) 2428.

In at least one embodiment, CN 2438 comprises MME(s) 2428, S-GW 2430, Packet Data Network (PDN) Gateway (P-GW) 2434, and a home subscriber server (HSS) 2432. In at least one embodiment, MME(s) 2428 may be similar in function to a control plane of legacy Serving General Packet Radio Service (GPRS) Support Nodes (SGSN). In at least one embodiment, MME(s) 2428 may manage mobility aspects in access such as gateway selection and tracking area list management. In at least one embodiment, HSS 2432 may comprise a database for network users, including subscription related information to support a network entities' handling of communication sessions. In at least one embodiment, CN 2438 may comprise one or several HSSs 2432, depending on a number of mobile subscribers, on a capacity of an equipment, on an organization of a network, etc. In at least one embodiment, HSS 2432 can provide support for routing/roaming, authentication, authorization, naming/addressing resolution, location dependencies, etc.

In at least one embodiment, S-GW 2430 may terminate a S1 interface 2422 towards RAN 2416, and routes data packets between RAN 2416 and CN 2438. In at least one embodiment, S-GW 2430 may be a local mobility anchor point for inter-RAN node handovers and also may provide an anchor for inter-3GPP mobility. In at least one embodiment, other responsibilities may include lawful intercept, charging, and some policy enforcement.

In at least one embodiment, P-GW 2434 may terminate an SGi interface toward a PDN. In at least one embodiment, P-GW 2434 may route data packets between CN 2438 and external networks such as a network including application server 2440 (alternatively referred to as application function (AF)) via an Internet Protocol (IP) interface 2442. In at least one embodiment, application server 2440 may be an element offering applications that use IP bearer resources with a core network (for example, UMTS Packet Services (PS) domain, LTE PS data services, etc.). In at least one embodiment, P-GW 2434 is shown to be communicatively coupled to an application server 2440 via an IP communications interface 2442. In at least one embodiment, application server 2440 can also be configured to support one or more communication services (for example, Voice-over-Internet Protocol (VOIP) sessions, PTT sessions, group communication sessions, social networking services, etc.) for UEs 2402 and 2404 via CN 2438.

In at least one embodiment, P-GW 2434 may further be a node for policy enforcement and charging data collection. In at least one embodiment, policy and Charging Enforcement Function (PCRF) 2436 is a policy and charging control element of CN 2438. In at least one embodiment, in a non-roaming scenario, there may be a single PCRF in a Home Public Land Mobile Network (HPLMN) associated with a UE's Internet Protocol Connectivity Access Network (IP-CAN) session. In at least one embodiment, in a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). In at least one embodiment, PCRF 2436 may be communicatively coupled to application server 2440 via P-GW 2434. In at least one embodiment, application server 2440 may signal PCRF 2436 to indicate a new service flow and select an appropriate Quality of Service (QOS) and charging parameters. In at least one embodiment, PCRF 2436 may provision this rule into a Policy and Charging Enforcement Function (PCEF) (not shown) with an appropriate traffic flow template (TFT) and QoS class of identifier (QCI), which commences a QoS and charging as specified by application server 2440.

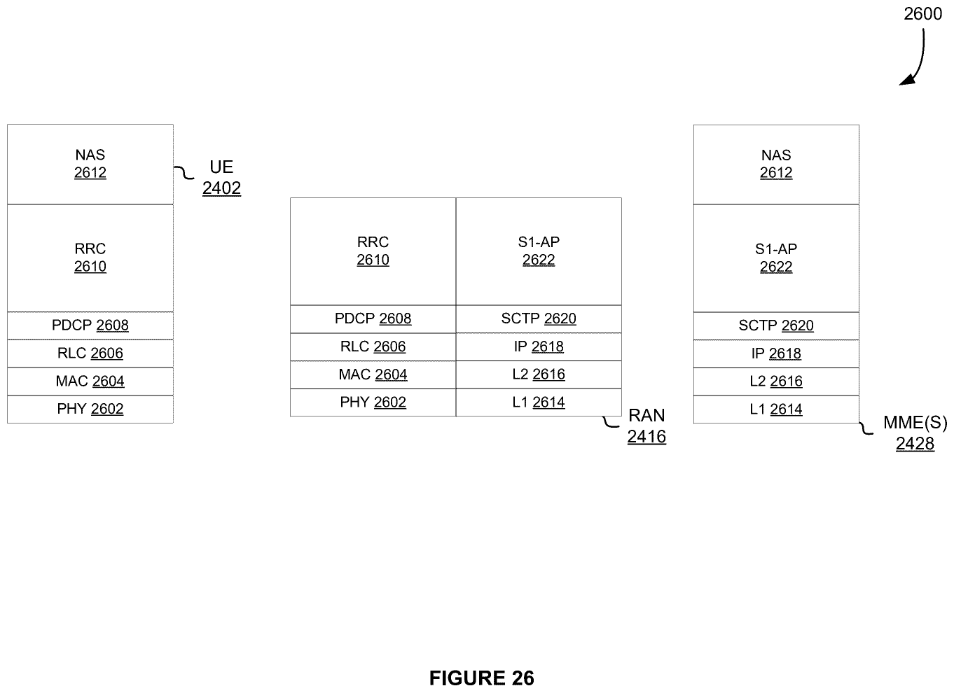

FIG. 25 illustrates an architecture of a system 2500 of a network in accordance with at least one embodiment. In at least one embodiment, system 2500 is shown to include a UE 2502, a 5G access node or RAN node (shown as (R)AN node 2208n), a User Plane Function (shown as UPF 2504), a Data Network (DN 2206), which may be, for example, operator services, Internet access or 3rd party services, and a 5G Core Network (5GC) (shown as CN 2510).

In at least one embodiment, CN 2510 includes an Authentication Server Function (AUSF 2514); a Core Access and Mobility Management Function (AMF 2512); a Session Management Function (SMF 2518); a Network Exposure Function (NEF 2516); a Policy Control Function (PCF 2522); a Network Function (NF) Repository Function (NRF 2520); a Unified Data Management (UDM 2524); and an Application Function (AF 2526). In at least one embodiment, CN 2510 may also include other elements that are not shown, such as a Structured Data Storage network function (SDSF), an Unstructured Data Storage network function (UDSF), and variations thereof.

In at least one embodiment, UPF 2504 may act as an anchor point for intra-RAT and inter-RAT mobility, an external PDU session point of interconnect to DN 2206, and a branching point to support multi-homed PDU session. In at least one embodiment, UPF 2504 may also perform packet routing and forwarding, packet inspection, enforce user plane part of policy rules, lawfully intercept packets (UP collection); traffic usage reporting, perform QoS handling for user plane (for example, packet filtering, gating, UL/DL rate enforcement), perform Uplink Traffic verification (for example, SDF to QoS flow mapping), transport level packet marking in uplink and downlink, and downlink packet buffering and downlink data notification triggering. In at least one embodiment, UPF 2504 may include an uplink classifier to support routing traffic flows to a data network. In at least one embodiment, DN 2206 may represent various network operator services, Internet access, or nth party services.

In at least one embodiment, AUSF 2514 may store data for authentication of UE 2502 and handle authentication related functionality. In at least one embodiment, AUSF 2514 may facilitate a common authentication framework for various access types.

In at least one embodiment, AMF 2512 may be responsible for registration management (for example, for registering UE 2502, etc.), connection management, reachability management, mobility management, and lawful interception of AMF-related events, and access authentication and authorization. In at least one embodiment, AMF 2512 may provide transport for SM messages for SMF 2518, and act as a transparent proxy for routing SM messages. In at least one embodiment, AMF 2512 may also provide transport for short message service (SMS) messages between UE 2502 and an SMS function (SMSF) (not shown by FIG. 25). In at least one embodiment, AMF 2512 may act as Security Anchor Function (SEA), which may include interaction with AUSF 2514 and UE 2502 and receipt of an intermediate key that was established as a result of UE 2502 authentication process. In at least one embodiment, where USIM based authentication is used, AMF 2512 may retrieve security material from AUSF 2514. In at least one embodiment, AMF 2512 may also include a Security Context Management (SCM) function, which receives a key from SEA that it uses to derive access-network specific keys. In at least one embodiment, furthermore, AMF 2512 may be a termination point of RAN CP interface (N2 reference point), a termination point of NAS (NI) signaling, and perform NAS ciphering and integrity protection.

In at least one embodiment, AMF 2512 may also support NAS signaling with a UE 2502 over an N3 interworking-function (IWF) interface. In at least one embodiment, N3IWF may be used to provide access to untrusted entities. In at least one embodiment, N3IWF may be a termination point for N2 and N3 interfaces for control plane and user plane, respectively, and as such, may handle N2 signaling from SMF and AMF for PDU sessions and QoS, encapsulate/de-encapsulate packets for IPSec and N3 tunneling, mark N3 user-plane packets in uplink, and enforce QoS corresponding to N3 packet marking taking into account QoS requirements associated to such marking received over N2. In at least one embodiment, N3IWF may also relay uplink and downlink control-plane NAS (NI) signaling between UE 2502 and AMF 2512, and relay uplink and downlink user-plane packets between UE 2502 and UPF 2504. In at least one embodiment, N3IWF also provides mechanisms for IPsec tunnel establishment with UE 2502.

In at least one embodiment, SMF 2518 may be responsible for session management (for example, session establishment, modify and release, including tunnel maintain between UPF and AN node); UE IP address allocation & management (including optional Authorization); Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. In at least one embodiment, SMF 2518 may include following roaming functionality: handle local enforcement to apply QOS SLAB (VPLMN); charging data collection and charging interface (VPLMN); lawful intercept (in VPLMN for SM events and interface to LI System); support for interaction with external DN for transport of signaling for PDU session authorization/authentication by external DN.

In at least one embodiment, NEF 2516 may provide means for securely exposing services and capabilities provided by 3GPP network functions for nth party, internal exposure/re-exposure, Application Functions (for example, AF 2526), edge computing or fog computing systems, etc. In at least one embodiment, NEF 2516 may authenticate, authorize, and/or throttle AFs. In at least one embodiment, NEF 2516 may also translate information exchanged with AF 2526 and information exchanged with internal network functions. In at least one embodiment, NEF 2516 may translate between an AF-Service-Identifier and an internal 5GC information. In at least one embodiment, NEF 2516 may also receive information from other network functions (NFs) based on exposed capabilities of other network functions. In at least one embodiment, this information may be stored at NEF 2516 as structured data, or at a data storage NF using a standardized interfaces. In at least one embodiment, stored information can then be re-exposed by NEF 2516 to other NFs and AFs, and/or used for other purposes such as analytics.

In at least one embodiment, NRF 2520 may support service discovery functions, receive NF Discovery Requests from NF instances, and provide information of discovered NF instances to NF instances. In at least one embodiment, NRF 2520 also maintains information of available NF instances and their supported services.

In at least one embodiment, PCF 2522 may provide policy rules to control plane function(s) to enforce them, and may also support unified policy framework to govern network behavior. In at least one embodiment, PCF 2522 may also implement a front end (FE) to access subscription information relevant for policy decisions in a UDR of UDM 2524.

In at least one embodiment, UDM 2524 may handle subscription-related information to support a network entities' handling of communication sessions, and may store subscription data of UE 2502. In at least one embodiment, UDM 2524 may include two parts, an application FE and a User Data Repository (UDR). In at least one embodiment, UDM may include a UDM FE, which is in charge of processing of credentials, location management, subscription management and so on. In at least one embodiment, several different front ends may serve a same user in different transactions. In at least one embodiment, UDM-FE accesses subscription information stored in an UDR and performs authentication credential processing; user identification handling; access authorization; registration/mobility management; and subscription management. In at least one embodiment, UDR may interact with PCF 2522. In at least one embodiment, UDM 2524 may also support SMS management, wherein an SMS-FE implements a similar application logic as discussed previously.

In at least one embodiment, AF 2526 may provide application influence on traffic routing, access to a Network Capability Exposure (NCE), and interact with a policy framework for policy control. In at least one embodiment, NCE may be a mechanism that allows a 5GC and AF 2526 to provide information to each other via NEF 2516, which may be used for edge computing implementations. In at least one embodiment, network operator and nth party services may be hosted close to UE 2502 access point of attachment to achieve an efficient service delivery through a reduced end-to-end latency and load on a transport network. In at least one embodiment, for edge computing implementations, 5GC may select a UPF 2504 close to UE 2502 and execute traffic steering from UPF 2504 to DN 2206 via N6 interface. In at least one embodiment, this may be based on UE subscription data, UE location, and information provided by AF 2526. In at least one embodiment, AF 2526 may influence UPF (re) selection and traffic routing. In at least one embodiment, based on operator deployment, when AF 2526 is considered to be a trusted entity, a network operator may permit AF 2526 to interact directly with relevant NFs.

In at least one embodiment, CN 2510 may include an SMSF, which may be responsible for SMS subscription checking and verification, and relaying SM messages to/from UE 2502 to/from other entities, such as an SMS-GMSC/IWMSC/SMS-router. In at least one embodiment, SMS may also interact with AMF 2512 and UDM 2524 for notification procedure that UE 2502 is available for SMS transfer (for example, set a UE not reachable flag, and notifying UDM 2524 when UE 2502 is available for SMS).

In at least one embodiment, system 2500 may include following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

In at least one embodiment, system 2500 may include following reference points: N1: Reference point between UE and AMF; N2: Reference point between (R)AN and AMF; N3: Reference point between (R)AN and UPF; N4: Reference point between SMF and UPF; and N6: Reference point between UPF and a Data Network. In at least one embodiment, there may be many more reference points and/or service-based interfaces between a NF services in NFs, however, these interfaces and reference points have been omitted for clarity. In at least one embodiment, an NS reference point may be between a PCF and AF; an N7 reference point may be between PCF and SMF; an N11 reference point between AMF and SMF; etc. In at least one embodiment, CN 2510 may include an Nx interface, which is an inter-CN interface between MME and AMF 2512 in order to enable interworking between CN 2510 and CN 7216.

In at least one embodiment, system 2500 may include multiple RAN nodes (such as (R)AN node 2208n) wherein an Xn interface is defined between two or more (R)AN node 2208n (for example, gNBs) that connecting to 5GC 410, between a (R)AN node 2208n (for example, gNB) connecting to CN 2510 and an eNB (for example, a macro RAN node), and/or between two eNBs connecting to CN 2510.

In at least one embodiment, Xn interface may include an Xn user plane (Xn-U) interface and an Xn control plane (Xn-C) interface. In at least one embodiment. Xn-U may provide non-guaranteed delivery of user plane PDUs and support/provide data forwarding and flow control functionality. In at least one embodiment, Xn-C may provide management and error handling functionality, functionality to manage a Xn-C interface; mobility support for UE 2502 in a connected mode (for example, CM-CONNECTED) including functionality to manage UE mobility for connected mode between one or more (R)AN node 2208n. In at least one embodiment, mobility support may include context transfer from an old (source) serving (R)AN node 2208n to new (target) serving (R)AN node 2208n; and control of user plane tunnels between old (source) serving (R)AN node 2208n to new (target) serving (R)AN node 2208n.

In at least one embodiment, a protocol stack of a Xn-U may include a transport network layer built on Internet Protocol (IP) transport layer, and a GTP-U layer on top of a UDP and/or IP layer(s) to carry user plane PDUs. In at least one embodiment. Xn-C protocol stack may include an application layer signaling protocol (referred to as Xn Application Protocol (Xn-AP)) and a transport network layer that is built on an SCTP layer. In at least one embodiment. SCTP layer may be on top of an IP layer. In at least one embodiment, SCTP layer provides a guaranteed delivery of application layer messages. In at least one embodiment, in a transport IP layer point-to-point transmission is used to deliver signaling PDUs. In at least one embodiment, Xn-U protocol stack and/or a Xn-C protocol stack may be same or similar to a user plane and/or control plane protocol stack(s) shown and described herein.

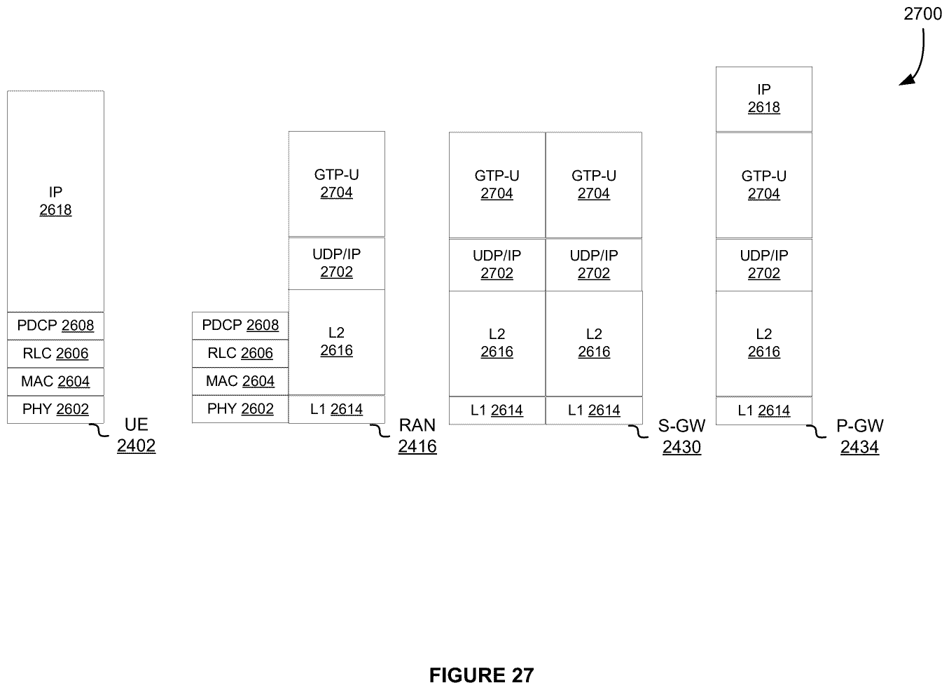

FIG. 26 is an illustration of a control plane protocol stack in accordance with at least one embodiment. In at least one embodiment, a control plane 2600 is shown as a communications protocol stack between UE 2602 (or alternatively, UE 2604), RAN 2616, and MME(s) 2628.

In at least one embodiment, PHY layer 2602 may transmit or receive information used by MAC layer 2604 over one or more air interfaces. In at least one embodiment, PHY layer 2602 may further perform link adaptation or adaptive modulation and coding (AMC), power control, cell search (for example, for initial synchronization and handover purposes), and other measurements used by higher layers, such as an RRC layer 2610. In at least one embodiment, PHY layer 2602 may still further perform error detection on transport channels, forward error correction (FEC) coding/de-coding of transport channels, modulation/demodulation of physical channels, interleaving, rate matching, mapping onto physical channels, and Multiple Input Multiple Output (MIMO) antenna processing.

In at least one embodiment, MAC layer 2604 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from PHY via transport channels, multiplexing MAC SDUs onto TBs, scheduling information reporting, error correction through hybrid automatic repeat request (HARD), and logical channel prioritization.

In at least one embodiment, RLC layer 2606 may operate in a plurality of modes of operation, including: Transparent Mode (TM), Unacknowledged Mode (UM), and Acknowledged Mode (AM). In at least one embodiment, RLC layer 2606 may execute transfer of upper layer protocol data units (PDUs), error correction through automatic repeat request (ARQ) for AM data transfers, and concatenation, segmentation and reassembly of RLC SDUs for UM and AM data transfers. In at least one embodiment, RLC layer 2606 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

In at least one embodiment, PDCP layer 2608n may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (for example, ciphering, deciphering, integrity protection, integrity verification, etc.).

In at least one embodiment, main services and functions of a RRC layer 2610 may include broadcast of system information (for example, included in Master Information Blocks (MIBs) or System Information Blocks (SIBs) related to a non-access stratum (NAS)), broadcast of system information related to an access stratum (AS), paging, establishment, maintenance and release of an RRC connection between an UE and E-UTRAN (for example, RRC connection paging, RRC connection establishment, RRC connection modification, and RRC connection release), establishment, configuration, maintenance and release of point-to-point radio bearers, security functions including key management, inter radio access technology (RAT) mobility, and measurement configuration for UE measurement reporting. In at least one embodiment, said MIBs and SIBs may comprise one or more information elements (IEs), which may each comprise individual data fields or data structures.

In at least one embodiment, UE 2602 and RAN 2616 may utilize a Uu interface (for example, an LTE-Uu interface) to exchange control plane data via a protocol stack comprising PHY layer 2602, MAC layer 2604, RLC layer 2606, PDCP layer 2608n, and RRC layer 2610.

In at least one embodiment, non-access stratum (NAS) protocols (NAS protocols 2612) form a highest stratum of a control plane between UE 2602 and MME(s) 2628. In at least one embodiment, NAS protocols 2612 support mobility of UE 2602 and session management procedures to establish and maintain IP connectivity between UE 2602 and P-GW 2634.

In at least one embodiment, Si Application Protocol (S1-AP) layer (Si-AP layer 2622) may support functions of a Si interface and comprise Elementary Procedures (EPs). In at least one embodiment, an EP is a unit of interaction between RAN 2616 and CN 2638. In at least one embodiment, S1-AP layer services may comprise two groups: UE-associated services and non UE-associated services. In at least one embodiment, these services perform functions including, but not limited to: E-UTRAN Radio Access Bearer (E-RAB) management, UE capability indication, mobility, NAS signaling transport, RAN Information Management (RIM), and configuration transfer.

In at least one embodiment, Stream Control Transmission Protocol (SCTP) layer (alternatively referred to as a stream control transmission protocol/internet protocol (SCTP/IP) layer) (SCTP layer 2620) may ensure reliable delivery of signaling messages between RAN 2616 and MME(s) 2628 based, in part, on an IP protocol, supported by an IP layer 2618. In at least one embodiment, L2 layer 2616 and an L1 layer 2614 may refer to communication links (for example, wired or wireless) used by a RAN node and MME to exchange information.

In at least one embodiment, RAN 2616 and MME(s) 2628 may utilize an S1-MME interface to exchange control plane data via a protocol stack comprising a L1 layer 2614, L2 layer 2616, IP layer 2618, SCTP layer 2620, and Si-AP layer 2622.

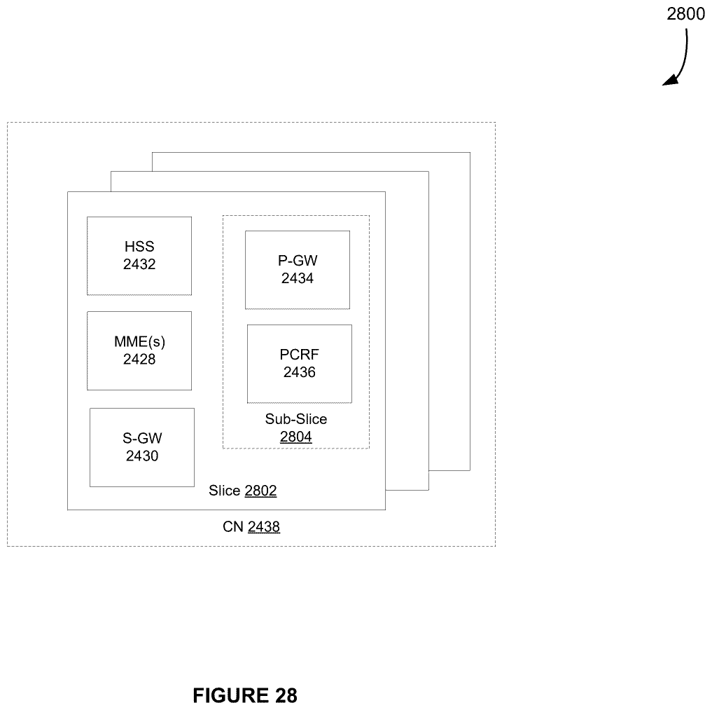

FIG. 27 is an illustration of a user plane protocol stack in accordance with at least one embodiment. In at least one embodiment, a user plane 2700 is shown as a communications protocol stack between a UE 2602. RAN 2616, S-GW 2630, and P-GW 2634. In at least one embodiment, user plane 2700 may utilize a same protocol layers as control plane 1700. In at least one embodiment, for example, UE 2602 and RAN 2616 may utilize a Uu interface (for example, an LTE-Uu interface) to exchange user plane data via a protocol stack comprising PHY layer 1702, MAC layer 1704, RLC layer 1706, PDCP layer 1708.

In at least one embodiment, General Packet Radio Service (GPRS) Tunneling Protocol for a user plane (GTP-U) layer (GTP-U layer 2704) may be used for carrying user data within a GPRS core network and between a radio access network and a core network. In at least one embodiment, user data transported can be packets in any of IPV4, IPV6, or PPP formats, for example. In at least one embodiment, UDP and IP security (UDP/IP) layer (UDP/IP layer 2702) may provide checksums for data integrity, port numbers for addressing different functions at a source and destination, and encryption and authentication on selected data flows. In at least one embodiment, RAN 2616 and S-GW 2630 may utilize an S1-U interface to exchange user plane data via a protocol stack comprising L1 layer 1714, L2 layer 1716, UDP/IP layer 2702, and GTP-U layer 2704. In at least one embodiment, S-GW 2630 and P-GW 2634 may utilize an S5/S8a interface to exchange user plane data via a protocol stack comprising L1 layer 1714, L2 layer 1716, UDP/IP layer 2702, and GTP-U layer 2704. In at least one embodiment, as discussed above with respect to FIG. 17, NAS protocols support a mobility of UE 2602 and session management procedures to establish and maintain IP connectivity between UE 2602 and P-GW 2634.

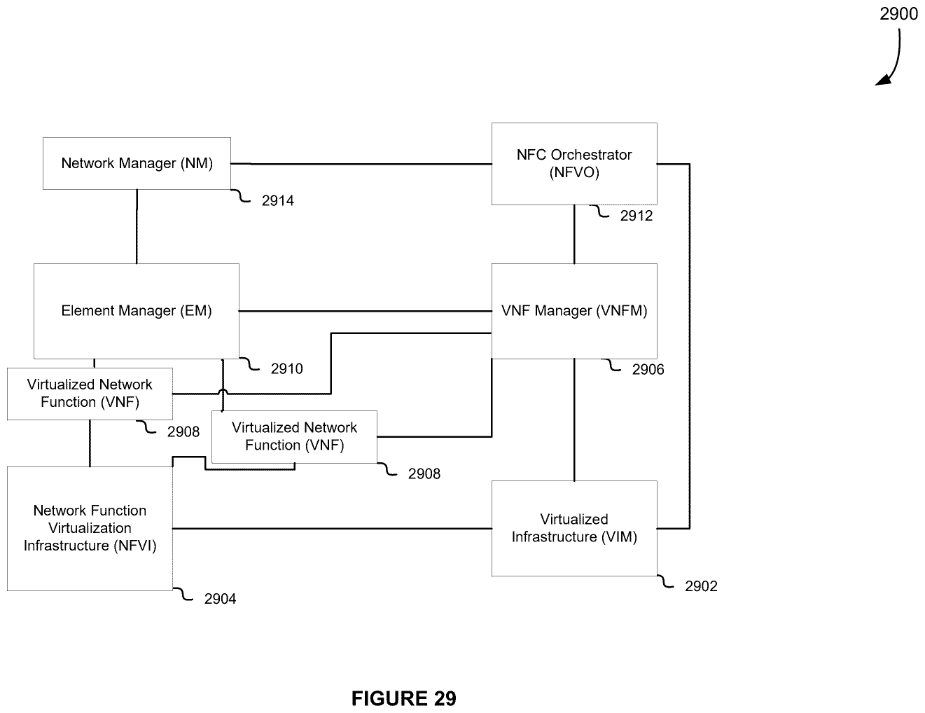

FIG. 28 illustrates components 2800 of a core network in accordance with at least one embodiment. In at least one embodiment, components of CN 2838 may be implemented in one physical node or separate physical nodes including components to read and execute instructions from a machine-readable or computer-readable medium (for example, a non-transitory machine-readable storage medium). In at least one embodiment, Network Functions Virtualization (NFV) is utilized to virtualize any or all of above described network node functions via executable instructions stored in one or more computer readable storage mediums (described in further detail below). In at least one embodiment, a logical instantiation of CN 2838 may be referred to as a network slice 2802 (for example, network slice 2802 is shown to include HSS 2832, MME(s) 2828, and S-GW 2830). In at least one embodiment, a logical instantiation of a portion of CN 2838 may be referred to as a network sub-slice 2804 (for example, network sub-slice 2804 is shown to include P-GW 2834 and PCRF 2836).

In at least one embodiment, NFV architectures and infrastructures may be used to virtualize one or more network functions, alternatively performed by proprietary hardware, onto physical resources comprising a combination of industry-standard server hardware, storage hardware, or switches. In at least one embodiment, NFV systems can be used to execute virtual or reconfigurable implementations of one or more EPC components/functions.

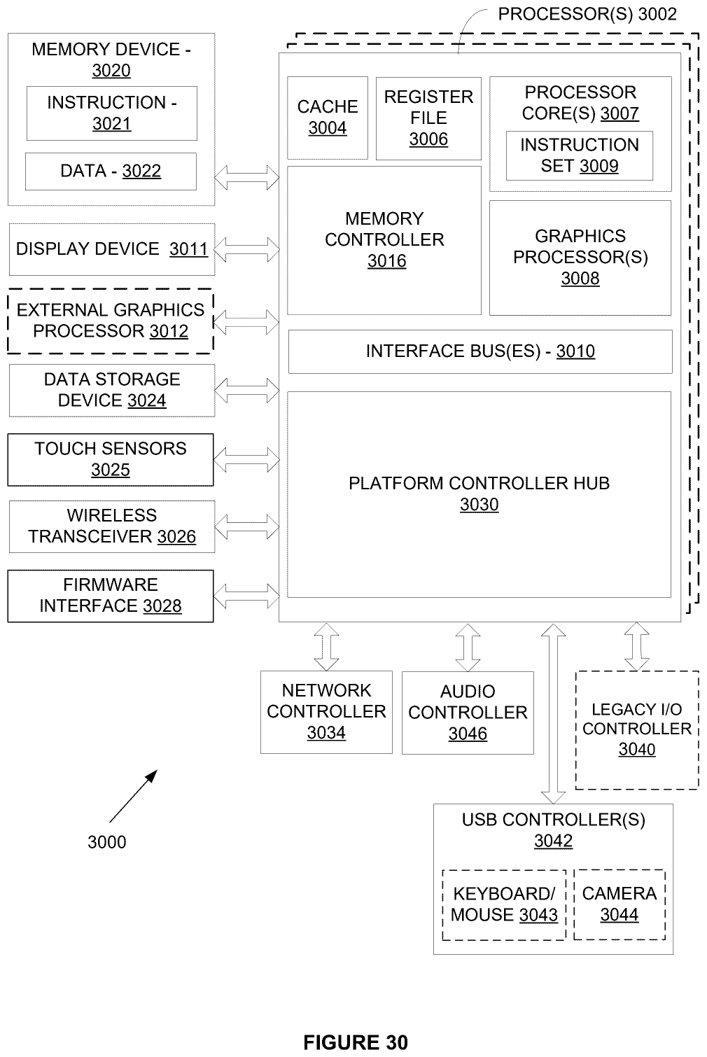

FIG. 29 is a block diagram illustrating components, according to at least one embodiment, of a system 2900 to support network function virtualization (NFV). In at least one embodiment, system 2900 is illustrated as including a virtualized infrastructure manager (shown as VIM 2902), a network function virtualization infrastructure (shown as NFVI 2904), a VNF manager (shown as VNFM 2906), virtualized network functions (shown as VNF 2908), an element manager (shown as EM 2910), an NFV Orchestrator (shown as NFVO 2912), and a network manager (shown as NM 2914).

In at least one embodiment. VIM 2902 manages resources of NFVI 2904. In at least one embodiment, NFVI 2904 can include physical or virtual resources and applications (including hypervisors) used to execute system 2900. In at least one embodiment, VIM 2902 may manage a life cycle of virtual resources with NFVI 2904 (for example, creation, maintenance, and tear down of virtual machines (VMs) associated with one or more physical resources), track VM instances, track performance, fault and security of VM instances and associated physical resources, and expose VM instances and associated physical resources to other management systems.

In at least one embodiment, VNFM 2906 may manage VNF 2908. In at least one embodiment, VNF 2908 may be used to execute EPC components/functions. In at least one embodiment, VNFM 2906 may manage a life cycle of VNF 2908 and track performance, fault and security of virtual aspects of VNF 2908. In at least one embodiment, EM 2910 may track performance, fault and security of functional aspects of VNF 2908. In at least one embodiment, tracking data from VNFM 2906 and EM 2910 may comprise, for example, performance measurement (PM) data used by VIM 2902 or NFVI 2904. In at least one embodiment, both VNFM 2906 and EM 2910 can scale up/down a quantity of VNFs of system 2900.

In at least one embodiment, NFVO 2912 may coordinate, authorize, release and engage resources of NFVI 2904 in order to provide a requested service (for example, to execute an EPC function, component, or slice). In at least one embodiment, NM 2914 may provide a package of end-user functions with responsibility for a management of a network, which may include network elements with VNFs, non-virtualized network functions, or both (management of VNFs may occur via an EM 2910).

### Computer-Based Systems

The following figures set forth, without limitation, exemplary computer-based systems that can be used to implement at least one embodiment.

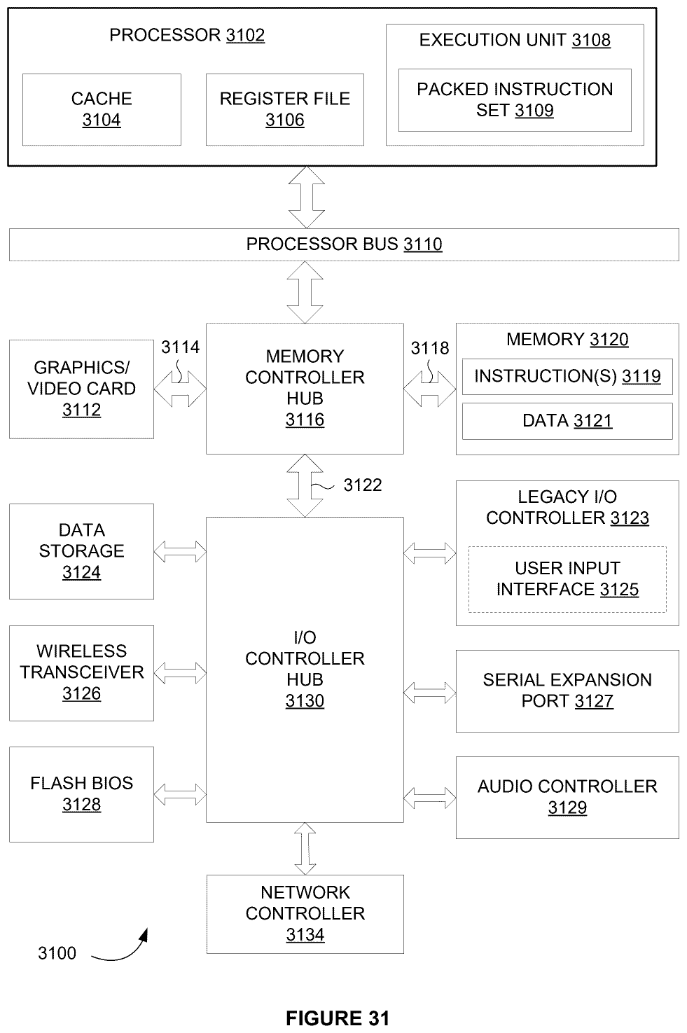

FIG. 30 illustrates a processing system 3000, in accordance with at least one embodiment. In at least one embodiment, processing system 3000 includes one or more processors 3002 and one or more graphics processors 3008, and may be a single processor desktop system, a multiprocessor workstation system, or a server system having a large number of processors 3002 or processor cores 3007. In at least one embodiment, processing system 3000 is a processing platform incorporated within a system-on-a-chip (“SoC”) integrated circuit for use in mobile, handheld, or embedded devices. The processing system 3000 and/or the processor(s) 3002 may be the same as or at least similar to the servers, the electronic components, the sets of one or more processors, and/or the power-on control circuitry illustrated in any one or more FIGS. 1 through 5 and may include one or more same or similar features as the servers, the electronic components, the sets of one or more processors, and/or the power-on control circuitry illustrated in any one or more FIGS. 1 through 5.

In at least one embodiment, processing system 3000 can include, or be incorporated within a server-based gaming platform, a game console, a media console, a mobile gaming console, a handheld game console, or an online game console. In at least one embodiment, processing system 3000 is a mobile phone, smart phone, tablet computing device or mobile Internet device. In at least one embodiment, processing system 3000 can also include, couple with, or be integrated within a wearable device, such as a smart watch wearable device, smart eyewear device, augmented reality device, or virtual reality device. In at least one embodiment, processing system 3000 is a television or set top box device having one or more processors 3002 and a graphical interface generated by one or more graphics processors 3008.

In at least one embodiment, one or more processors 3002 each include one or more processor cores 3007 to process instructions which, when executed, perform operations for system and user software. In at least one embodiment, each of one or more processor cores 3007 is configured to process a specific instruction set 3009. In at least one embodiment, instruction set 3009 may facilitate Complex Instruction Set Computing (“CISC”), Reduced Instruction Set Computing (“RISC”), or computing via a Very Long Instruction Word (“VLIW”). In at least one embodiment, processor cores 3007 may each process a different instruction set 3009, which may include instructions to facilitate emulation of other instruction sets. In at least one embodiment, processor core 3007 may also include other processing devices, such as a digital signal processor (“DSP”).

In at least one embodiment, processor 3002 includes cache memory (‘cache”) 3004. In at least one embodiment, processor 3002 can have a single internal cache or multiple levels of internal cache. In at least one embodiment, cache memory is shared among various components of processor 3002. In at least one embodiment, processor 3002 also uses an external cache (for example, a Level 3 (“L3”) cache or Last Level Cache (“LLC”)) (not shown), which may be shared among processor cores 3007 using known cache coherency techniques. In at least one embodiment, register file 3006 is additionally included in processor 3002 which may include different types of registers for storing different types of data (for example, integer registers, floating point registers, status registers, and an instruction pointer register). In at least one embodiment, register file 3006 may include general-purpose registers or other registers.

In at least one embodiment, one or more processor(s) 3002 are coupled with one or more interface bus(es) 3010 to transmit communication signals such as address, data, or control signals between processor 3002 and other components in processing system 3000. In at least one embodiment interface bus 3010, in one embodiment, can be a processor bus, such as a version of a Direct Media Interface (“DMI”) bus. In at least one embodiment, interface bus 3010 is not limited to a DMI bus, and may include one or more Peripheral Component Interconnect buses (for example, “PCI,” PCI Express (“PCIe”)), memory buses, or other types of interface buses. In at least one embodiment processor(s) 3002 include an integrated memory controller 3016 and a platform controller hub 3030. In at least one embodiment, memory controller 3016 facilitates communication between a memory device and other components of processing system 3000, while platform controller hub (“PCH”) 3030 provides connections to Input/Output (“I/O”) devices via a local I/O bus.

In at least one embodiment, memory device 3020 can be a dynamic random access memory (“DRAM”) device, a static random access memory (“SRAM”) device, flash memory device, phase-change memory device, or some other memory device having suitable performance to serve as processor memory. In at least one embodiment memory device 3020 can operate as system memory for processing system 3000, to store data 3022 and instructions 3021 for use when one or more processors 3002 executes an application or process. In at least one embodiment, memory controller 3016 also couples with an optional external graphics processor 3012, which may communicate with one or more graphics processors 3008 in processors 3002 to perform graphics and media operations. In at least one embodiment, a display device 3011 can connect to processor(s) 3002. In at least one embodiment display device 3011 can include one or more of an internal display device, as in a mobile electronic device or a laptop device or an external display device attached via a display interface (for example, DisplayPort, etc.). In at least one embodiment, display device 3011 can include a head mounted display (“HMD”) such as a stereoscopic display device for use in virtual reality (“VR”) applications or augmented reality (“AR”) applications.

In at least one embodiment, platform controller hub 3030 enables peripherals to connect to memory device 3020 and processor 3002 via a high-speed I/O bus. In at least one embodiment, I/O peripherals include, but are not limited to, an audio controller 3046, a network controller 3034, a firmware interface 3028, a wireless transceiver 3026, touch sensors 3025, a data storage device 3024 (for example, hard disk drive, flash memory, etc.). In at least one embodiment, data storage device 3024 can connect via a storage interface (for example, SATA) or via a peripheral bus, such as PCI, or PCIe. In at least one embodiment, touch sensors 3025 can include touch screen sensors, pressure sensors, or fingerprint sensors. In at least one embodiment, wireless transceiver 3026 can be a Wi-Fi transceiver, a Bluetooth transceiver, or a mobile network transceiver such as a 3G, 4G, or Long Term Evolution (“LTE”) transceiver. In at least one embodiment, firmware interface 3028 enables communication with system firmware, and can be, for example, a unified extensible firmware interface (“UEFI”). In at least one embodiment, network controller 3034 can enable a network connection to a wired network. In at least one embodiment, a high-performance network controller (not shown) couples with interface bus 3010. In at least one embodiment, audio controller 3046 is a multi-channel high definition audio controller. In at least one embodiment, processing system 3000 includes an optional legacy I/O controller 3040 for coupling legacy (for example, Personal System 2 (“PS/2”)) devices to processing system 3000. In at least one embodiment, platform controller hub 3030 can also connect to one or more Universal Serial Bus (“USB”) controllers 3042 connect input devices, such as keyboard and mouse 3043 combinations, a camera 3044, or other USB input devices.

In at least one embodiment, an instance of memory controller 3016 and platform controller hub 3030 may be integrated into a discreet external graphics processor, such as external graphics processor 3012. In at least one embodiment, platform controller hub 3030 and/or memory controller 3016 may be external to one or more processor(s) 3002. For example, in at least one embodiment, processing system 3000 can include an external memory controller 3016 and platform controller hub 3030, which may be configured as a memory controller hub and peripheral controller hub within a system chipset that is in communication with processor(s) 3002.

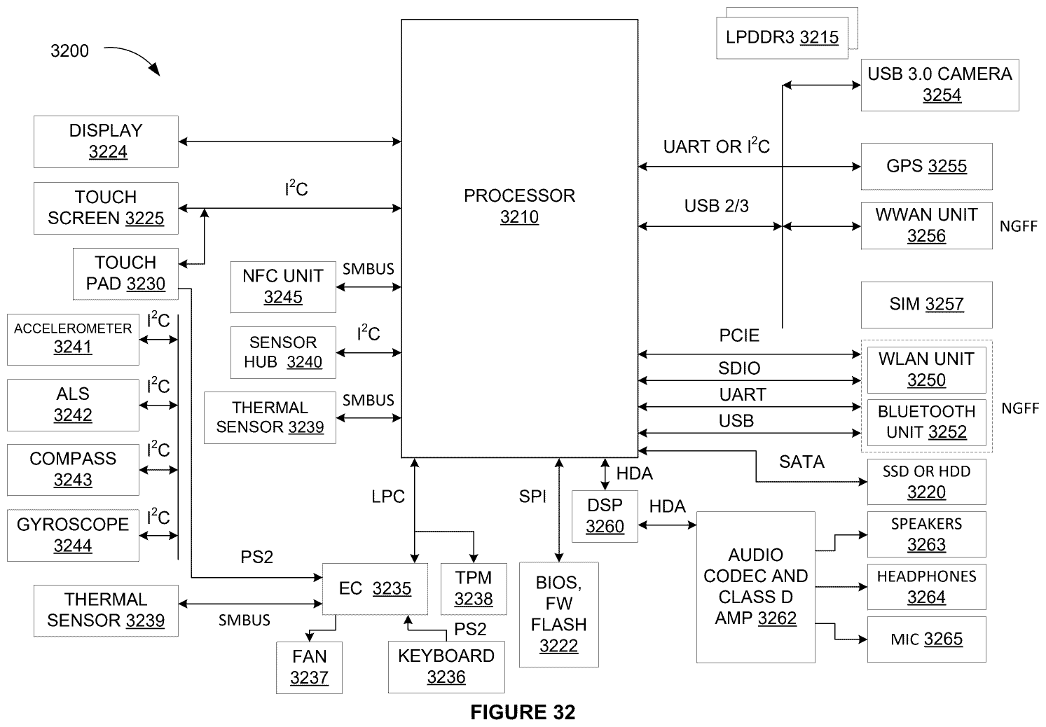

FIG. 31 illustrates a computer system 3100, in accordance with at least one embodiment. In at least one embodiment, computer system 3100 may be a system with interconnected devices and components, an SOC, or some combination. In at least on embodiment, computer system 3100 is formed with a processor 3102 that may include execution units to execute an instruction. In at least one embodiment, computer system 3100 may include, without limitation, a component, such as processor 3102 to employ execution units including logic to perform algorithms for processing data. In at least one embodiment, computer system 3100 may include processors, such as PENTIUM® Processor family, Xeon™, Itanium®, XScale™ and/or StrongARM™, Intel® Core™, or IntelR Nervana™ microprocessors available from Intel Corporation of Santa Clara, California, although other systems (including PCs having other microprocessors, engineering workstations, set-top boxes and like) may also be used. In at least one embodiment, computer system 3100 may execute a version of WINDOWS' operating system available from Microsoft Corporation of Redmond, Wash., although other operating systems (UNIX and Linux for example), embedded software, and/or graphical user interfaces, may also be used. The computer system 3100 and/or the processor 3102 may be the same as or at least similar to the servers, the electronic components, the sets of one or more processors, and/or the power-on control circuitry illustrated in any one or more FIGS. 1 through 5 and may include one or more same or similar features as the servers, the electronic components, the sets of one or more processors, and/or the power-on control circuitry illustrated in any one or more of FIGS. 1 through 5.

In at least one embodiment, computer system 3100 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 3100 may include, without limitation, processor 3102 that may include, without limitation, one or more execution units 3108 that may be configured to execute a Compute Unified Device Architecture (“CUDA”) (CUDAR is developed by NVIDIA Corporation of Santa Clara, CA) program. In at least one embodiment, a CUDA program is at least a portion of a software application written in a CUDA programming language. In at least one embodiment, computer system 3100 is a single processor desktop or server system. In at least one embodiment, computer system 3100 may be a multiprocessor system. In at least one embodiment, processor 3102 may include, without limitation, a CISC microprocessor, a RISC microprocessor, a VLIW microprocessor, a processor implementing a combination of instruction sets, or any other processor device, such as a digital signal processor, for example. In at least one embodiment, processor 3102 may be coupled to a processor bus 3110 that may transmit data signals between processor 3102 and other components in computer system 3100.

In at least one embodiment, processor 3102 may include, without limitation, a Level 1 (“L1”) internal cache memory (“cache”) 3104. In at least one embodiment, processor 3102 may have a single internal cache or multiple levels of internal cache. In at least one embodiment, cache memory may reside external to processor 3102. In at least one embodiment, processor 3102 may also include a combination of both internal and external caches. In at least one embodiment, a register file 3106 may store different types of data in various registers including, without limitation, integer registers, floating point registers, status registers, and instruction pointer register.

In at least one embodiment, execution unit 3108, including, without limitation, logic to perform integer and floating point operations, also resides in processor 3102. Processor 3102 may also include a microcode (“ucode”) read only memory (“ROM”) that stores microcode for certain macro instructions. In at least one embodiment, execution unit 3108 may include logic to handle a packed instruction set 3109. In at least one embodiment, by including packed instruction set 3109 in an instruction set of a general-purpose processor 3102, along with associated circuitry to execute instructions, operations used by many multimedia applications may be performed using packed data in a general-purpose processor 3102. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 3108 may also be used in microcontrollers, embedded processors, graphics devices, DSPs, and other types of logic circuits. In at least one embodiment, computer system 3100 may include, without limitation, a memory 3120. In at least one embodiment, memory 3120 may be implemented as a DRAM device, an SRAM device, flash memory device, or other memory device. Memory 3120 may store instruction(s) 3119 and/or data 3121 represented by data signals that may be executed by processor 3102.

In at least one embodiment, a system logic chip may be coupled to processor bus 3110 and memory 3120. In at least one embodiment, a system logic chip may include, without limitation, a memory controller hub (“MCH”) 3116, and processor 3102 may communicate with MCH 3116 via processor bus 3110. In at least one embodiment, MCH 3116 may provide a high bandwidth memory path 3118 to memory 3120 for instruction and data storage and for storage of graphics commands, data and textures. In at least one embodiment, MCH 3116 may direct data signals between processor 3102, memory 3120, and other components in computer system 3100 and to bridge data signals between processor bus 3110, memory 3120, and a system I/O 3122. In at least one embodiment, system logic chip may provide a graphics port for coupling to a graphics controller. In at least one embodiment, MCH 3116 may be coupled to memory 3120 through high bandwidth memory path 3118 and graphics/video card 3112 may be coupled to MCH 3116 through an Accelerated Graphics Port (“AGP”) interconnect 3114.

In at least one embodiment, computer system 3100 may use system I/O 3122 that is a proprietary hub interface bus to couple MCH 3116 to I/O controller hub (“ICH”) 3130. In at least one embodiment, ICH 3130 may provide direct connections to some I/O devices via a local I/O bus. In at least one embodiment, local I/O bus may include, without limitation, a high-speed I/O bus for connecting peripherals to memory 3120, a chipset, and processor 3102. Examples may include, without limitation, an audio controller 3129, a firmware hub (“flash BIOS”) 3128, a wireless transceiver 3126, a data storage 3124, a legacy I/O controller 3123 containing a user input interface 3125 and a keyboard interface, a serial expansion port 3127, such as a USB, and a network controller 3134. Data storage 3124 may comprise a hard disk drive, a floppy disk drive, a CD-ROM device, a flash memory device, or other mass storage device.

In at least one embodiment, FIG. 31 illustrates a system, which includes interconnected hardware devices or “chips.” In at least one embodiment, FIG. 31 may illustrate an exemplary SoC. In at least one embodiment, devices illustrated in FIG. 31 may be interconnected with proprietary interconnects, standardized interconnects (for example, PCIe), or some combination thereof. In at least one embodiment, one or more components of system 3100 are interconnected using compute express link (“CXL”) interconnects.

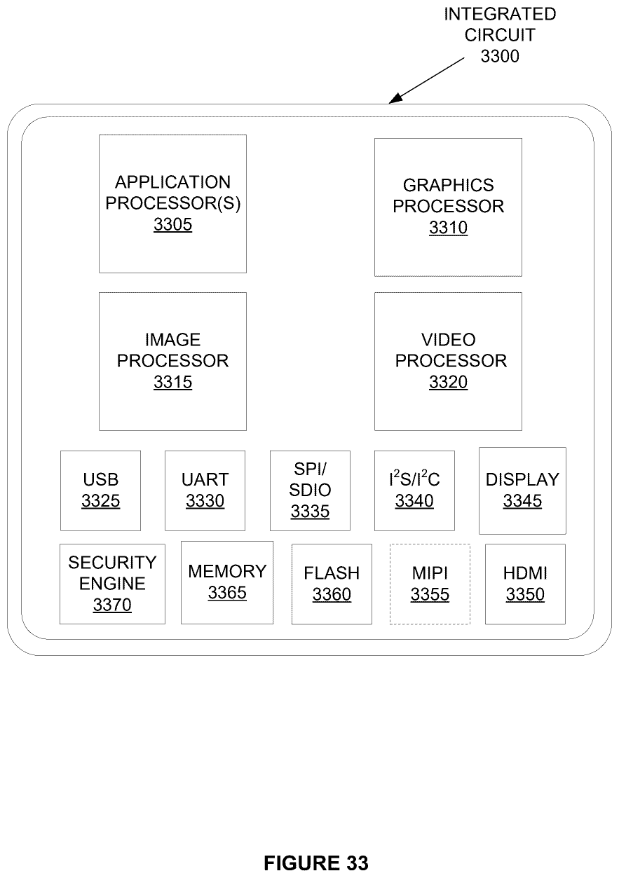

FIG. 32 illustrates a system 3200, in accordance with at least one embodiment. In at least one embodiment, system 3200 is an electronic device that utilizes a processor 3210. In at least one embodiment, system 3200 may be, for example and without limitation, a notebook, a tower server, a rack server, a blade server, a laptop, a desktop, a tablet, a mobile device, a phone, an embedded computer, or any other suitable electronic device. The system 3200 and/or the processor 3210 may be the same as or at least similar to the servers, the electronic components, the sets of one or more processors, and/or the power control circuitry illustrated in any one or more of FIGS. 1 through 5 and may include one or more same or similar features as the servers, the electronic components, the sets of one or more processors, and/or the power on control circuitry illustrated in any one or more of FIGS. 1 through 5.

In at least one embodiment, system 3200 may include, without limitation, processor 3210 communicatively coupled to any suitable number or kind of components, peripherals, modules, or devices. In at least one embodiment, processor 3210 is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 32 illustrates a system which includes interconnected hardware devices or “chips.” In at least one embodiment, FIG. 32 may illustrate an exemplary SoC. In at least one embodiment, devices illustrated in FIG. 32 may be interconnected with proprietary interconnects, standardized interconnects (for example, PCIe) or some combination thereof. In at least one embodiment, one or more components of FIG. 32 are interconnected using CXL interconnects.

In at least one embodiment, FIG. 32 may include a display 3224, a touch screen 3225, a touch pad 3230, a Near Field Communications unit (“NFC”) 3245, a sensor hub 3240, thermal sensors 3239, an Express Chipset (“EC”) 3235, a Trusted Platform Module (“TPM”) 3238, BIOS/firmware/flash memory (“BIOS, FW Flash”) 3222, a DSP 3260, a Solid State Disk (“SSD”) or Hard Disk Drive (“HDD”) 3220, a wireless local area network unit (“WLAN”) 3250, a Bluetooth unit 3252, a Wireless Wide Area Network unit (“WWAN”) 3256, a Global Positioning System (“GPS”) 3255, a camera (“USB 3.0 camera”) 3254 such as a USB 3.0 camera, or a Low Power Double Data Rate (“LPDDR”) memory unit (“LPDDR3”) 3215 implemented in, for example, LPDDR3 standard. These components may each be implemented in any suitable manner.

In at least one embodiment, other components may be communicatively coupled to processor 3210 through components discussed above. In at least one embodiment, an accelerometer 3241, an Ambient Light Sensor (“ALS”) 3242, a compass 3243, and a gyroscope 3244 may be communicatively coupled to sensor hub 3240. In at least one embodiment, a thermal sensor 3239, a fan 3237, a keyboard 3236, and a touch pad 3230 may be communicatively coupled to EC 3235. In at least one embodiment, a speaker 3263, headphones 3264, and a microphone (“mic”) 3265 may be communicatively coupled to an audio unit (“audio codec and class d amp”) 3262, which may in turn be communicatively coupled to DSP 3260. In at least one embodiment, audio unit 3262 may include, for example and without limitation, an audio coder/decoder (“codec”) and a class D amplifier. In at least one embodiment, a SIM card (“SIM”) 3257 may be communicatively coupled to WWAN unit 3256. In at least one embodiment, components such as WLAN unit 3250 and Bluetooth unit 3252, as well as WWAN unit 3256 may be implemented in a Next Generation Form Factor (“NGFF”).

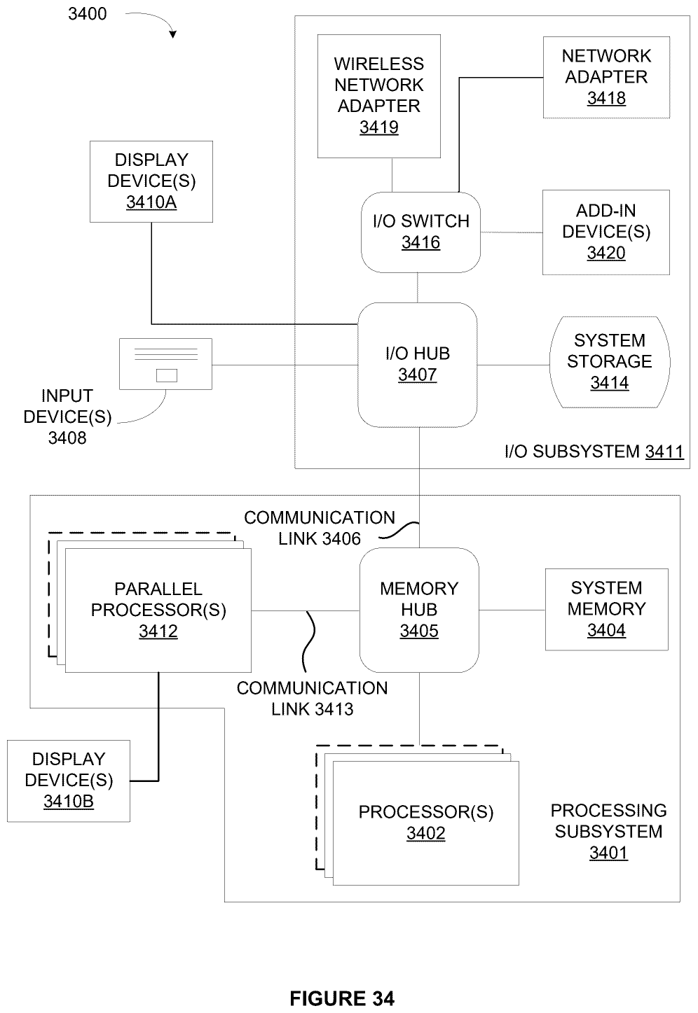

FIG. 33 illustrates an exemplary integrated circuit 3300, in accordance with at least one embodiment. In at least one embodiment, exemplary integrated circuit 3300 is an SoC that may be fabricated using one or more IP cores. In at least one embodiment, integrated circuit 3300 includes one or more application processor(s) 3305 (for example, CPUs), at least one graphics processor 3310, and may additionally include an image processor 3315 and/or a video processor 3320, any of which may be a modular IP core. In at least one embodiment, integrated circuit 3300 includes peripheral or bus logic including a USB controller 3325, a UART controller 3330, an SPI/SDIO controller 3335, and an I²S/I²C controller 3340. In at least one embodiment, integrated circuit 3300 can include a display device 3345 coupled to one or more of a high-definition multimedia interface (“HDMI”) controller 3350 and a mobile industry processor interface (“MIPI”) display interface 3355. In at least one embodiment, storage may be provided by a flash memory subsystem 3360 including flash memory and a flash memory controller. In at least one embodiment, a memory interface may be provided via a memory controller 3365 for access to SDRAM or SRAM memory devices. In at least one embodiment, some integrated circuits additionally include an embedded security engine 3370. The integrated circuit 3300 and/or the processor(s) 3305, 3310, 3315, and/or 3320 may be the same as or at least similar to the server, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

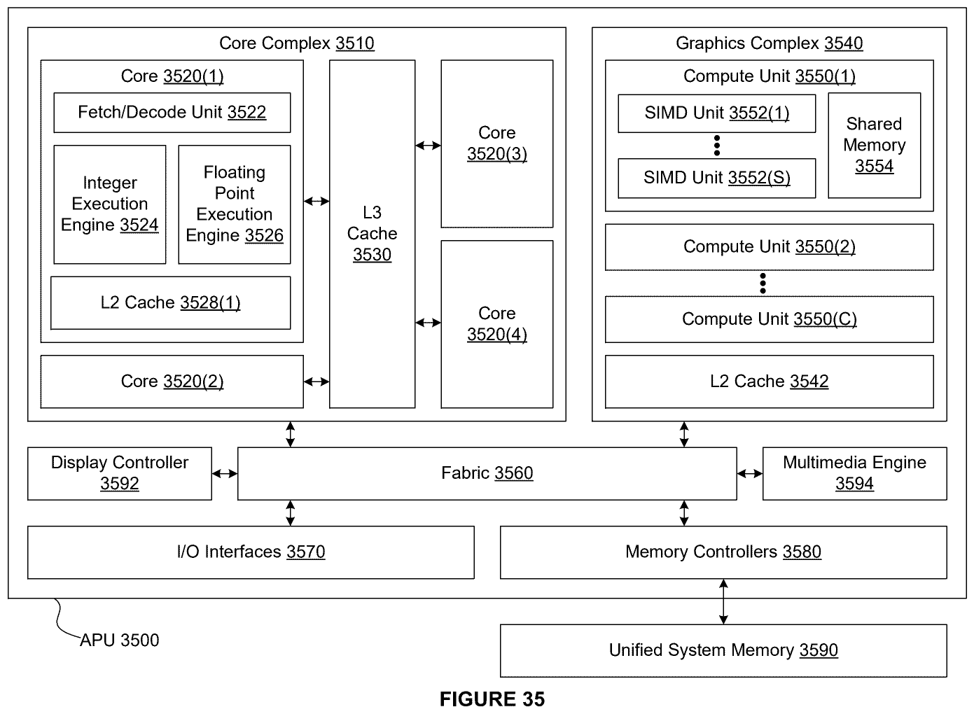

FIG. 34 illustrates a computing system 3400, according to at least one embodiment; In at least one embodiment, computing system 3400 includes a processing subsystem 3401 having one or more processor(s) 3402 and a system memory 3404 communicating via an interconnection path that may include a memory hub 3405. In at least one embodiment, memory hub 3405 may be a separate component within a chipset component or may be integrated within one or more processor(s) 3402. In at least one embodiment, memory hub 3405 couples with an I/O subsystem 3411 via a communication link 3406. In at least one embodiment, I/O subsystem 3411 includes an I/O hub 3407 that can enable computing system 3400 to receive input from one or more input device(s) 3408. In at least one embodiment, I/O hub 3407 can enable a display controller, which may be included in one or more processor(s) 3402, to provide outputs to one or more display device(s) 3410A. In at least one embodiment, one or more display device(s) 3410A coupled with I/O hub 3407 can include a local, internal, or embedded display device. The computing system 3400 and/or the processing subsystem 3401 may be the same as or at least similar to the servers, the electronic components, the sets of one or more processors, and/or the power control circuitry illustrated in any one or more of FIGS. 1 through 5 and may include one or more same or similar features as the server, the electronic components, the sets of one or more processors, and/or the power on control circuitry illustrated in any one or more of FIGS. 1 through 5.

In at least one embodiment, processing subsystem 3401 includes one or more parallel processor(s) 3412 coupled to memory hub 3405 via a bus or other communication link 3413. In at least one embodiment, communication link 3413 may be one of any number of standards based communication link technologies or protocols, such as, but not limited to PCIe, or may be a vendor specific communications interface or communications fabric. In at least one embodiment, one or more parallel processor(s) 3412 form a computationally focused parallel or vector processing system that can include a large number of processing cores and/or processing clusters, such as a many integrated core processor. In at least one embodiment, one or more parallel processor(s) 3412 form a graphics processing subsystem that can output pixels to one of one or more display device(s) 3410A coupled via I/O Hub 3407. In at least one embodiment, one or more parallel processor(s) 3412 can also include a display controller and display interface (not shown) to enable a direct connection to one or more display device(s) 3410B.

In at least one embodiment, a system storage unit 3414 can connect to I/O hub 3407 to provide a storage mechanism for computing system 3400. In at least one embodiment, an I/O switch 3416 can be used to provide an interface mechanism to enable connections between I/O hub 3407 and other components, such as a network adapter 3418 and/or wireless network adapter 3419 that may be integrated into a platform, and various other devices that can be added via one or more add-in device(s) 3420. In at least one embodiment, network adapter 3418 can be an Ethernet adapter or another wired network adapter. In at least one embodiment, wireless network adapter 3419 can include one or more of a Wi-Fi, Bluetooth, NFC, or other network device that includes one or more wireless radios.

In at least one embodiment, computing system 3400 can include other components not explicitly shown, including USB or other port connections, optical storage drives, video capture devices, and/or variations thereof, that may also be connected to I/O hub 3407. In at least one embodiment, communication paths interconnecting various components in FIG. 34 may be implemented using any suitable protocols, such as PCI based protocols (for example, PCIe), or other bus or point-to-point communication interfaces and/or protocol(s), such as NVLink high-speed interconnect, or interconnect protocols.

In at least one embodiment, one or more parallel processor(s) 3412 incorporate circuitry optimized for graphics and video processing, including, for example, video output circuitry, and constitutes a graphics processing unit (“GPU”). In at least one embodiment, one or more parallel processor(s) 3412 incorporate circuitry optimized for general purpose processing. In at least embodiment, components of computing system 3400 may be integrated with one or more other system elements on a single integrated circuit. For example, in at least one embodiment, one or more parallel processor(s) 3412, memory hub 3405, processor(s) 3402, and I/O hub 3407 can be integrated into a SoC integrated circuit. In at least one embodiment, components of computing system 3400 can be integrated into a single package to form a system in package (“SIP”) configuration. In at least one embodiment, at least a portion of components of computing system 3400 can be integrated into a multi-chip module (“MCM”), which can be interconnected with other multi-chip modules into a modular computing system. In at least one embodiment, I/O subsystem 3411 and display devices 3410B are omitted from computing system 3400.

### Processing Systems

The following figures set forth, without limitation, exemplary processing systems that can be used to implement at least one embodiment.

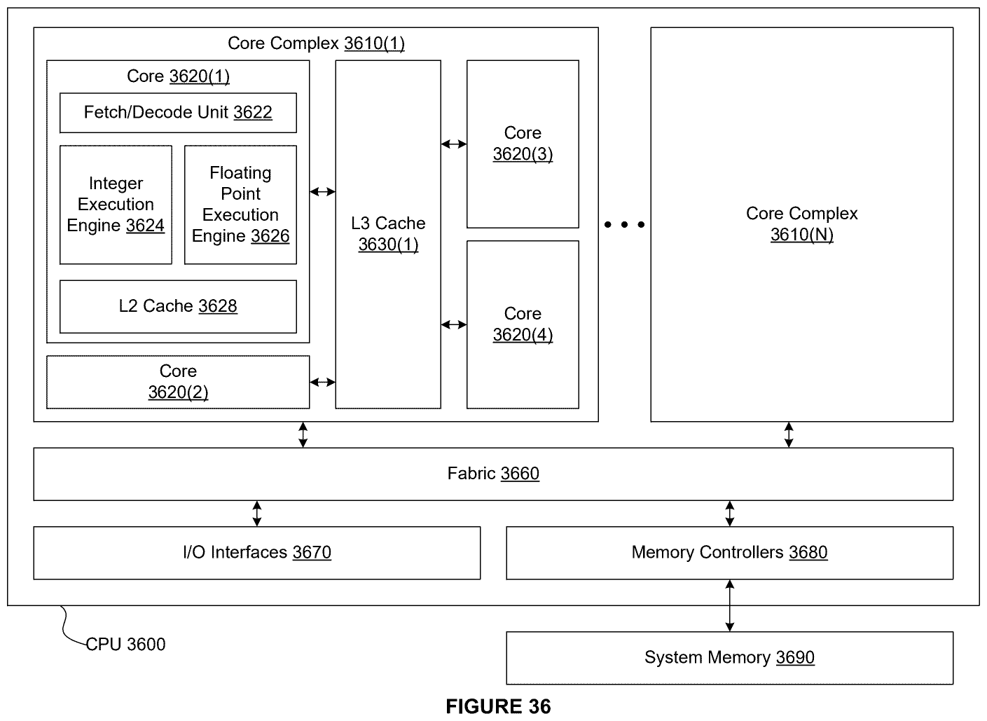

FIG. 35 illustrates an accelerated processing unit (“APU”) 3500, in accordance with at least one embodiment. In at least one embodiment, APU 3500 is developed by AMD Corporation of Santa Clara, CA. In at least one embodiment, APU 3500 can be configured to execute an application program, such as a CUDA program. In at least one embodiment, APU 3500 includes, without limitation, a core complex 3510, a graphics complex 3540, fabric 3560, I/O interfaces 3570, memory controllers 3580, a display controller 3592, and a multimedia engine 3594. In at least one embodiment, APU 3500 may include, without limitation, any number of core complexes 3510, any number of graphics complexes 3540, any number of display controllers 3592, and any number of multimedia engines 3594 in any combination. For explanatory purposes, multiple instances of like objects are denoted herein with reference numbers identifying an object and parenthetical numbers identifying an instance where needed. The APU 3500 may be the same as or at least similar to the servers, the electronic components, the sets of one or more processors, and/or the power-on control circuitry illustrated in any one or more of FIGS. 1 through 5 and may include one or more same or similar features as the server, the electronic components, the sets of one or more processors, and/or the power-on control circuitry illustrated in any one or more of FIGS. 1 through 5.

In at least one embodiment, core complex 3510 is a CPU, graphics complex 3540 is a GPU, and APU 3500 is a processing unit that integrates, without limitation, 3510 and 3540 onto a single chip. In at least one embodiment, some tasks may be assigned to core complex 3510 and other tasks may be assigned to graphics complex 3540. In at least one embodiment, core complex 3510 is configured to execute main control software associated with APU 3500, such as an operating system. In at least one embodiment, core complex 3510 is a master processor of APU 3500, controlling and coordinating operations of other processors. In at least one embodiment, core complex 3510 issues commands that control an operation of graphics complex 3540. In at least one embodiment, core complex 3510 can be configured to execute host executable code derived from CUDA source code, and graphics complex 3540 can be configured to execute device executable code derived from CUDA source code.

In at least one embodiment, core complex 3510 includes, without limitation, cores 3520(1)-2620(4) and an L3 cache 3530. In at least one embodiment, core complex 3510 may include, without limitation, any number of cores 3520 and any number and type of caches in any combination. In at least one embodiment, cores 3520 are configured to execute instructions of a particular instruction set architecture (“ISA”). In at least one embodiment, each core 3520 is a CPU core.

In at least one embodiment, each core 3520 includes, without limitation, a fetch/decode unit 3522, an integer execution engine 3524, a floating point execution engine 3526, and an L2 cache 3528. In at least one embodiment, fetch/decode unit 3522 fetches instructions, decodes such instructions, generates micro-operations, and dispatches separate micro-instructions to integer execution engine 3524 and floating point execution engine 3526. In at least one embodiment, fetch/decode unit 3522 can concurrently dispatch one micro-instruction to integer execution engine 3524 and another micro-instruction to floating point execution engine 3526. In at least one embodiment, integer execution engine 3524 executes, without limitation, integer and memory operations. In at least one embodiment, floating point engine 3526 executes, without limitation, floating point and vector operations. In at least one embodiment, fetch-decode unit 3522 dispatches micro-instructions to a single execution engine that replaces both integer execution engine 3524 and floating point execution engine 3526.

In at least one embodiment, each core 3520(i), where i is an integer representing a particular instance of core 3520, may access L2 cache 3528(i) included in core 3520(i). In at least one embodiment, each core 3520 included in core complex 3510(j), where j is an integer representing a particular instance of core complex 3510, is connected to other cores 3520 included in core complex 3510(j) via L3 cache 3530(j) included in core complex 3510(j). In at least one embodiment, cores 3520 included in core complex 3510(j), where j is an integer representing a particular instance of core complex 3510, can access all of L3 cache 3530(j) included in core complex 3510(j). In at least one embodiment, L3 cache 3530 may include, without limitation, any number of slices.

In at least one embodiment, graphics complex 3540 can be configured to perform compute operations in a highly-parallel fashion. In at least one embodiment, graphics complex 3540 is configured to execute graphics pipeline operations such as draw commands, pixel operations, geometric computations, and other operations associated with rendering an image to a display. In at least one embodiment, graphics complex 3540 is configured to execute operations unrelated to graphics. In at least one embodiment, graphics complex 3540 is configured to execute both operations related to graphics and operations unrelated to graphics.

In at least one embodiment, graphics complex 3540 includes, without limitation, any number of compute units 3550 and an L2 cache 3542. In at least one embodiment, compute units 3550 share L2 cache 3542. In at least one embodiment, L2 cache 3542 is partitioned. In at least one embodiment, graphics complex 3540 includes, without limitation, any number of compute units 3550 and any number (including zero) and type of caches. In at least one embodiment, graphics complex 3540 includes, without limitation, any amount of dedicated graphics hardware.

In at least one embodiment, compute units 3550 include, without limitation, any number of SIMD units 3552 and a shared memory 3554. In at least one embodiment, each SIMD unit 3552 implements a SIMD architecture and is configured to perform operations in parallel. In at least one embodiment, compute units 3550 may execute any number of thread blocks, but each thread block executes on a single one of compute units 3550. In at least one embodiment, a thread block includes, without limitation, any number of threads of execution. In at least one embodiment, a workgroup is a thread block. In at least one embodiment, each SIMD unit 3552 executes a different warp. In at least one embodiment, a warp is a group of threads (for example, 16 threads), where each thread in a warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 3554.

In at least one embodiment, fabric 3560 is a system interconnect that facilitates data and control transmissions across core complex 3510, graphics complex 3540, I/O interfaces 3570, memory controllers 3580, display controller 3592, and multimedia engine 3594. In at least one embodiment, APU 3500 may include, without limitation, any amount and type of system interconnect in addition to or instead of fabric 3560 that facilitates data and control transmissions across any number and type of directly or indirectly linked components that may be internal or external to APU 3500. In at least one embodiment, I/O interfaces 3570 are representative of any number and type of I/O interfaces (for example, PCI, PCI-Extended (“PCI-X”), PCIe, gigabit Ethernet (“GBE”), USB, etc.). In at least one embodiment, various types of peripheral devices are coupled to I/O interfaces 3570 In at least one embodiment, peripheral devices that are coupled to I/O interfaces 3570 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 3594 includes, without limitation, any amount and type of circuitry that is related to multimedia, such as a video decoder, a video encoder, an image signal processor, etc. In at least one embodiment, memory controllers 3580 facilitate data transfers between APU 3500 and a unified system memory 3590. In at least one embodiment, core complex 3510 and graphics complex 3540 share unified system memory 3590.

In at least one embodiment, APU 3500 implements a memory subsystem that includes, without limitation, any amount and type of memory controllers 3580 and memory devices (for example, shared memory 3554) that may be dedicated to one component or shared among multiple components. In at least one embodiment, APU 3500 implements a cache subsystem that includes, without limitation, one or more cache memories (for example, L2 caches 2728, L3 cache 3530, and L2 cache 3542) that may each be private to or shared between any number of components (for example, cores 3520, core complex 3510, SIMD units 3552, compute units 3550, and graphics complex 3540).

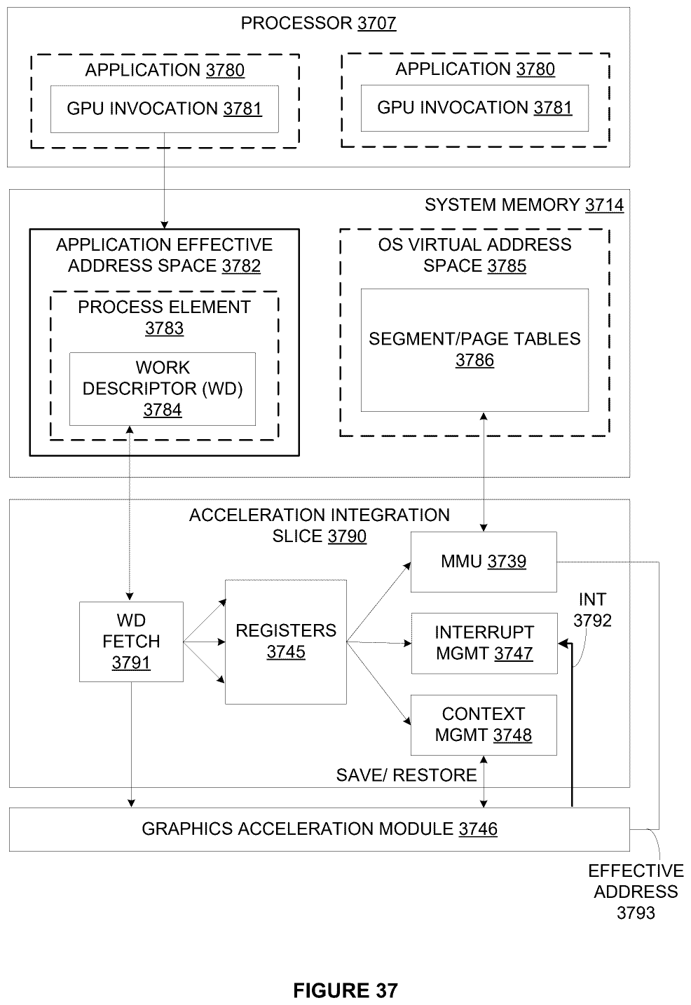

FIG. 36 illustrates a CPU 3600, in accordance with at least one embodiment. In at least one embodiment, CPU 3600 is developed by AMD Corporation of Santa Clara, CA. In at least one embodiment, CPU 3600 can be configured to execute an application program. In at least one embodiment, CPU 3600 is configured to execute main control software, such as an operating system. In at least one embodiment, CPU 3600 issues commands that control an operation of an external GPU (not shown). In at least one embodiment, CPU 3600 can be configured to execute host executable code derived from CUDA source code, and an external GPU can be configured to execute device executable code derived from such CUDA source code. In at least one embodiment, CPU 3600 includes, without limitation, any number of core complexes 3610, fabric 3660, I/O interfaces 3670, and memory controllers 3680. The CPU 3600 and/or the core complex 3610(1) may be the same as or at least similar to the servers, the electronic components, the sets of one or more processors, and/or the power control circuitry illustrated in any one or more of FIGS. 1 through 5 and may include one or more same or similar features as the servers, the electronic components, the sets of one or more processors, and/or the power on control circuitry illustrated in any one or more of FIGS. 1 through 5.

In at least one embodiment, core complex 3610 includes, without limitation, cores 3620(1)-2720(4) and an L3 cache 3630. In at least one embodiment, core complex 3610 may include, without limitation, any number of cores 3620 and any number and type of caches in any combination. In at least one embodiment, cores 3620 are configured to execute instructions of a particular ISA. In at least one embodiment, each core 3620 is a CPU core.

In at least one embodiment, each core 3620 includes, without limitation, a fetch/decode unit 3622, an integer execution engine 3624, a floating point execution engine 3626, and an L2 cache 3628. In at least one embodiment, fetch/decode unit 3622 fetches instructions, decodes such instructions, generates micro-operations, and dispatches separate micro-instructions to integer execution engine 3624 and floating point execution engine 3626. In at least one embodiment, fetch/decode unit 3622 can concurrently dispatch one micro-instruction to integer execution engine 3624 and another micro-instruction to floating point execution engine 3626. In at least one embodiment, integer execution engine 3624 executes, without limitation, integer and memory operations. In at least one embodiment, floating point engine 3626 executes, without limitation, floating point and vector operations. In at least one embodiment, fetch-decode unit 3622 dispatches micro-instructions to a single execution engine that replaces both integer execution engine 3624 and floating point execution engine 3626.

In at least one embodiment, each core 3620(i), where i is an integer representing a particular instance of core 3620, may access L2 cache 3628 (i) included in core 3620(i). In at least one embodiment, each core 3620 included in core complex 3610(j), where j is an integer representing a particular instance of core complex 3610, is connected to other cores 3620 in core complex 3610(j) via L3 cache 3630(j) included in core complex 3610(j). In at least one embodiment, cores 3620 included in core complex 3610(j), where j is an integer representing a particular instance of core complex 3610, can access all of L3 cache 3630(j) included in core complex 3610(j). In at least one embodiment, L3 cache 3630 may include, without limitation, any number of slices.

In at least one embodiment, fabric 3660 is a system interconnect that facilitates data and control transmissions across core complexes 3610(1)-2710(N) (where N is an integer greater than zero), I/O interfaces 3670, and memory controllers 3680. In at least one embodiment, CPU 3600 may include, without limitation, any amount and type of system interconnect in addition to or instead of fabric 3660 that facilitates data and control transmissions across any number and type of directly or indirectly linked components that may be internal or external to CPU 3600. In at least one embodiment, I/O interfaces 3670 are representative of any number and type of I/O interfaces (for example, PCI, PCI-X, PCIe, GBE, USB, etc.). In at least one embodiment, various types of peripheral devices are coupled to I/O interfaces 3670 In at least one embodiment, peripheral devices that are coupled to I/O interfaces 3670 may include, without limitation, displays, keyboards, mice, printers, scanners, joysticks or other types of game controllers, media recording devices, external storage devices, network interface cards, and so forth.

In at least one embodiment, memory controllers 3680 facilitate data transfers between CPU 3600 and a system memory 3690. In at least one embodiment, core complex 3610 and graphics complex 3640 share system memory 3690. In at least one embodiment, CPU 3600 implements a memory subsystem that includes, without limitation, any amount and type of memory controllers 3680 and memory devices that may be dedicated to one component or shared among multiple components. In at least one embodiment, CPU 3600 implements a cache subsystem that includes, without limitation, one or more cache memories (for example, L2 caches 3628 and L3 caches 3630) that may each be private to or shared between any number of components (for example, cores 3620 and core complexes 3610).

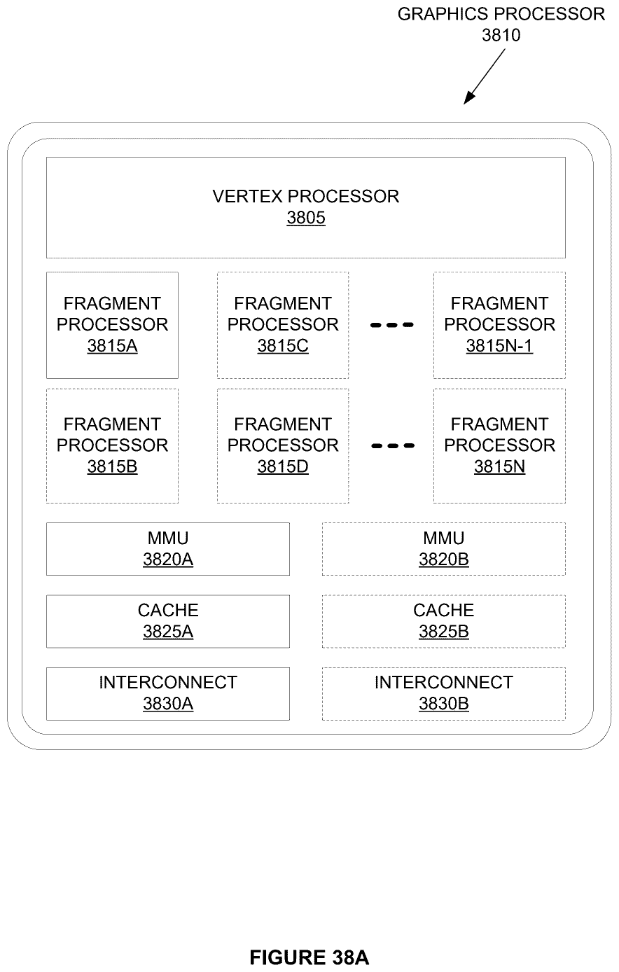

FIG. 37 illustrates an exemplary accelerator integration slice 3790, in accordance with at least one embodiment. As used herein, a “slice” comprises a specified portion of processing resources of an accelerator integration circuit. In at least one embodiment, an accelerator integration circuit provides cache management, memory access, context management, and interrupt management services on behalf of multiple graphics processing engines included in a graphics acceleration module. Graphics processing engines may each comprise a separate GPU. Alternatively, graphics processing engines may comprise different types of graphics processing engines within a GPU such as graphics execution units, media processing engines (for example, video encoders/decoders), samplers, and blit engines. In at least one embodiment, a graphics acceleration module may be a GPU with multiple graphics processing engines. In at least one embodiment, graphics processing engines may be individual GPUs integrated on a common package, line card, or chip. The processor 3707 and/or the acceleration integration slice 3790 may be the same as or at least similar to the servers, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

An application effective address space 3782 within system memory 3714 stores process elements 3783. In one embodiment, process elements 3783 are stored in response to GPU invocations 3781 from applications 3780 executed on processor 3707. A process element 3783 contains process state for corresponding application 3780. A work descriptor (“WD”) 3784 contained in process element 3783 can be a single job requested by an application or may contain a pointer to a queue of jobs. In at least one embodiment, WD 3784 is a pointer to a job request queue in application effective address space 3782.

Graphics acceleration module 3746 and/or individual graphics processing engines can be shared by all or a subset of processes in a system. In at least one embodiment, an infrastructure for setting up process state and sending WD 3784 to graphics acceleration module 3746 to start a job in a virtualized environment may be included.

In at least one embodiment, a dedicated-process programming model is implementation-specific. In this model, a single process owns graphics acceleration module 3746 or an individual graphics processing engine. Because graphics acceleration module 3746 is owned by a single process, a hypervisor initializes an accelerator integration circuit for an owning partition and an operating system initializes accelerator integration circuit for an owning process when graphics acceleration module 3746 is assigned.

In operation, a WD fetch unit 3791 in accelerator integration slice 3790 fetches next WD 3784 which includes an indication of work to be done by one or more graphics processing engines of graphics acceleration module 3746. Data from WD 3784 may be stored in registers 3745 and used by a memory management unit (“MMU”) 3739, interrupt management circuit 3747 and/or context management circuit 3748 as illustrated. For example, one embodiment of MMU 3739 includes segment/page walk circuitry for accessing segment/page tables 3786 within OS virtual address space 3785. Interrupt management circuit 3747 may process interrupt events (“INT”) 3792 received from graphics acceleration module 3746. When performing graphics operations, an effective address 3793 generated by a graphics processing engine is translated to a real address by MMU 3739.

In one embodiment, a same set of registers 3745 are duplicated for each graphics processing engine and/or graphics acceleration module 3746 and may be initialized by a hypervisor or operating system. Each of these duplicated registers may be included in accelerator integration slice 3790. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 3784 is specific to a particular graphics acceleration module 3746 and/or a particular graphics processing engine. It contains all information required by a graphics processing engine to do work or it can be a pointer to a memory location where an application has set up a command queue of work to be completed.

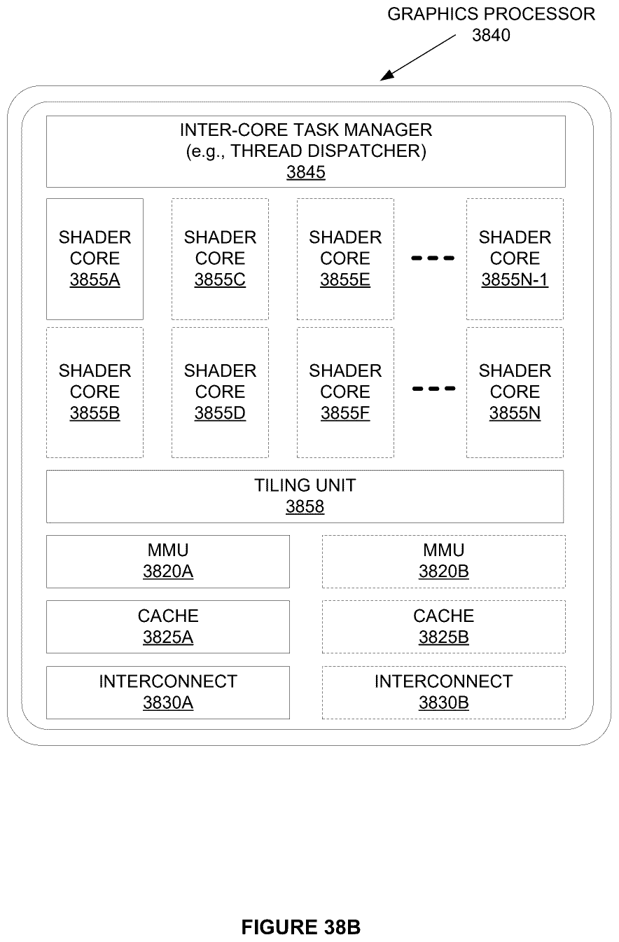

FIGS. 38A-34B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

FIG. 38A illustrates an exemplary graphics processor 3810 of an SoC integrated circuit that may be fabricated using one or more IP cores, in accordance with at least one embodiment. FIG. 38B illustrates an additional exemplary graphics processor 3840 of an SoC integrated circuit that may be fabricated using one or more IP cores, in accordance with at least one embodiment. In at least one embodiment, graphics processor 3810 of FIG. 38A is a low power graphics processor core. In at least one embodiment, graphics processor 3840 of FIG. 38B is a higher performance graphics processor core. In at least one embodiment, each of graphics processors 3810, 3840 can be variants of processor 1414 of FIG. 14. The graphics processor 3810 and/or the vertex processor 3805 may be the same as or at least similar to the servers, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

In at least one embodiment, graphics processor 3810 includes a vertex processor 3805 and one or more fragment processor(s) 3815A-3815N (for example, 3815A, 3815B, 3815C, 3815D, through 3815N-1, and 3815N). In at least one embodiment, graphics processor 3810 can execute different shader programs via separate logic, such that vertex processor 3805 is optimized to execute operations for vertex shader programs, while one or more fragment processor(s) 3815A-3815N execute fragment (for example, pixel) shading operations for fragment or pixel shader programs. In at least one embodiment, vertex processor 3805 performs a vertex processing stage of a 3D graphics pipeline and generates primitives and vertex data. In at least one embodiment, fragment processor(s) 3815A-3815N use primitive and vertex data generated by vertex processor 3805 to produce a framebuffer that is displayed on a display device. In at least one embodiment, fragment processor(s) 3815A-3815N are optimized to execute fragment shader programs as provided for in an OpenGL API, which may be used to perform similar operations as a pixel shader program as provided for in a Direct 3D API.

In at least one embodiment, graphics processor 3810 additionally includes one or more MMU(s) 3820A-3820B, cache(s) 3825A-3825B, and circuit interconnect(s) 3830A-3830B. In at least one embodiment, one or more MMU(s) 3820A-3820B provide for virtual to physical address mapping for graphics processor 3810, including for vertex processor 3805 and/or fragment processor(s) 3815A-3815N, which may reference vertex or image/texture data stored in memory, in addition to vertex or image/texture data stored in one or more cache(s) 3825A-3825B. In at least one embodiment, one or more MMU(s) 3820A-3820B may be synchronized with other MMUs within a system, including one or more MMUs associated with one or more application processor(s), image processors, and/or video processors, such that each processor can participate in a shared or unified virtual memory system. In at least one embodiment, one or more circuit interconnect(s) 3830A-3830B enable graphics processor 3810 to interface with other IP cores within an SoC, either via an internal bus of an SoC or via a direct connection.

In at least one embodiment, graphics processor 3840 includes one or more MMU(s) 3820A-3820B, caches 3825A-3825B, and circuit interconnects 3830A-3830B of graphics processor 3810 of FIG. 38A. In at least one embodiment, graphics processor 3840 includes one or more shader core(s) 3855A-3855N (for example, 3855A, 3855B, 3855C, 3855D, 3855E, 3855F, through 3855N-1, and 3855N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 3840 includes an inter-core task manager 3845, which acts as a thread dispatcher to dispatch execution threads to one or more shader cores 3855A-3855N and a tiling unit 3858 to accelerate tiling operations for tile-based rendering, in which rendering operations for a scene are subdivided in image space, for example to exploit local spatial coherence within a scene or to optimize use of internal caches. The graphics processor 3840 may be the same as or at least similar to the servers, the electronic components, the sets of one or more processors, and/or the power control circuitry illustrated in any one or more of FIGS. 1 through 5 and may include one or more same or similar features as the servers, the electronic components, the sets of one or more processors, and/or the power on control circuitry illustrated in any one or more of FIGS. 1 through 5.

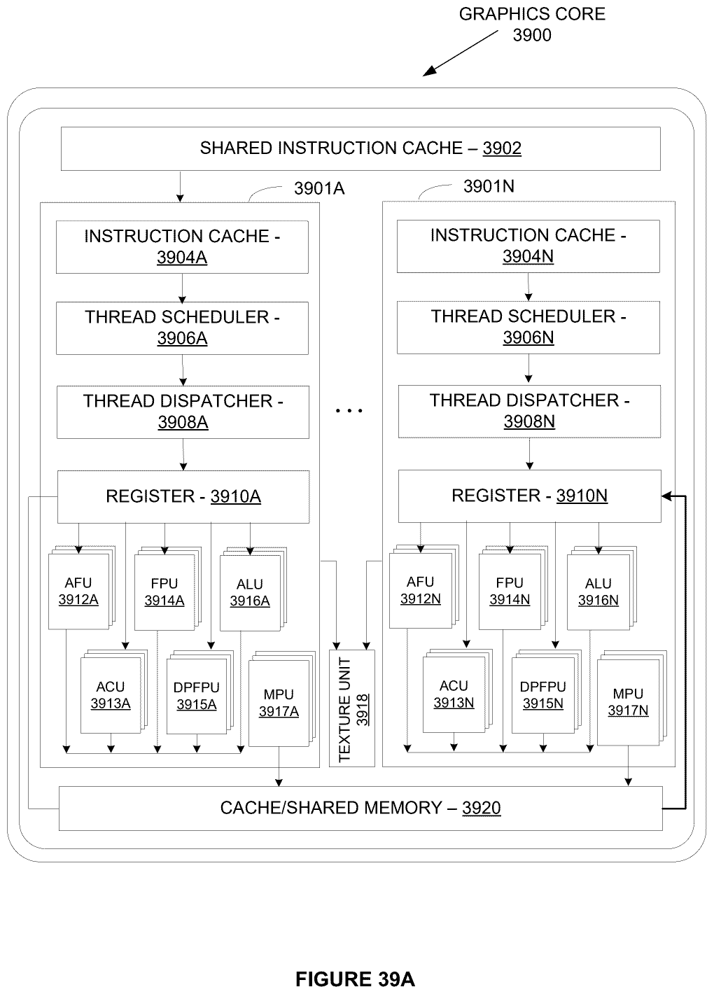

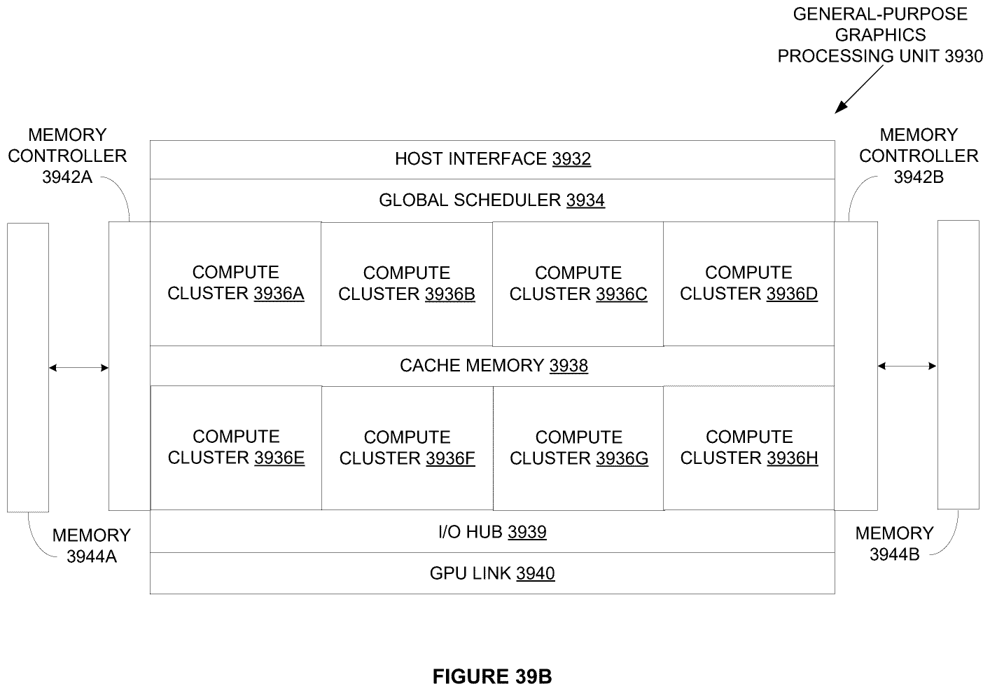

FIG. 39A illustrates a graphics core 3900, in accordance with at least one embodiment. In at least one embodiment, graphics core 3900 may be included within graphics processor 2810 of FIG. 28. In at least one embodiment, graphics core 3900 may be a unified shader core 3355A-3355N as in FIG. 33B. In at least one embodiment, graphics core 3900 includes a shared instruction cache 3902, a texture unit 3918, and a cache/shared memory 3920 that are common to execution resources within graphics core 3900. In at least one embodiment, graphics core 3900 can include multiple slices 3901A-3901N or partition for each core, and a graphics processor can include multiple instances of graphics core 3900. Slices 3901A-3901N can include support logic including a local instruction cache 3904A-3904N, a thread scheduler 3906A-3906N, a thread dispatcher 3908A-3908N, and a set of registers 3910A-3910N. In at least one embodiment, slices 3901A-3901N can include a set of additional function units (“AFUs”) 3912A-3912N, floating-point units (“FPUs”) 3914A-3914N, integer arithmetic logic units (“ALUs”) 3916-3916N, address computational units (“ACUs”) 3913A-3513N, double-precision floating-point units (“DPFPUs”) 3915A-3915N, and matrix processing units (“MPUs”) 3917A-3517N. The graphics core 3900 and/or the vertex processor 3405 may be the same as or at least similar to the servers, the electronic components, the sets of one or more processors, and/or the power control circuitry illustrated in any one or more of FIGS. 1 through 5 and may include one or more same or similar features as the servers, the electronic components, the sets of one or more processors, and/or the power on control circuitry illustrated in any one or more of FIGS. 1 through 5.

In at least one embodiment, FPUs 3914A-3914N can perform single-precision (32-bit) and half-precision (16-bit) floating point operations, while DPFPUs 3915A-3915N perform double precision (64-bit) floating point operations. In at least one embodiment, ALUs 3916A-3916N can perform variable precision integer operations at 8-bit. 16-bit, and 32-bit precision, and can be configured for mixed precision operations. In at least one embodiment, MPUs 3917A-3917N can also be configured for mixed precision matrix operations, including half-precision floating point and 8-bit integer operations. In at least one embodiment, MPUs 3917-3917N can perform a variety of matrix operations to accelerate CUDA programs, including enabling support for accelerated general matrix to matrix multiplication (“GEMM”). In at least one embodiment, AFUs 3912A-3912N can perform additional logic operations not supported by floating-point or integer units, including trigonometric operations (for example, Sine, Cosine, etc.).

FIG. 39B illustrates a general-purpose graphics processing unit (“GPGPU”) 3930, in accordance with at least one embodiment. In at least one embodiment, GPGPU 3930 is highly-parallel and suitable for deployment on a multi-chip module. In at least one embodiment, GPGPU 3930 can be configured to enable highly-parallel compute operations to be performed by an array of GPUs. In at least one embodiment, GPGPU 3930 can be linked directly to other instances of GPGPU 3930 to create a multi-GPU cluster to improve execution time for CUDA programs. In at least one embodiment, GPGPU 3930 includes a host interface 3932 to enable a connection with a host processor. In at least one embodiment, host interface 3932 is a PCIe interface. In at least one embodiment, host interface 3932 can be a vendor specific communications interface or communications fabric. In at least one embodiment, GPGPU 3930 receives commands from a host processor and uses a global scheduler 3934 to distribute execution threads associated with those commands to a set of compute clusters 3936A-3936H. In at least one embodiment, compute clusters 3936A-3936H share a cache memory 3938. In at least one embodiment, cache memory 3938 can serve as a higher-level cache for cache memories within compute clusters 3936A-3936H.

In at least one embodiment, GPGPU 3930 includes memory 3944A-3944B coupled with compute clusters 3936A-3936H via a set of memory controllers 3942A-3942B. In at least one embodiment, memory 3944A-3944B can include various types of memory devices including DRAM or graphics random access memory, such as synchronous graphics random access memory (“SGRAM”), including graphics double data rate (“GDDR”) memory. The GPGPU 3930 may be the same as or at least similar to the servers, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

In at least one embodiment, compute clusters 3936A-3936H each include a set of graphics cores, such as graphics core 3900 of FIG. 39A, which can include multiple types of integer and floating point logic units that can perform computational operations at a range of precisions including suited for computations associated with CUDA programs. For example, in at least one embodiment, at least a subset of floating point units in each of compute clusters 3936A-3936H can be configured to perform 16-bit or 32-bit floating point operations, while a different subset of floating point units can be configured to perform 64-bit floating point operations.

In at least one embodiment, multiple instances of GPGPU 3930 can be configured to operate as a compute cluster. In at least one embodiment, compute clusters 3936A-3936H may implement any technically feasible communication techniques for synchronization and data exchange. In at least one embodiment, multiple instances of GPGPU 3930 communicate over host interface 3932. In at least one embodiment, GPGPU 3930 includes an I/O hub 3939 that couples GPGPU 3930 with a GPU link 3940 that enables a direct connection to other instances of GPGPU 3930. In at least one embodiment, GPU link 3940 is coupled to a dedicated GPU-to-GPU bridge that enables communication and synchronization between multiple instances of GPGPU 3930. In at least one embodiment GPU link 3940 couples with a high speed interconnect to transmit and receive data to other GPGPUs 3930 or parallel processors. In at least one embodiment, multiple instances of GPGPU 3930 are located in separate data processing systems and communicate via a network device that is accessible via host interface 3932. In at least one embodiment GPU link 3940 can be configured to enable a connection to a host processor in addition to or as an alternative to host interface 3932. In at least one embodiment, GPGPU 3930 can be configured to execute a CUDA program.

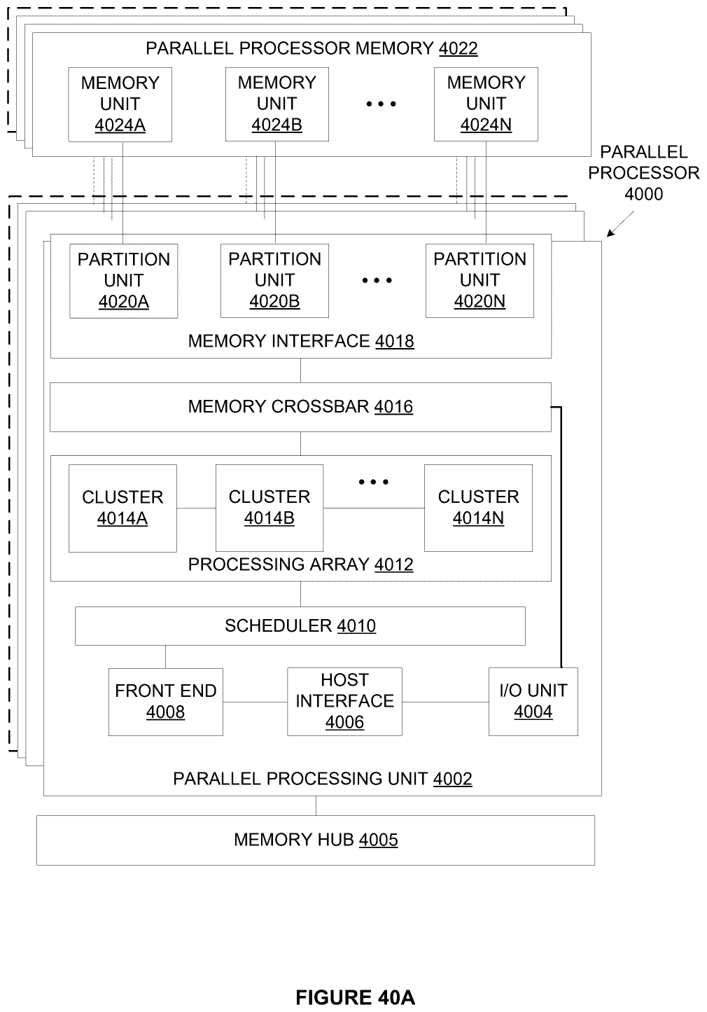

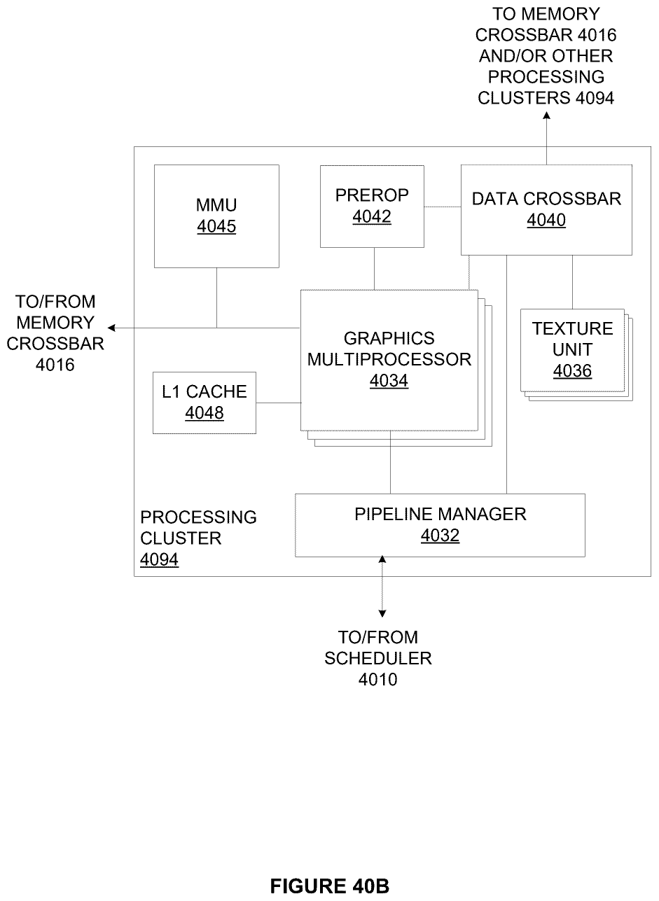

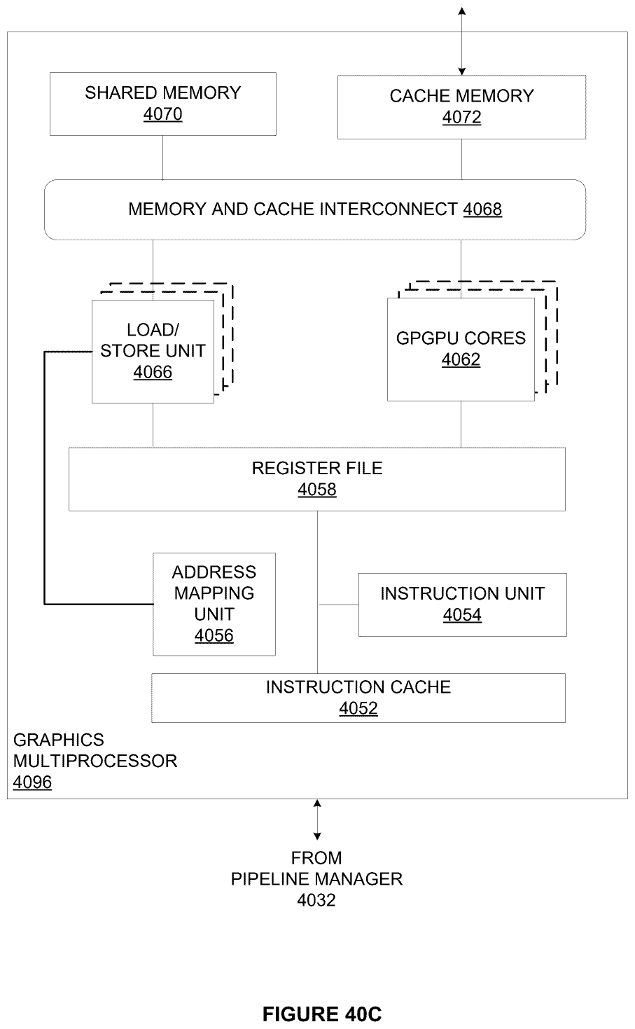

FIG. 40A illustrates a parallel processor 4000, in accordance with at least one embodiment. In at least one embodiment, various components of parallel processor 4000 may be implemented using one or more integrated circuit devices, such as programmable processors, application specific integrated circuits (“ASICs”), or FPGAs. The parallel processor 4000 may be the same as or at least similar to the servers, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

In at least one embodiment, parallel processor 4000 includes a parallel processing unit 4002. In at least one embodiment, parallel processing unit 4002 includes an I/O unit 4004 that enables communication with other devices, including other instances of parallel processing unit 4002. In at least one embodiment, I/O unit 4004 may be directly connected to other devices. In at least one embodiment, I/O unit 4004 connects with other devices via use of a hub or switch interface, such as memory hub 605. In at least one embodiment, connections between memory hub 605 and I/O unit 4004 form a communication link. In at least one embodiment, I/O unit 4004 connects with a host interface 4006 and a memory crossbar 4016, where host interface 4006 receives commands directed to performing processing operations and memory crossbar 4016 receives commands directed to performing memory operations.

In at least one embodiment, when host interface 4006 receives a command buffer via I/O unit 4004, host interface 4006 can direct work operations to perform those commands to a front end 4008. In at least one embodiment, front end 4008 couples with a scheduler 4010, which is configured to distribute commands or other work items to a processing array 4012. In at least one embodiment, scheduler 4010 ensures that processing array 4012 is properly configured and in a valid state before tasks are distributed to processing array 4012. In at least one embodiment, scheduler 4010 is implemented via firmware logic executing on a microcontroller. In at least one embodiment, microcontroller implemented scheduler 4010 is configurable to perform complex scheduling and work distribution operations at coarse and fine granularity, enabling rapid preemption and context switching of threads executing on processing array 4012. In at least one embodiment, host software can prove workloads for scheduling on processing array 4012 via one of multiple graphics processing doorbells. In at least one embodiment, workloads can then be automatically distributed across processing array 4012 by scheduler 4010 logic within a microcontroller including scheduler 4010.

In at least one embodiment, processing array 4012 can include up to “N” clusters (for example, cluster 4014A, cluster 4014B, through cluster 4014N). In at least one embodiment, each cluster 4014A-4014N of processing array 4012 can execute a large number of concurrent threads. In at least one embodiment, scheduler 4010 can allocate work to clusters 4014A-4014N of processing array 4012 using various scheduling and/or work distribution algorithms, which may vary depending on a workload arising for each type of program or computation. In at least one embodiment, scheduling can be handled dynamically by scheduler 4010, or can be assisted in part by compiler logic during compilation of program logic configured for execution by processing array 4012. In at least one embodiment, different clusters 4014A-4014N of processing array 4012 can be allocated for processing different types of programs or for performing different types of computations.

In at least one embodiment, processing array 4012 can be configured to perform various types of parallel processing operations. In at least one embodiment, processing array 4012 is configured to perform general-purpose parallel compute operations. For example, in at least one embodiment, processing array 4012 can include logic to execute processing tasks including filtering of video and/or audio data, performing modeling operations, including physics operations, and performing data transformations.

In at least one embodiment, processing array 4012 is configured to perform parallel graphics processing operations. In at least one embodiment, processing array 4012 can include additional logic to support execution of such graphics processing operations, including, but not limited to texture sampling logic to perform texture operations, as well as tessellation logic and other vertex processing logic. In at least one embodiment, processing array 4012 can be configured to execute graphics processing related shader programs such as, but not limited to vertex shaders, tessellation shaders, geometry shaders, and pixel shaders. In at least one embodiment, parallel processing unit 4002 can transfer data from system memory via I/O unit 4004 for processing. In at least one embodiment, during processing, transferred data can be stored to on-chip memory (for example, a parallel processor memory 4022) during processing, then written back to system memory.

In at least one embodiment, when parallel processing unit 4002 is used to perform graphics processing, scheduler 4010 can be configured to divide a processing workload into approximately equal sized tasks, to better enable distribution of graphics processing operations to multiple clusters 4014A-4014N of processing array 4012. In at least one embodiment, portions of processing array 4012 can be configured to perform different types of processing. For example, in at least one embodiment, a first portion may be configured to perform vertex shading and topology generation, a second portion may be configured to perform tessellation and geometry shading, and a nth portion may be configured to perform pixel shading or other screen space operations, to produce a rendered image for display. In at least one embodiment, intermediate data produced by one or more of clusters 4014A-4014N may be stored in buffers to allow intermediate data to be transmitted between clusters 4014A-4014N for further processing.

In at least one embodiment, processing array 4012 can receive processing tasks to be executed via scheduler 4010, which receives commands defining processing tasks from front end 4008. In at least one embodiment, processing tasks can include indices of data to be processed, for example, surface (patch) data, primitive data, vertex data, and/or pixel data, as well as state parameters and commands defining how data is to be processed (for example, what program is to be executed). In at least one embodiment, scheduler 4010 may be configured to fetch indices corresponding to tasks or may receive indices from front end 4008. In at least one embodiment, front end 4008 can be configured to ensure processing array 4012 is configured to a valid state before a workload specified by incoming command buffers (for example, batch-buffers, push buffers, etc.) is initiated.

In at least one embodiment, each of one or more instances of parallel processing unit 4002 can couple with parallel processor memory 4022. In at least one embodiment, parallel processor memory 4022 can be accessed via memory crossbar 4016, which can receive memory requests from processing array 4012 as well as I/O unit 4004. In at least one embodiment, memory crossbar 4016 can access parallel processor memory 4022 via a memory interface 4018. In at least one embodiment, memory interface 4018 can include multiple partition units (for example, a partition unit 4020A, partition unit 4020B, through partition unit 4020N) that can each couple to a portion (for example, memory unit) of parallel processor memory 4022. In at least one embodiment, a number of partition units 4020A-4020N is configured to be equal to a number of memory units, such that a first partition unit 4020A has a corresponding first memory unit 4024A, a second partition unit 4020B has a corresponding memory unit 4024B, and an Nth partition unit 4020N has a corresponding Nth memory unit 4024N. In at least one embodiment, a number of partition units 4020A-4020N may not be equal to a number of memory devices.

In at least one embodiment, memory units 4024A-4024N can include various types of memory devices, including DRAM or graphics random access memory, such as SGRAM, including GDDR memory. In at least one embodiment, memory units 4024A-4024N may also include 3D stacked memory, including but not limited to high bandwidth memory (“HBM”). In at least one embodiment, render targets, such as frame buffers or texture maps may be stored across memory units 4024A-4024N, allowing partition units 4020A-4020N to write portions of each render target in parallel to efficiently use available bandwidth of parallel processor memory 4022. In at least one embodiment, a local instance of parallel processor memory 4022 may be excluded in favor of a unified memory design that utilizes system memory in conjunction with local cache memory.

In at least one embodiment, any one of clusters 4014A-4014N of processing array 4012 can process data that will be written to any of memory units 4024A-4024N within parallel processor memory 4022. In at least one embodiment, memory crossbar 4016 can be configured to transfer an output of each cluster 4014A-4014N to any partition unit 4020A-4020N or to another cluster 4014A-4014N, which can perform additional processing operations on an output. In at least one embodiment, each cluster 4014A-4014N can communicate with memory interface 4018 through memory crossbar 4016 to read from or write to various external memory devices. In at least one embodiment, memory crossbar 4016 has a connection to memory interface 4018 to communicate with I/O unit 4004, as well as a connection to a local instance of parallel processor memory 4022, enabling processing units within different clusters 4014A-4014N to communicate with system memory or other memory that is not local to parallel processing unit 4002. In at least one embodiment, memory crossbar 4016 can use virtual channels to separate traffic streams between clusters 4014A-4014N and partition units 4020A-4020N.

In at least one embodiment, multiple instances of parallel processing unit 4002 can be provided on a single add-in card, or multiple add-in cards can be interconnected. In at least one embodiment, different instances of parallel processing unit 4002 can be configured to inter-operate even if different instances have different numbers of processing cores, different amounts of local parallel processor memory, and/or other configuration differences. For example, in at least one embodiment, some instances of parallel processing unit 4002 can include higher precision floating point units relative to other instances. In at least one embodiment, systems incorporating one or more instances of parallel processing unit 4002 or parallel processor 4000 can be implemented in a variety of configurations and form factors, including but not limited to desktop, laptop, or handheld personal computers, servers, workstations, game consoles, and/or embedded systems.

FIG. 40B illustrates a processing cluster 4094, in accordance with at least one embodiment. In at least one embodiment, processing cluster 4094 is included within a parallel processing unit. In at least one embodiment, processing cluster 4094 is one of processing clusters 4014A-4014N of FIG. 40. In at least one embodiment, processing cluster 4094 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 4094. The processing cluster 4094 may be the same as or at least similar to the servers, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

In at least one embodiment, operation of processing cluster 4094 can be controlled via a pipeline manager 4032 that distributes processing tasks to SIMT parallel processors. In at least one embodiment, pipeline manager 4032 receives instructions from scheduler 4010 of FIG. 40 and manages execution of those instructions via a graphics multiprocessor 4034 and/or a texture unit 4036. In at least one embodiment, graphics multiprocessor 4034 is an exemplary instance of a SIMT parallel processor. However, in at least one embodiment, various types of SIMT parallel processors of differing architectures may be included within processing cluster 4094. In at least one embodiment, one or more instances of graphics multiprocessor 4034 can be included within processing cluster 4094. In at least one embodiment, graphics multiprocessor 4034 can process data and a data crossbar 4040 can be used to distribute processed data to one of multiple possible destinations, including other shader units. In at least one embodiment, pipeline manager 4032 can facilitate distribution of processed data by specifying destinations for processed data to be distributed via data crossbar 4040.

In at least one embodiment, each graphics multiprocessor 4034 within processing cluster 4094 can include an identical set of functional execution logic (for example, arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 4094 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 4034. In at least one embodiment, a thread group may include fewer threads than a number of processing engines within graphics multiprocessor 4034. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 4034. In at least one embodiment, when a thread group includes more threads than a number of processing engines within graphics multiprocessor 4034, processing can be performed over consecutive clock cycles. In at least one embodiment, multiple thread groups can be executed concurrently on graphics multiprocessor 4034.

In at least one embodiment, graphics multiprocessor 4034 includes an internal cache memory to perform load and store operations. In at least one embodiment, graphics multiprocessor 4034 can forego an internal cache and use a cache memory (for example, L1 cache 4048) within processing cluster 4094. In at least one embodiment, each graphics multiprocessor 4034 also has access to Level 2 (“L2”) caches within partition units (for example, partition units 4020A-4020N of FIG. 40A) that are shared among all processing clusters 4094 and may be used to transfer data between threads. In at least one embodiment, graphics multiprocessor 4034 may also access off-chip global memory, which can include one or more of local parallel processor memory and/or system memory. In at least one embodiment, any memory external to parallel processing unit 4002 may be used as global memory. In at least one embodiment, processing cluster 4094 includes multiple instances of graphics multiprocessor 4034 that can share common instructions and data, which may be stored in L1 cache 4048.

In at least one embodiment, each processing cluster 4094 may include an MMU 4045 that is configured to map virtual addresses into physical addresses. In at least one embodiment, one or more instances of MMU 4045 may reside within memory interface 4018 of FIG. 40. In at least one embodiment, MMU 4045 includes a set of page table entries (“PTEs”) used to map a virtual address to a physical address of a tile and optionally a cache line index. In at least one embodiment, MMU 4045 may include address translation lookaside buffers (“TLBs”) or caches that may reside within graphics multiprocessor 4034 or L1 cache 4048 or processing cluster 4094. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 4094 may be configured such that each graphics multiprocessor 4034 is coupled to a texture unit 4036 for performing texture mapping operations, for example, determining texture sample positions, reading texture data, and filtering texture data. In at least one embodiment, texture data is read from an internal texture L1 cache (not shown) or from an L1 cache within graphics multiprocessor 4034 and is fetched from an L2 cache, local parallel processor memory, or system memory, as needed. In at least one embodiment, each graphics multiprocessor 4034 outputs a processed task to data crossbar 4040 to provide a processed task to another processing cluster 4094 for further processing or to store a processed task in an L2 cache, a local parallel processor memory, or a system memory via memory crossbar 4016. In at least one embodiment, a pre-raster operations unit (“preROP”) 4042 is configured to receive data from graphics multiprocessor 4034, direct data to ROP units, which may be located with partition units as described herein (for example, partition units 4020A-4020N of FIG. 40). In at least one embodiment, PreROP 4042 can perform optimizations for color blending, organize pixel color data, and perform address translations.

FIG. 40C illustrates a graphics multiprocessor 4096, in accordance with at least one embodiment. In at least one embodiment, graphics multiprocessor 4096 is graphics multiprocessor 4034 of FIG. 40B. In at least one embodiment, graphics multiprocessor 4096 couples with pipeline manager 4032 of processing cluster 4094. In at least one embodiment, graphics multiprocessor 4096 has an execution pipeline including but not limited to an instruction cache 4052, an instruction unit 4054, an address mapping unit 4056, a register file 4058, one or more GPGPU cores 4062, and one or more LSUs 4066. GPGPU cores 4062 and LSUs 4066 are coupled with cache memory 4072 and shared memory 4070 via a memory and cache interconnect 4068. The graphics multiprocessor 4096 may be the same as or at least similar to the servers, the electronic components, the sets of one or more processors, and/or the power-on control circuitry illustrated in any one or more of FIGS. 1 through 5 and may include one or more same or similar features as the servers, the electronic components, the sets of one or more processors, and/or the power-on control circuitry illustrated in any one or more of FIGS. 1 through 5.

In at least one embodiment, instruction cache 4052 receives a stream of instructions to execute from pipeline manager 4032. In at least one embodiment, instructions are cached in instruction cache 4052 and dispatched for execution by instruction unit 4054. In at least one embodiment, instruction unit 4054 can dispatch instructions as thread groups (for example, warps), with each thread of a thread group assigned to a different execution unit within GPGPU core 4062. In at least one embodiment, an instruction can access any of a local, shared, or global address space by specifying an address within a unified address space. In at least one embodiment, address mapping unit 4056 can be used to translate addresses in a unified address space into a distinct memory address that can be accessed by LSUs 4066.

In at least one embodiment, register file 4058 provides a set of registers for functional units of graphics multiprocessor 4096. In at least one embodiment, register file 4058 provides temporary storage for operands connected to data paths of functional units (for example, GPGPU cores 4062. LSUs 4066) of graphics multiprocessor 4096. In at least one embodiment, register file 4058 is divided between each of functional units such that each functional unit is allocated a dedicated portion of register file 4058. In at least one embodiment, register file 4058 is divided between different thread groups being executed by graphics multiprocessor 4096.

In at least one embodiment, GPGPU cores 4062 can each include FPUs and/or integer ALUs that are used to execute instructions of graphics multiprocessor 4096. GPGPU cores 4062 can be similar in architecture or can differ in architecture. In at least one embodiment, a first portion of GPGPU cores 4062 include a single precision FPU and an integer ALU while a second portion of GPGPU cores 4062 include a double precision FPU. In at least one embodiment, FPUs can implement IEEE 754-2008 standard for floating point arithmetic or enable variable precision floating point arithmetic. In at least one embodiment, graphics multiprocessor 4096 can additionally include one or more fixed function or special function units to perform specific functions such as copy rectangle or pixel blending operations. In at least one embodiment one or more of GPGPU cores 4062 can also include fixed or special function logic.

In at least one embodiment, GPGPU cores 4062 include SIMD logic capable of performing a single instruction on multiple sets of data. In at least one embodiment GPGPU cores 4062 can physically execute SIMD4, SIMD8, and SIMD16 instructions and logically execute SIMD1, SIMD2, and SIMD32 instructions. In at least one embodiment, SIMD instructions for GPGPU cores 4062 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 4068 is an interconnect network that connects each functional unit of graphics multiprocessor 4096 to register file 4058 and to shared memory 4070. In at least one embodiment, memory and cache interconnect 4068 is a crossbar interconnect that allows LSU 4066 to implement load and store operations between shared memory 4070 and register file 4058. In at least one embodiment, register file 4058 can operate at a same frequency as GPGPU cores 4062, thus data transfer between GPGPU cores 4062 and register file 4058 is very low latency. In at least one embodiment, shared memory 4070 can be used to enable communication between threads that execute on functional units within graphics multiprocessor 4096. In at least one embodiment, cache memory 4072 can be used as a data cache for example, to cache texture data communicated between functional units and texture unit 4036. In at least one embodiment, shared memory 4070 can also be used as a program managed cached. In at least one embodiment, threads executing on GPGPU cores 4062 can programmatically store data within shared memory in addition to automatically cached data that is stored within cache memory 4072.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (for example, a high speed interconnect such as PCIe or NVLink). In at least one embodiment, a GPU may be integrated on a same package or chip as cores and communicatively coupled to cores over a processor bus/interconnect that is internal to a package or a chip. In at least one embodiment, regardless of a manner in which a GPU is connected, processor cores may allocate work to a GPU in a form of sequences of commands/instructions contained in a WD. In at least one embodiment, a GPU then uses dedicated circuitry/logic for efficiently processing these commands/instructions.

### General Computing

The following figures set forth, without limitation, exemplary software constructs within general computing that can be used to implement at least one embodiment.

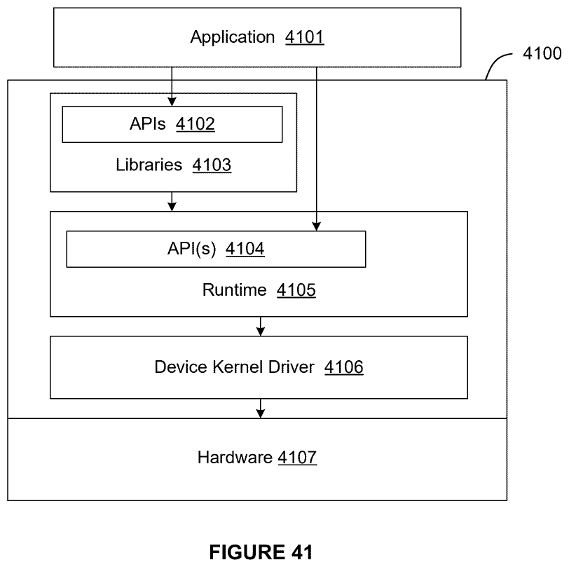

FIG. 41 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 4100 of a programming platform provides an execution environment for an application 4101. In at least one embodiment, application 4101 may include any computer software capable of being launched on software stack 4100. In at least one embodiment, application 4101 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 4101 and software stack 4100 run on hardware 4107. Hardware 4107 may include one or more GPUs, CPUs, FPGAs, AI engines, and/or other types of compute devices that support a programming platform, in at least one embodiment. In at least one embodiment, such as with CUDA, software stack 4100 may be vendor specific and compatible with only devices from particular vendor(s). In at least one embodiment, such as in with OpenCL, software stack 4100 may be used with devices from different vendors. In at least one embodiment, hardware 4107 includes a host connected to one more devices that can be accessed to perform computational tasks via application programming interface (“API”) calls. A device within hardware 4107 may include, but is not limited to, a GPU, FPGA, AI engine, or other compute device (but may also include a CPU) and its memory, as opposed to a host within hardware 4107 that may include, but is not limited to, a CPU (but may also include a compute device) and its memory, in at least one embodiment.

In at least one embodiment, software stack 4100 of a programming platform includes, without limitation, a number of libraries 4103, a runtime 4105, and a device kernel driver 4106. Each of libraries 4103 may include data and programming code that can be used by computer programs and leveraged during software development, in at least one embodiment. In at least one embodiment, libraries 4103 may include, but are not limited to, pre-written code and subroutines, classes, values, type specifications, configuration data, documentation, help data, and/or message templates. In at least one embodiment, libraries 4103 include functions that are optimized for execution on one or more types of devices. In at least one embodiment, libraries 4103 may include, but are not limited to, functions for performing mathematical, deep learning, and/or other types of operations on devices. In at least one embodiment, libraries 4103 are associated with corresponding APIs 4102, which may include one or more APIs, that expose functions implemented in libraries 4103.

In at least one embodiment, application 4101 is written as source code that is compiled into executable code, as discussed in greater detail below in conjunction with FIG. 41. Executable code of application 4101 may run, at least in part, on an execution environment provided by software stack 4100, in at least one embodiment. In at least one embodiment, during execution of application 4101, code may be reached that needs to run on a device, as opposed to a host. In such a case, runtime 4105 may be called to load and launch requisite code on a device, in at least one embodiment. In at least one embodiment, runtime 4105 may include any technically feasible runtime system that is able to support execution of application S01.

In at least one embodiment, runtime 4105 is implemented as one or more runtime libraries associated with corresponding APIs, which are shown as API(s) 4104. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 4104 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, device kernel driver 4106 is configured to facilitate communication with an underlying device. In at least one embodiment, device kernel driver 4106 may provide low-level functionalities upon which APIs, such as API(s) 4104, and/or other software relies. In at least one embodiment, device kernel driver 4106 may be configured to compile intermediate representation (“IR”) code into binary code at runtime. For CUDA, device kernel driver 4106 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 4106 to compile IR code at runtime.

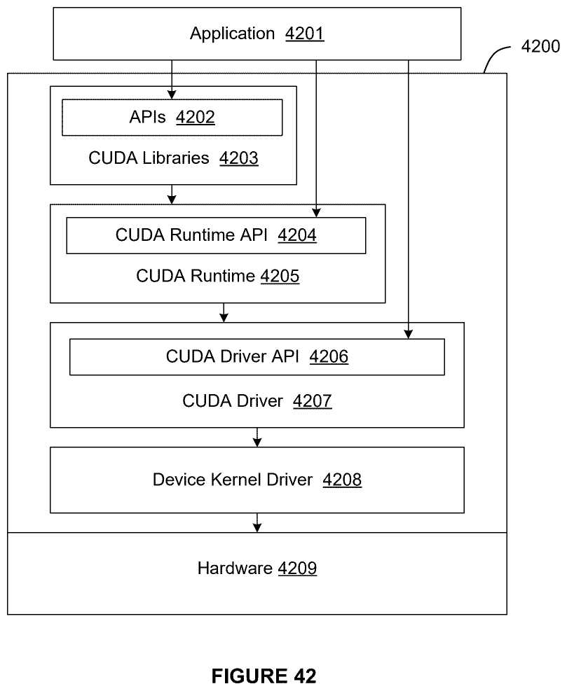

FIG. 42 illustrates a CUDA implementation of software stack 4100 of FIG. 41, in accordance with at least one embodiment. In at least one embodiment, a CUDA software stack 4200, on which an application 4201 may be launched, includes CUDA libraries 4203, a CUDA runtime 4205, a CUDA driver 4207, and a device kernel driver 4208. In at least one embodiment, CUDA software stack 4200 executes on hardware 4209, which may include a GPU that supports CUDA and is developed by NVIDIA Corporation of Santa Clara, CA.

In at least one embodiment, application 4201, CUDA runtime 4205, and device kernel driver 4208 may perform similar functionalities as application 4101, runtime 4105, and device kernel driver 4106, respectively, which are described above in conjunction with FIG. 32. In at least one embodiment, CUDA driver 4207 includes a library (libcuda.so) that implements a CUDA driver API 4206. Similar to a CUDA runtime API 4204 implemented by a CUDA runtime library (cudart), CUDA driver API 4206 may, without limitation, expose functions for memory management, execution control, device management, error handling, synchronization, and/or graphics interoperability, among other things, in at least one embodiment. In at least one embodiment, CUDA driver API 4206 differs from CUDA runtime API 4204 in that CUDA runtime API 4204 simplifies device code management by providing implicit initialization, context (analogous to a process) management, and module (analogous to dynamically loaded libraries) management. In contrast to high-level CUDA runtime API 4204, CUDA driver API 4206 is a low-level API providing more fine-grained control of a device, particularly with respect to contexts and module loading, in at least one embodiment. In at least one embodiment, CUDA driver API 4206 may expose functions for context management that are not exposed by CUDA runtime API 4204. In at least one embodiment, CUDA driver API 4206 is also language-independent and supports, for example, OpenCL in addition to CUDA runtime API 4204. Further, in at least one embodiment, development libraries, including CUDA runtime 4205, may be considered as separate from driver components, including user-mode CUDA driver 4207 and kernel-mode device driver 4208 (also sometimes referred to as a “display” driver).

In at least one embodiment, CUDA libraries 4203 may include, but are not limited to, mathematical libraries, deep learning libraries, parallel algorithm libraries, and/or signal/image/video processing libraries, which parallel computing applications such as application 4201 may utilize. In at least one embodiment, CUDA libraries 4203 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 4203 may include deep learning libraries such as a cuDNN library of primitives for deep neural networks and a TensorRT platform for high-performance deep learning inference, among others.

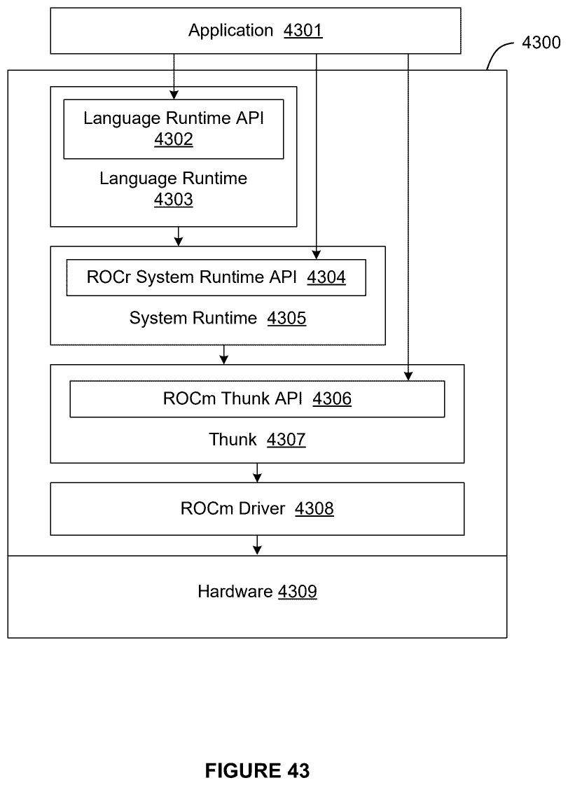

FIG. 43 illustrates a ROCm implementation of software stack 4100 of FIG. 41, in accordance with at least one embodiment. In at least one embodiment, a ROCm software stack 4300, on which an application 4301 may be launched, includes a language runtime 4303, a system runtime 4305, a thunk 4307, a ROCm kernel driver 4308, and a device kernel driver 4309. In at least one embodiment, ROCm software stack 4300 executes on hardware 4310, which may include a GPU that supports ROCm and is developed by AMD Corporation of Santa Clara, CA.

In at least one embodiment, application 4301 may perform similar functionalities as application 4101 discussed above in conjunction with FIG. 41. In addition, language runtime 4303 and system runtime 4305 may perform similar functionalities as runtime 4105 discussed above in conjunction with FIG. 41, in at least one embodiment. In at least one embodiment, language runtime 4303 and system runtime 4305 differ in that system runtime 4305 is a language-independent runtime that implements a ROCr system runtime API 4304 and makes use of a Heterogeneous System Architecture (“HAS”) Runtime API. HAS runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 4305, language runtime 4303 is an implementation of a language-specific runtime API 4302 layered on top of ROCr system runtime API 4304, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 3804 discussed above in conjunction with FIG. 38, such as functions for memory management, execution control, device management, error handling, and synchronization, among other things.

In at least one embodiment, thunk (ROCt) 4307 is an interface that can be used to interact with underlying ROCm driver 4308. In at least one embodiment, ROCm driver 4308 is a ROCK driver, which is a combination of an AMDGPU driver and a HAS kernel driver (amdkfd). In at least one embodiment, AMDGPU driver is a device kernel driver for GPUs developed by AMD that performs similar functionalities as device kernel driver 4106 discussed above in conjunction with FIG. 41. In at least one embodiment, HAS kernel driver is a driver permitting different types of processors to share system resources more effectively via hardware features.

In at least one embodiment, various libraries (not shown) may be included in ROCm software stack 4300 above language runtime 4303 and provide functionality similarity to CUDA libraries 3803, discussed above in conjunction with FIG. 38. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

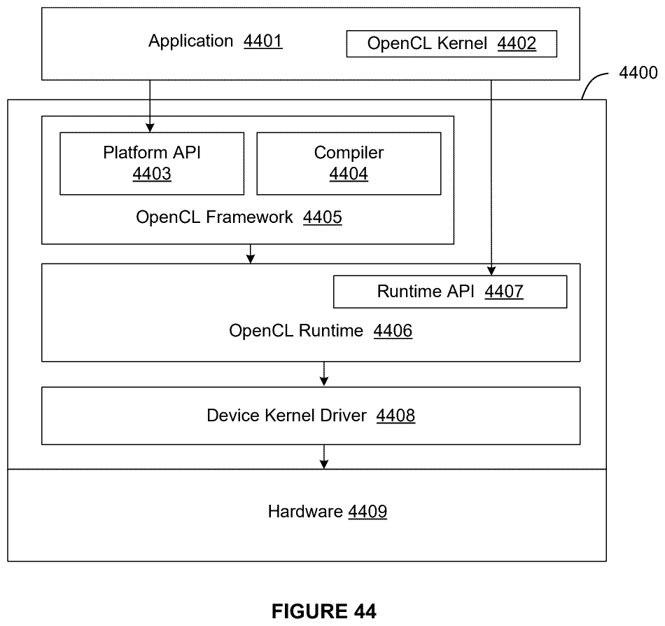

FIG. 44 illustrates an OpenCL implementation of software stack 4100 of FIG. 41, in accordance with at least one embodiment. In at least one embodiment, an OpenCL software stack 4400, on which an application 4401 may be launched, includes an OpenCL framework 4405, an OpenCL runtime 4406, and a device kernel driver 4408. In at least one embodiment. OpenCL software stack 4400 executes on hardware 4409 that is not vendor-specific. As OpenCL is supported by devices developed by different vendors, specific OpenCL drivers may be required to interoperate with hardware from such vendors, in at least one embodiment.

In at least one embodiment, application 4401, OpenCL runtime 4406, device kernel driver 4408, and hardware 4409 may perform similar functionalities as application 4101, runtime 4105, device kernel driver 4106, and hardware 4107, respectively, that are discussed above in conjunction with FIG. 41. In at least one embodiment, application 4401 further includes an OpenCL kernel 4402 with code that is to be executed on a device.

In at least one embodiment, OpenCL defines a “platform” that allows a host to control devices connected to a host. In at least one embodiment, an OpenCL framework provides a platform layer API and a runtime API, shown as platform API 4403 and runtime API 4407. In at least one embodiment, runtime API 4405 uses contexts to manage execution of kernels on devices. In at least one embodiment, each identified device may be associated with a respective context, which runtime API 4407 may use to manage command queues, program objects, and kernel objects, share memory objects, among other things, for that device. In at least one embodiment, platform API 4403 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 4404 is also included in OpenCL framework 4407. Source code may be compiled offline prior to executing an application or online during execution of an application, in at least one embodiment. In contrast to CUDA and ROCm, OpenCL applications in at least one embodiment may be compiled online by compiler 4404, which is included to be representative of any number of compilers that may be used to compile source code and/or IR code, such as Standard Portable Intermediate Representation (“SPIR-V”) code, into binary code. Alternatively, in at least one embodiment, OpenCL applications may be compiled offline, prior to execution of such applications.

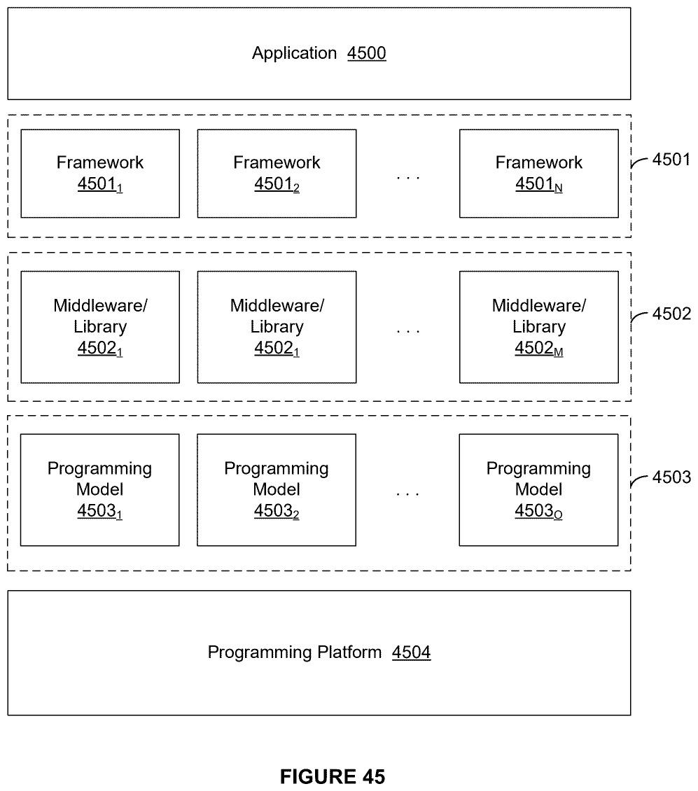

FIG. 45 illustrates software that is supported by a programming platform, in accordance with at least one embodiment. In at least one embodiment, a programming platform 4504 is configured to support various programming models 4503, libraries and/or middlewares 4502, and frameworks 4501 that an application 4500 may rely upon. In at least one embodiment, application 4500 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 4504 may be one of a CUDA, ROCm, or OpenCL platform described above in conjunction with FIG. 37, FIG. 38, and FIG. 39, respectively. In at least one embodiment, programming platform 4504 supports multiple programming models 4503, which are abstractions of an underlying computing system permitting expressions of algorithms and data structures. Programming models 4503 may expose features of underlying hardware in order to improve performance, in at least one embodiment. In at least one embodiment, programming models 4503 may include, but are not limited to, CUDA, HIP, OpenCL, C++ Accelerated Massive Parallelism (“C++ AMP”), Open Multi-Processing (“OpenMP”), Open Accelerators (“OpenACC”), and/or Vulcan Compute.

In at least one embodiment, libraries and/or middlewares 4502 provide implementations of abstractions of programming models 4504. In at least one embodiment, such libraries include data and programming code that may be used by computer programs and leveraged during software development. In at least one embodiment, such middlewares include software that provides services to applications beyond those available from programming platform 4504. In at least one embodiment, libraries and/or middlewares 4502 may include, but are not limited to, cuBLAS, cuFFT, cuRAND, and other CUDA libraries, or rocBLAS, rocFFT, rocRAND, and other ROCm libraries. In addition, in at least one embodiment, libraries and/or middlewares 4502 may include NCCL and ROCm Communication Collectives Library (“RCCL”) libraries providing communication routines for GPUs, a MIOpen library for deep learning acceleration, and/or an Eigen library for linear algebra, matrix and vector operations, geometrical transformations, numerical solvers, and related algorithms.

In at least one embodiment, application frameworks 4501 depend on libraries and/or middlewares 4502. In at least one embodiment, each of application frameworks 4501 is a software framework used to implement a standard structure of application software. An AI/ML application may be implemented using a framework such as Caffe, Caffe2, TensorFlow, Keras, PyTorch, or MxNet deep learning frameworks, in at least one embodiment.

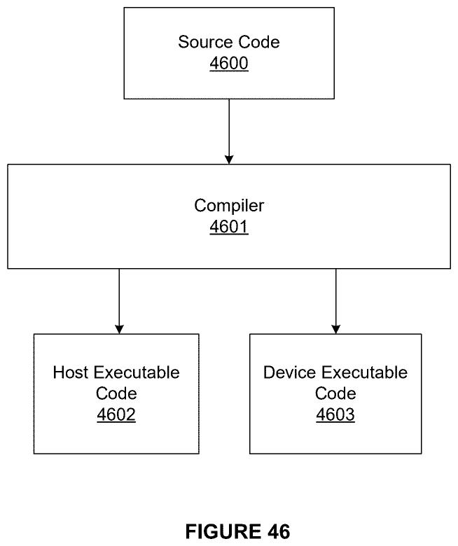

FIG. 46 illustrates compiling code to execute on one of programming platforms of FIGS. 41-44, in accordance with at least one embodiment. In at least one embodiment, a compiler 4601 receives source code 4600 that includes both host code as well as device code. In at least one embodiment, compiler 4601 is configured to convert source code 4600 into host executable code 4602 for execution on a host and device executable code 4603 for execution on a device. In at least one embodiment, source code 4600 may either be compiled offline prior to execution of an application, or online during execution of an application.

In at least one embodiment, source code 4600 may include code in any programming language supported by compiler 4601, such as C++, C, Fortran, etc. In at least one embodiment, source code 4600 may be included in a single-source file having a mixture of host code and device code, with locations of device code being indicated therein. In at least one embodiment, a single-source file may be a .cu file that includes CUDA code or a .hip.cpp file that includes HIP code. Alternatively, in at least one embodiment, source code 4600 may include multiple source code files, rather than a single-source file, into which host code and device code are separated.

In at least one embodiment, compiler 4601 is configured to compile source code 4600 into host executable code 4602 for execution on a host and device executable code 4603 for execution on a device. In at least one embodiment, compiler 4601 performs operations including parsing source code 4600 into an abstract system tree (AST), performing optimizations, and generating executable code. In at least one embodiment in which source code 4600 includes a single-source file, compiler 4601 may separate device code from host code in such a single-source file, compile device code and host code into device executable code 4603 and host executable code 4602, respectively, and link device executable code 4603 and host executable code 4602 together in a single file, as discussed in greater detail below with respect to FIG. 26.

In at least one embodiment, host executable code 4602 and device executable code 4603 may be in any suitable format, such as binary code and/or IR code. In a case of CUDA, host executable code 4602 may include native object code and device executable code 4603 may include code in PTX intermediate representation, in at least one embodiment. In a case of ROCm, both host executable code 4602 and device executable code 4603 may include target binary code, in at least one embodiment.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising.” “having.” “including.” and “containing” are to be construed as open-ended terms (meaning “including, but not limited to,”) unless otherwise noted, term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (for example, “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A. B and C.” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A. B}, {A. C}, {B. C}, {A. B. C}. Thus, such conjunctive language is not generally intended to imply that certain embodiments require at least one of A, at least one of B and at least one of C each to be present. In addition, unless otherwise noted or contradicted by context, term “plurality.” indicates a state of being plural (for example, “a plurality of items” indicates multiple items). In at least one embodiment, a number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (for example, executable instructions, one or more computer programs or one or more applications) executing collectively on one or more processors, by hardware or combinations thereof. In at least one embodiment, code is stored on a computer-readable storage medium. In at least one embodiment, in form of a computer program comprising a plurality of instructions executable by one or more processors. In at least one embodiment, a computer-readable storage medium is a non-transitory computer-readable storage medium that excludes transitory signals (for example, a propagating transient electric or electromagnetic transmission) but includes non-transitory data storage circuitry (for example, buffers, cache, and queues) within transceivers of transitory signals. In at least one embodiment, code (for example, executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—in at least one embodiment, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (for example, “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating.” “determining.” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, in at least one embodiment, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An electronic component comprising one or more processors and power-on control circuitry to modulate a time when at least a portion of the electronic component including the one or more processors powers on responsive to an input indicating the electronic component to power-up.

2. The electronic component of claim 1, the power-on control circuitry of the electronic component to modulate the time when at least the portion of the electronic component including the one or more processors are to power-up based on a random time generated for at least the portion of the electronic component to power-up.

3. The electronic component of claim 2, the random time generated for the one or more processors to power-up comprise a random time within a limited time window.

4. The electronic component of claim 3, the limited time window comprises a configurable limited time window.

5. The electronic component of claim 4, the electronic component to configure the configurable limited time window based on at least one of a power-up time of the one or more processors, a power-up time of one or more other processors of one or more other electronic components, or a total number of other electronic components receiving power from a same power source as the electronic component.

6. The electronic component of claim 1, the power-on control circuitry to modulate the time when the one or more processors power on based on:
a request from the power-on control circuitry to a main power-on control circuitry to request that the one or more processors power-up; and
receipt, by the power-on control circuitry, of a control signal from the main power-on control circuitry responsive to the request.

7. The electronic component of claim 1, the power-on control circuitry to modulate the time when the one or more processors power on based on communication between the power-on control circuitry and at least one other electronic component, the communication to indicate a respective power on status for the at least one other electronic component.

8. A method, comprising:
receiving, by an electronic component including power-on control circuitry and one or more processors, an input indicating that the electronic component is to power-up; and
modulating, by the power-on control circuit of the electronic component, a time when the one or more processors of the electronic component power-up responsive to the input.

9. The method of claim 8, modulating, by the power-on control circuitry of the electronic component, the time when the one or more processors are to power-up is based on a random time generated for at least the portion of the electronic component including the one or more processors to power-up.

10. The method of claim 9, the random time generated for at least the portion of the electronic component including the one or more processors to power-up comprises a random time within a limited time window.

11. The method of claim 10, the limited time window comprises a configurable limited time window.

12. The method of claim 11, configuring the configurable limited time window based on at least one of a power-up time of the one or more processors, a power-up time of one or more other processors of one or more other electronic components, or a total number of other electronic components receiving power from a same power source as the electronic component.

13. The method of claim 8, modulating, by the power-on control circuitry of the electronic component, the time when the one or more processors power-up comprises:
sending, by the power-on control circuitry, a request to a main power-on control circuitry requesting that the one or more processors power-up; and
receiving, by the power-on control circuitry, a control signal from the main power-on control circuitry responsive to the sent request.

14. The method of claim 8, modulating, by the power-on control circuitry, the time when the one or more processors power-up comprises communicating with at least one other electronic component, the communicating indicating a respective power on status for the at least one other electronic component.

15. A system comprising a plurality of electronic components to share a same power source, a respective electronic component of the plurality of electronic components includes one or more processors and power-on control circuitry to modulate a time when at least a portion of the respective electronic component including the one or more processors powers on responsive to an input indicating the respective electronic component to power-up.

16. The system of claim 15, the power-on control circuitry of the respective electronic component to modulate the time when at least the portion of the respective electronic component including the one or more processors is to power-up is based on a random time generated for at least the portion of the respective electronic component to power-up.

17. The system of claim 16, the random time generated for the one or more processors to power-up comprises a random time within a limited time window.

18. The system of claim 17, the limited time window comprises a configurable limited time window, the respective electronic component to configure the configurable limited time window based on at least one of a power-up time of the one or more processors, a power-up time of one or more other processors of one or more other electronic components, or a total number of other electronic components to receive power from the same power source as the respective electronic component.

19. The system of claim 15, the power-on control circuitry of the respective electronic component to modulate the time when the one or more processors of the respective electronic component powers on based on:
a request from the power-on control circuitry to a main power-on control circuitry requesting that the one or more processors power-up; and
receipt, by the power-on control circuitry, of a control signal from the main power-on control circuitry responsive to the request.

20. The system of claim 15, the power-on control circuitry of the respective electronic component to modulate the time when the one or more processors of the respective electronic component power on based on communication between the power-on control circuitry of the respective electronic component and at least one other electronic component of the plurality of electronic components, the communication indicating a respective power on status for the at least one other electronic component of the plurality of electronic components.
